(19) United States
(12) Patent Application Publication
(10) Pub. No.: US 2026/0249253 A1
(43) Pub. Date: Aug. 27, 2026

(54) MIXED-MATRIX METAL-ORGANIC FRAMEWORK MEMBRANES FOR MOLECULAR SEPARATIONS

(71) Applicant: King Abdullah University of Science and Technology, Thuwal (SA)

(72) Inventors: Mohamed EDDAOUDI, Thuwal (SA); Shuvo Jit DATTA, Thuwal (SA)

(21) Appl. No.: 18/854,642

(22) PCT Filed: Apr. 7, 2023
(86) PCT No.: PCT/IB2023/053590

§ 371 Date: Oct. 7, 2024

Related U.S. Application Data
(60) Provisional application No. 63/328,427, filed on Apr. 7, 2022.

(51) Int. Cl. B01D 69/14; B01D 53/22; B01D 71/02; B01D 71/64

(52) U.S. Cl. CPC B01D 69/148; B01D 53/228; B01D 71/02232; B01D 71/64; B01D 2256/22; B01D 2257/7025; B01D 2325/04

(57) ABSTRACT

A mixed matrix membrane for molecular separation includes a plurality of metal organic framework (MOF) nanosheets, the MOF comprising a square grid pillared by an inorganic building block, the square grid being Ni(pyrazine)₂ and the inorganic building block selected from [NbOF₅]²⁻, [AlF₅(H₂O)]²⁻, [FeF₅(H₂O)]²⁻ and [GaF₅(H₂O]²⁻. The mixed matrix membrane further includes a polymer matrix, and the plurality of MOF nanosheets are incorporated into the polymer matrix to form a mixed matrix metal organic framework (MMMOF) membrane. The nanosheets have a high aspect ratio and when incorporated into the polymer matrix, the nanosheets are in-plane aligned with one another such that 1D channels of the nanosheets are parallel for enhancing gas diffusion. The MMMOF membrane has high nanosheet loading and strong nanosheet-polymer interaction, resulting in high separation performance.

### PRIORITY CLAIM

This application claims benefit of U.S. Provisional Application No. 63/328,427 filed on Apr. 7, 2022. U.S. Provisional Application No. 63/328,427 is incorporated herein by reference in its entirety. A claim of priority is made.

### BACKGROUND

Conventional separation technologies to separate valuable commodities are energy-intensive, consuming 15% of the worldwide energy. Chemical separations are highly energy-intensive and account for around half of the global industrial energy consumption. Membrane-based separation can provide an energy-efficient alternative to traditional separation processes like cryogenic distillation and adsorptive separation. Polymer membranes intrinsically undergo a trade-off between the permeability (productivity) and selectivity (efficiency), known as Robeson's upper bound. Mixed-matrix membranes (MMMs) can combine the distinct properties of selective adsorbents (molecular separation and facilitated gas transport) and polymers (processability and mechanical stability), as well as enable energy-efficient and environmentally sustainable technologies. However, successful translation of adsorbent distinct properties into MMMs remains a persistent challenge, due to recurring agglomeration and sedimentation of adsorbent fillers in the polymer matrix and incompatibility between adsorbent-polymer interfaces.

It would be beneficial to develop a mixed matrix membrane system that has high permeability and selectivity for select gases, while maintaining membrane strength and stability.

### SUMMARY

According to one aspect, a metal organic framework (MOF) nanosheet has the formula MₐM_{b}F₅ (O/H₂O)(pyrazine)₂·x(solv), wherein Mₐ is Ni²⁺, M_{b} is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH. The nanosheet includes one-dimension (1D) channels extending vertically through the nanosheet and the nanosheet has an aspect ratio of at least 20, the aspect ratio being defined as the ratio of a lateral dimension of the nanosheet to a thickness of the nanosheet.

According to another aspect, a mixed-matrix membrane for molecular separation includes a plurality of metal organic framework (MOF) nanosheets, the MOF comprising a square grid pillared by an inorganic building block, the square grid being Ni(pyrazine)₂ and the inorganic building block selected from [NbOF₅]²⁻, [AlF₅(H₂O)]²⁻, [FeF₅(H₂O)]²⁻ and [GaF₅(H₂O]²⁻. The mixed-matrix membrane further includes a polymer matrix, and the plurality of MOF nanosheets are incorporated into the polymer matrix and the incorporated nanosheets are in-plane aligned with one another such that 1D channels of the nanosheets are parallel with one another.

According to another aspect, a method of making a mixed-matrix membrane for molecular separation includes contacting a ligand and a pillar component at a ligand to pillar ratio between about 10 and about 120 to form a plurality of MOF nanosheets, and the MOF has the formula MₐM_{b}F₅ (O/H₂O)(pyrazine)₂·x(solv), wherein Mₐ is Ni²⁺, M_{b} is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH. The method further includes contacting the plurality of MOF nanosheets with a polymer matrix in a dispersion of solvent to form a solution in which the plurality of MOF nanosheets incorporate into the polymer matrix to form a mixed-matrix membrane, and evaporating the solvent at a rate sufficient to induce in-plane alignment of the incorporated nanosheets with one another in the mixed-matrix membrane such that 1D channels of the nanosheets are parallel with one another.

According to another aspect, a method of capturing chemical species includes contacting a mixed-matrix membrane with a composition including CH₄ and one or more of H₂S and CO₂. The mixed-matrix membrane includes a plurality of MOF nanosheets having the formula MₐM_{b}F₅ (O/H₂O)(pyrazine)₂·x(solv), wherein Mₐ is Ni²⁺, M_{b} is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH. The mixed-matrix membrane further includes a polymer matrix, and the plurality of MOF nanosheets are incorporated into the polymer matrix and the incorporated nanosheets are in-plane aligned with one another such that 1D channels of the nanosheets are parallel with one another. The method of capturing chemical species further includes capturing one or more of H₂S and CO₂ from the composition on the mixed-matrix membrane.

### BRIEF DESCRIPTION OF THE DRAWINGS

This written disclosure describes illustrative embodiments that are non-limiting and non-exhaustive. Reference is made to illustrative embodiments that are depicted in the figures, in which:

FIGS. 1A-H illustrate Crystal structure and morphology of AIFFIVE-1-Ni (point group 4/mmm). (A) Structure view along [110 or 1-10] direction. (B) Schematic illustration of truncated bipyramidal morphology and 1D channel orientation. (C) Structure view along the [001] direction. (D) SEM image of nanosheets. Inset: large 001 surface and short channel. (E) Low-resolution STEM image of nanosheets. Inset: photos showing Tyndall effect on nanosheets, using a green laser. (F) SEM image of nanoparticles. Inset: depicted crystal morphology and long channel. (G) Powder XRD patterns (λ1.54056 Å) of nanosheets and nanoparticles. (H) CO₂ adsorption isotherms of nanosheets between 20 to 100° C.

FIGS. 2A-F illustrate Cₛ-corrected STEM images of AIFFIVE-1-Ni nanosheets acquired from different zone axes. (A) An annular bright-field (ABF) image along [001] with the Fourier diffractogram (FD). (B) Symmetry averaged image of (A) and an overlaid crystal structure. (C) Enlarged a part marked by the dotted red rectangle and intensity profile along the red arrow of (B), and associated structure model. (D) ABF image taken with [100] incidence. (E) Wiener filtered image with superimposed atomic structure. Color code: Ni(II) orange, Al(III) purple, C gray, F green, N blue. (F) Schematic illustration of nanosheet with 1D channel orientation.

FIGS. 3A-N illustrate Fabrication and characterization of [001]-oriented MMMOF membranes. (A) Schematic illustration of [001]-oriented membrane and an efficient H₂S and CO₂ separation process through 1D channel. (B and C) Cross-section SEM image (B) and FIB-SEM image (C) of (001)-AIFFIVE(58.9)/6FDA-DAM membrane. (D) XRD patterns of [001]-oriented membrane and nanosheet crystallite. (E) Illustration of ‘slow evaporation-induced in-plane alignment’ of nanosheets in polymer matrix. (F) Photographs of membrane. (G) Cross-section SEM image of random fashion nanosheets membrane. (H) Illustration of random fashion nanoparticles embedded in polymer matrix. (I and J) Cross-section SEM image (I) and XRD pattern (J) of nanoparticle (37.1)/6FDA-DAM membrane. (K) Mechanical studies of the membranes. (L) Relative viscosity changes of MOF/polymer and polymer suspension. (M and N) Computational studies of [001]-oriented membrane. Color code: polymer phase (transparent sky blue), MOF in (001)-facet (green) and (110)- or (1-10)-facet (purple).

FIG. 4 illustrates a method of making a MMMOF membrane for molecular separation.

FIG. 5 illustrates a method of capturing chemical species.

FIGS. 6A-I illustrate Gas separation properties of MMMOF membranes. (A) Gas permeability of gases with various kinetic diameters. (B) CO₂ permeability and CO₂/CH₄ selectivity of [001]-oriented MMMOF membranes with various nanosheets loading in wt % and predicted pure (001)-AIFFIVE-1-Ni membrane; pure gas permeation (CO₂ at 1 bar and CH₄ at 4 bar, 35° C.). (C and D) Effects of feed CO₂ concentration and temperature on CO₂ permeability and CO₂/CH₄ selectivity for [001]-oriented and pure polymeric membranes, mixed-gas permeation (CO₂/CH₄: 50/50 at 2 bar, 20/80 at 5 bar, and 10/90 at 10 bar, 35° C.) (C) and temperature region between 2° and 100° C. (D). (E) Variation of CO₂/CH₄ sorption and diffusion selectivity with respect to temperature between 2° and 100° C. (F) Long-term stability and reversibility of CO₂ permeability and CO₂/CH₄ selectivity under thermal stress in (001)-AIFFIVE(59.6)/6FDA-DAM-DAT membrane. (G) Plot of CO₂/CH₄ selectivity versus CO₂ permeability providing a recent literature review of polymer/MOF-based MMMs. (H) (H₂S+CO₂)/CH₄ mixed-gas separation properties of [001]-oriented and pure polymer membranes, and comparison with the literature; permeation conditions and individual H₂S and CO₂ permeability and H₂S/CH₄ and CO₂/CH₄ selectivity are listed in Supplementary Table 16. The dash black line indicates the general trade-off between permeability and selectivity in glassy polymers under the described test condition. (I) Permeability and selectivity of [001]-oriented membrane under feed pressures between 5 and 35 bar, at 35° C. The dash black line in Fig B and G indicates the Robeson upper bound for state-of-the-art polymer membranes ref (3). The average permeation data are presented; error bars represent the standard error of three membranes (n=3). 1 barrer=10⁻¹⁰ cc (STP) cm cm⁻² s⁻¹ cmHg⁻¹.

FIGS. 7A-D illustrate Effects of pillar ratio on the morphology of AIFFIVE-1-Ni. (A to D) SEM images of AIFFIVE-1-Ni bulk crystals obtained using a synthetic gel with the pillar [AlF₅(H₂O)]2-ratio of (A) 1, (B) 0.71, (C) 0.46, and (D) 0.32 with respect to Ni(II) in the gel. The solvothermal reaction performed at 100° C. for 3h.

FIGS. 8A-E illustrate the Effect of reaction temperature and time on the morphology of AIFFIVE-1-Ni. (A to E) SEM images of AIFFIVE-1-Ni obtained from solvothermal reaction carried out at 100° C. for (A) 3h, and (B) 3 days. At 50° C. for (C) 3h, (D) 3 days without Ethanol, (E) 3 days with Ethanol.

FIGS. 9A-E illustrate the Effect of amount of ethanol on the morphology of AIFFIVE-1-Ni. (A to E) SEM images of AIFFIVE-1-Ni nanosheets obtained from solvothermal reaction using various ethanol/water mixture solution, the reactions were performed (A to D) at 50° C. for 3 days, and (E) 100° C. for 12 h.

FIGS. 10A-E illustrate the Scale-up synthesis of AIFFIVE-1-Ni nanosheets. (A and B) photographs of AIFFIVE-1-Ni nanosheets crystallite synthesized in 12.4 g scale. (C) SEM image, (D) PXRD patterns, and (E) CO₂ adsorption isotherms at 298 K.

FIG. 11 illustrates CO₂ adsorption isotherms on as-synthesized nanosheets, nanoparticles and bulk crystals of AIFFIVE-1-Ni measured at 308 K.

FIGS. 12A-C illustrate (A to C) SEM images of FeFFIVE-1-Ni (KAUST-9) crystals. (A) as-synthesized bulk FeFFIVE-1-Ni crystals and (B and C) FeFFIVE-1-Ni nanosheets morphology under different magnifications.

FIGS. 13A-F illustrate Cs-corrected STEM analyses of AIFFIVE-1-Ni nanosheets. (A to F) Cs-corrected STEM-ADF and ABF micrographs of a nanosheets along the [001] orientation. (B) The Electron Diffraction (ED) pattern of nanosheets corroborating the excellent crystallinity as well as [001] crystal orientation. (C) ADF image and (D) ABF image along [001] orientation. Symmetry averaged p4mm (E) ADF image and (F) ABF image.

FIGS. 14A-C illustrate (A) Low resolution ADF image of AIFFIVE-1-Ni nanosheet. (B) High-resolution ABF image along the orientation, the corresponding ED pattern (inset) indexed assuming 14/mcm symmetry. (C) Symmetry averaged atomic-resolution ABF image, the strong dark spots corresponds to the —F—Ni—F—Al—F— inorganic columns. The elongated faint signal between —F—Ni—F—Al—F— inorganic columns is attributed to the pyrazine, for clarity, the crystal structure is superimposed.

FIGS. 15A-D illustrates (A) Low-resolution ADF image showing AIFFIVE-1-Ni nanosheets along a different orientation. (B) Low- and (C) High-resolution ABF image along [100] orientation. (D) Wiener filtered image along orientation that allows the clear visualization of Ni(II)-pyrazine-Ni(II) 2D square grids (black layers) separated each other by 7.2 Å, for clarity, the crystal structure is superimposed. Color code: Ni(II) orange, Al(III) purple, C gray, F green, N blue.

FIGS. 16A-B illustrate Effects of solvents as a dispersion medium for membrane preparation on the performance of CO₂/CH₄ separation. (A) 6FDA-DAM (PI) and (001)-AIFFIVE(58.9)/6FDA-DAM (MMMOF) membranes; (B) 6FDA-DAM-DAT (PI) and (001)-AIFFIVE(59.6)/6FDA-DAM-DAT (MMMOF) membranes. Pure CO2 permeation at 1 bar and pure CH₄ permeation at 4 bar, at 35° C. 1 Barrer=10⁻¹⁰ cm³ (STP) cm/cm2 s cmHg. Tetrahydrofuran (THF), dichloromethane (DCM), Chloroform (CHCl3).

FIG. 17 illustrates Representative structures of polyimide polymers employed for membrane preparation in this study. 6FDA-DAM [6FDA: 4,4′-(hexafluoroisopropylidene)diphthalic anhydride; DAM: 2,4,6 trimethyl-1,3-diaminobenzene]. 6FDA-DAM-DAT(1:1) [6FDA: 4,4′-(hexafluoroisopropylidene) diphthalic anhydride; DAM: 2,4,6 trimethyl-1,3-diaminobenzene; DAT: 2,6-diaminotoluene]. 6FDA-DAT [6FDA: 4,4′-(hexafluoroisopropylidene)diphthalic anhydride; DAT: 2,6-diaminotoluene].

FIGS. 18A-D illustrate (A and B) Cross-sectional SEM images of pure 6FDA-DAM membrane. (C and D) Cross-sectional SEM images of uniformly in plane aligned (001)-AIFFIVE/6FDA-DAM MMM under different magnification with (001)-AIFFIVE-1-Ni nanosheets loading of 58.9 wt %.

FIGS. 19A-D illustrate FIB-SEM analyses of [001]-oriented ((001)-AIFFIVE/6FDA-DAM) MMMOF membrane. (A) Top view SEM image of the trench carved with a FIB on the surface of (001)-AIFFIVE(58.9)/6FDA-DAM membrane. The white line frame indicates a central region within the imaged cross-section that was selected for further analysis. (B and C) Representative SEM images of cross-sections of the membrane containing (001)-AIFFIVE-1-Ni nanosheets embedded in 6FDA-DAM polyimide under different magnification. A uniform in-plane alignment of (001)-AIFFIVE nanosheets appear as bright motifs on the dark grey polymer matrix (B and C).

FIGS. 20A-D illustrate TGA curves of AIFFIVE-1-Ni powder, AIFFIVE-1-Ni/polymer MMMs with different MOF loadings and pure polymer membrane. (A) nanoparticle/6FDA-DAM MMMs, (B) (001)-AIFFIVE/6FDA-DAM MMMOF membranes, (C) (001)-AIFFIVE/6FDA-DAM-DAT(1:1) MMMOF membranes, and (D) (001)-AIFFIVE/6FDA-DAT MMMOF membranes. Samples were first heated at 200° C. under N₂ for 2 h to remove any residual solvent or moisture. Afterwards, the temperature was increased to 800° C. with a constant heating rate of 10° C./min under 02 to decompose 6FDA-DAM, and MOFs to corresponding metal oxidize.

FIGS. 21A-D illustrate ATR-FTIR spectra of AIFFIVE-1-Ni powder, AIFFIVE-1-Ni/polymer MMMs with different MOF loadings and pure polymer membrane. (A) nanoparticle/6FDA-DAM MMMs, (B) (001)-AIFFIVE/6FDA-DAM MMMOF membranes, (C) (001)-AIFFIVE/6FDA-DAM-DAT(1:1) MMMOF membranes, and (D) (001)-AIFFIVE/6FDA-DAT MMMOF membranes.

FIGS. 22A-D illustrate X-ray diffraction (XRD) patterns of AIFFIVE-1-Ni powder, AIFFIVE-1-Ni/polymer MMMs with different MOF loadings and pure polymer membrane. (A) nanoparticle/6FDA-DAM MMMs, (B) (001)-AIFFIVE/6FDA-DAM MMMOF membranes, (C) (001)-AIFFIVE/6FDA-DAM-DAT(1:1) MMMOF membranes, and (D) (001)-AIFFIVE/6FDA-DAT MMMOF membranes.

FIGS. 23A-B illustrate (A and B) Cross-sectional SEM images of uniformly in plane aligned (001)-AIFFIVE/6FDA-DAM-DAT MMMOF membrane under different magnification with (001)-AIFFIVE-1-Ni nanosheets loading of 59.6 wt %.

FIGS. 24A-D illustrate FIB-SEM analysis of [001]-oriented ((001)-AIFFIVE/6FDA-DAM-DAT) MMMOF membrane. (A) Top view SEM image of the trench carved with a FIB on the surface of (001)-AIFFIVE(59.6)/6FDA-DAM-DAT membrane. The white line frame indicates a central region within the imaged cross-section that was selected for further analysis. (B and C) Representative SEM images of cross-sections of the membrane containing (001)-AIFFIVE-1-Ni nanosheets embedded in 6FDA-DAM-DAT polyimide under different magnification. (B and C) A uniform in-plane alignment of (001)-AIFFIVE nanosheets appear as bright motifs on the dark grey polymer matrix.

FIGS. 25A-C illustrate FIB-SEM analysis of (001)-AIFFIVE/6FDA-DAM-DAT membrane with 59.6 wt % nanosheets loading. (A) Cross-section SEM image. (B and C) FIB-SEM images of the cross-section of the membrane from the (B) top side and (C) bottom side. (B and C) A homogeneous in-plane

FIGS. 26A-B illustrate (A and B) Cross-sectional SEM images of uniformly in plane aligned (001)-AIFFIVE/6FDA-DAT MMMOF membrane under different magnification with (001)-AIFFIVE-1-Ni nanosheets loading of 60.3 wt %.

FIGS. 27A-B illustrate (A and B) Cross-sectional SEM images of nanoparticles/6FDA-DAM MMMs under different magnification with AIFFIVE-1-Ni nanoparticles loading of 37.1 wt %.

FIG. 28 illustrates Stress-strain curves of 6FDA-DAM, nanoparticles/6FDA-DAM, and nanosheets/6FDA-DAM membranes at different MOF loadings.

FIGS. 29A-D illustrate (A and C) A comparison of mixed-gas CO₂ permeability and CO2/CH4 selectivity of (001)-AIFFIVE nanosheets (ns)/polymer and AIFFIVE nanoparticles (np)/polymer membranes based on by volume (%) and (B and D) by weight (%). Permeation conditions: CO2/CH4:50/50, at 2 bar, 35° C.

FIGS. 30A-C illustrate (A and B) Cross-sectional SEM images of randomly aligned (001)-AIFFIVE/6FDA-DAM-DAT membrane under different magnification with (001)-AIFFIVE-1-Ni nanosheets loading of 48.9 wt %. (C) A comparison of CO₂ permeability and CO₂/CH₄ selectivity of randomly aligned and in-plane aligned (001)-AIFFIVE nanosheets MMMOF membranes. Permeation conditions: CO₂ feed pressure 1 bar and CH₄ feed pressure at 4 bar, at 35° C.

FIGS. 31A-B illustrate (A) A comparison of CO₂/CH₄ separation of MMMs comprises of MOF nanosheets with different pore size and shape, functionality, and host-guest interactions. 12.1 wt % Zn2(bim)4, 13.5 wt % Zn-TCPP, 11.3 and 58.9 wt % (001)-AIFFIVE nanosheets in 6FDA-DAM polymer. Permeation conditions: CO₂/CH4:50/50, at 2 bar, 35° C. (B) CO2 adsorption isotherms of Zn2(bim)4, Zn-TCPP, and (001)-AIFFIVE nanosheets obtained at 35° C.

FIGS. 32A-C illustrate CO₂ and CH₄ adsorption isotherms of (A) (001)-AIFFIVE nanosheets, (001)-AIFFIVE(58.9)/6FDA-DAM membrane and pure 6FDA-DAM membrane. (B) (001)-AIFFIVE nanosheets, (001)-AIFFIVE(59.6)/6FDA-DAM-DAT membrane and pure 6FDA-DAM-DAT(1:1) membrane. (C) (001)-AIFFIVE nanosheets, (001)-AIFFIVE(60.3)/6FDA-DAT membrane and pure 6FDA-DAT membrane. Isotherms measured at 35 □C. The star indicates the theoretical CO2 uptake of MMMOF membranes.

FIGS. 33A-F illustrate Molecular modelling of (001)-AIFFIVE-1-Ni/polymer MMMs. (A to F) Side views of the MOF/polymer interface model and associated pore distribution alongside the distribution of the MOF/polymer minimum separating distances: (A to C) 42 wt % (001)-AIFFIVE/6FDA-DAM loaded composite model with and (D to F) 59 wt % (001)-AIFFIVE nanosheets loaded. F, N, O, C, Ni, Al and H atoms are respectively shown in green, blue, red, gray, orange, purple and white. C atoms of the polymer are shown in cyan for clarity. Green dots and red dots in fig. B and E denote to regions containing smaller and larger porosity respectively.

FIGS. 34A-D illustrate (A) Illustration of the AIFFIVE-1-Ni(001) surface model viewed along indicated directions. (B) Atom types associated with the AIFFIVE-1-Ni (001) surface model. Only a single end of the surface slab structure is shown in this scheme for clarity. F, N, C, Ni, Al and H are respectively shown in green, blue, gray, orange, purple and white. (C) Optimized 6FDA-DAM monomer structure, with head and tail atoms represented by atoms 17 and 30. N, C, O and H are respectively shown in blue, gray, red and white. (D) Atomic density profile of 6FDA-DAM (black) and AIFFIVE-1-Ni (red) in the AIFFIVE-1-Ni/6FDA-DAM composite plotted along the direction perpendicular to the surface slab (z).

FIGS. 35A-B illustrate (A) Lateral view (xz plane) of a representative interface of a AIFFIVE-1-Ni/6FDA-DAM composite model displaying its adsorption surface (in blue) and showing the average 3.5 Å center-to-center MOF-polymer distance obtained from fig. S27. (B) Top view (xy plane) of such interface cut at a 3.5 Å height from the MOF surface highlighting the interconnected interfacial porosities.

FIGS. 36A-C illustrate (A and B) Representative snapshots obtained from single adsorption GCMC calculations at 298 K and 1 bar showing the main adsorption sites and interactions of CO2 (red spheres) and CH₄ (blue spheres) in the AIFFIVE-1-Ni/6FDA-DAM composite. (C) Radial distribution functions (RDFs) respectively displaying the interactions of CO2 and CH4 with the H atoms of the pyrazine of the MOF (black lines), with the O atoms of the carbonyl functions of the polymer (red lines) and with the CH3 groups of the polymer (blue lines) obtained from single-component GCMC calculations for the composite at 1 bar and 298 K.

FIGS. 37A-C illustrate (A and B) Representative GCMC simulated snapshot for the adsorption of (A) CO2 (red spheres) and (B) CH4 (cyan spheres) in AIFFIVE-1-Ni/6FDA-DAM membrane at 298 K and 1 bar. (C) GCMC simulated binary mixture (solid symbols) and single component (empty symbols) adsorption isotherms at 298 K for AIFFIVE-1-Ni/6FDA-DAM composite.

FIGS. 38A-C illustrate Single gas permeability as a function of the kinetic diameters of various gases in (A) (001)-AIFFIVE(58.9)/6FDA-DAM and pure 6FDA-DAM, (B) (001)-AIFFIVE(59.6)/6FDA-DAM-DAT and pure 6FDA-DAM-DAT, (C) (001)-AIFFIVE(60.3)/6FDA-DAT and pure 6FDA-DAT. Permeation measured at 2 bar and 35° C.

FIGS. 39A-D illustrate (A and B) Single and mixed gas permeation under different feed CO₂ concentration (10-50%). Variation of CO2/CH4 selectivity and CO2 permeability as a function of CO2 concentration for (001)-AIFFIVE(58.9)/6FDA-DAM and 6FDA-DAM membranes, (A) single- and (B) mixed-gas. A comparison of single- and mixed-gas CO2/CH4 selectivity and CO2 permeability at indicated CO2/CH4 composition for (C) 6FDA-DAM, and (D) (001)-AIFFIVE(58.9)/6FDA-DAM membranes. Permeation condition: CO2/CH4: 50/50 at 2 bar; 20/80 at 5 bar; 10/90 at 10 bar, at 35° C.

FIGS. 40A-D illustrate (A and B) Single and mixed gas permeation under different feed CO2 concentration (10-50%). Variation of CO2/CH4 selectivity and CO2 permeability as a function of CO2 concentration for (001)-AIFFIVE(59.6)/6FDA-DAM-DAT and 6FDA-DAM-DAT membranes, (A) single- and (B) mixed-gas. A comparison of single- and mixed-gas CO2/CH4 selectivity and CO2 permeability at indicated CO2/CH4 composition for (C) 6FDA-DAM-DAT, and (D) (001)-AIFFIVE(59.6)/6FDA-DAM-DAT membranes. Permeation condition: CO2/CH4: 50/50 at 2 bar; 20/80 at 5 bar; 10/90 at 10 bar, at 35° C.

FIGS. 41A-D illustrate (A and B) Single and mixed gas permeation under different feed CO2 concentration (10-50%). Variation of CO2/CH4 selectivity and CO2 permeability as a function of CO2 concentration for (001)-AIFFIVE(60.3)/6FDA-DAT and 6FDA-DAT membranes, (A) single- and (B) mixed-gas. A comparison of single- and mixed-gas CO2/CH4 selectivity and CO2 permeability at indicated CO2/CH4 composition for (C) 6FDA-DAT, and (D) (001)-AIFFIVE(60.3)/6FDA-DAT membranes. Permeation condition: CO2/CH4: 50/50 at 2 bar; 20/80 at 5 bar; 10/90 at 10 bar, at 35° C.

FIGS. 42A-D illustrate (A and B) Variable temperature (20-100 IC) CO2/CH4 separation under single gas (SG) and mixed gas (MG). Variation of CO2/CH4 selectivity and CO2 permeability as a function of temperature for (001)-AIFFIVE(58.9)/6FDA-DAM and 6FDA-DAM membranes, (A) single- and (B) mixed-gas. A comparison of single- and mixed-gas CO2/CH4 selectivity and CO2 permeability at different temperatures for (C) 6FDA-DAM, and (D) (001)-AIFFIVE(58.9)/6FDA-DAM membranes.

FIGS. 43A-D illustrate (A and B) Variable temperature (20-100 IC) CO2/CH4 separation under single gas (SG) and mixed gas (MG). Variation of CO2/CH4 selectivity and CO2 permeability as a function of temperature for (001)-AIFFIVE(59.6)/6FDA-DAM-DAT and 6FDA-DAM-DAT membranes, (A) single- and (B) mixed-gas. A comparison of single- and mixed-gas CO2/CH4 selectivity and CO2 permeability at different temperatures for (C) 6FDA-DAM-DAT, and (D) (001)-AIFFIVE(59.6)/6FDA-DAM-DAT membranes.

FIGS. 44A-D illustrate (A and B) Variable temperature (20-100 IC) CO2/CH4 separation under single gas (SG) and mixed gas (MG). Variation of CO2/CH4 selectivity and CO2 permeability as a function of temperature for (001)-AIFFIVE(60.3)/6FDA-DAT and 6FDA-DAT membranes, (A) single- and (B) mixed-gas. A comparison of single- and mixed-gas CO2/CH4 selectivity and CO2 permeability at different temperatures for (C) 6FDA-DAT, and (D) (001)-AIFFIVE(60.3)/6FDA-DAT membranes.

FIGS. 45A-D illustrate (A to C) Solubility, diffusivity, sorption and diffusion selectivity. Solubility and diffusivity of (A) CO2 and (B) CH4, and (C) CO2/CH4 sorption selectivity and diffusion selectivity in (001)-AIFFIVE/6FDA-DAM-DAT and pure 6FDA-DAM-DAT membranes obtained temperature between 20 and 100 □C, feed pressure CO2 at 1 bar and CH4 at 4 bar. (D) Variable temperature CO2 adsorption isotherms on (001)-AIFFIVE-1-Ni nanosheets.

FIGS. 46A-B illustrate (A) Plot of CO2/CH4 selectivity versus CO2 permeability providing a recent literature review of MOFs-nanosheets/polymer-based MMMs. filled symbols: MMMs, empty symbols: pure polymers. (B) Comparison with the performance of our newly designed [001]-oriented MMMOF membranes.

FIG. 47 illustrates a comparison of CO2/CH4 separation performances of 421 nm ultrathin (001)-AIFFIVE(55)/6FDA-DAM-DAT membrane on porous □-Al2O3support and 61 μm thick free standing (001)-AIFFIVE(59.6)/6FDA-DAM-DAT. Permeation conditions: CO2 feed pressure 1 bar and CH4 feed pressure 4 bar, at 35° C.

FIGS. 48A-B illustrate (A and B) Membrane stability under different H₂S concentration, (A) H2S/CO2/CH4: 1/9/90; (B) H2S/CO2/CH4: 5/5/90. Robust H2S/CO2/CH4 separation properties of (001)-AIFFIVE(59.6)/6FDA-DAM-DAT membrane for at least 30 days. Feed pressure at 10 bar and 35° C.

FIGS. 49A-B illustrate (A and B) High-pressure H2S/CO2/CH4 permeation study. Permeability and selectivity of (A) (001)-AIFFIVE(59.6)/6FDA-DAM-DAT and (B) (001)-AIFFIVE(58.9)/6FDA-DAM membranes for the separation of H2S/CO2/CH4:1/9/90 gas mixture under feed pressure varied from 5 to 35 bar, at 35° C.

FIG. 50 illustrates a comparison of high-pressure H2S/CO2/CH4 permeation study. Permeability and selectivity of (001)-AIFFIVE(59.6)/6FDA-DAM-DAT and pure 6FDA-DAM-DAT membranes for the separation of H2S/CO2/CH4:1/9/90 gas mixture under feed pressure varied from 5 to 35 bar, at 35° C.

FIGS. 51A-C illustrate Permeation properties of (001)-AIFFIVE(59.2)/6FDA-DAM-DAT MMMOF membranes for other gas pairs and comparison with 2008 Robeson upper-bounds (3): (A) H2/N2, (B) H2/CH4, (C) H2/C3H6 and (D) H2/C3H8. Permeation conditions: pure gas feed pressure 2 bar, 35° C. See table S4 for details information.

FIG. 52 illustrates Constant-volume dense film permeation system for pure and mixed gases.

FIG. 53 illustrates Theoretically predicting permeation properties of mixed-matrix membranes based on the measured performance of pure 6FDA-DAM-DAT membrane and (001)-AIFFIVE/6FDA-DAM-DAT mixed-matrix membranes (Exp.: measured pure-gas permeability and selectivity; Pred.: Maxwell-predicted pure-gas permeability and selectivity).

### DETAILED DESCRIPTION

According to some embodiments, the methods and systems described herein are directed to mixed-matrix metal organic framework (MMMOF) membranes that exhibit enhanced selectivity and permeability for separation of a composition comprising CH₄ and one or more of H₂S and CO₂. The MMMOF membranes use processable polymers and selective adsorbents—the MOF adsorbent is in the form of multiple nanosheets, the nanosheets having a plurality of channels formed therein for gas diffusion. The MOF nanosheets can be incorporated into a polymer matrix in such a way that the nanosheets have in-plane alignment with one another in the polymer matrix and the channels in the nanosheets can be arranged in parallel. As described herein, the MMMOF membranes are highly effective for gas separation based on at least three interrelated criteria: i) using a fluorinated metal-organic framework, such as, for example, AIFFIVE-1-Ni as a molecular sieve adsorbent that selectively enhances H₂S and CO₂ diffusion while excluding CH₄; ii) tailoring MOF crystal morphology along 001 crystallographic direction into high-aspect-ratio (001)-nanosheets that proffer maximum exposure of one-dimensional (1D) channels and promotes nanosheets-polymer interaction resulting from high nanosheets loading; and iii) in-plane (face-to-face) alignment of (001)-nanosheets in a polymer matrix with proximal distance to translate the molecular separation properties of single nanosheets into a uniformly [001]-oriented macroscopic MMMOF membrane.

The attainment of in-plane alignment and high loading of (001) nanosheets results in high separation performance. The nanosheets described herein selectively transported gases, based on their kinetic diameter, through the oriented MMMOF membranes. The centimeter-scale flexible [001]-oriented membrane can be regarded as a single piece of a flexible crystal in which thousands of nanosheets are uniformly aligned in a predefined crystallographic direction and the gaps between aligned nanosheets are filled with polymer. The results provided herein confirm the benefits for various gas separations of tailoring MOF crystal morphology into orientated nanosheets, allowing the desired orientation of the 1D channels parallel to the gas diffusion direction and maximizing performance of the oriented membrane.

Hydrolytically stable fluorinated AIFFIVE-1-Ni, when used as an adsorbent, has excellent separation properties for H₂S/CH₄ and CO₂/CH₄. This MOF possesses appropriate H₂S and CO₂ adsorption and separation properties, high chemical stability towards H₂S that instigates AIFFIVE-1-Ni as a potential molecular sieve filler in a MMMOF membrane for natural gas upgrading. Effective deployment of AIFFIVE-1-Ni (a 3-periodic MOF with 1D channels) as a filler into membranes, as described herein, includes tailoring its morphology into nanosheets with defined crystallographic direction, for maximum surface exposure of 1D channels.

MOFs generally: Gas storage and separation using porous materials, such as metal-organic frameworks (MOF), have experienced significant development in recent years in various industrial applications related to energy, environment, and medicine. Among porous materials, metal organic frameworks are a versatile and promising class of crystalline solid state materials which allow porosity and functionality to be tailored towards various applications. MOF crystal chemistry uses a molecular building block (MBB) approach that offers potential to construct MOFs where desired structural and geometrical information are incorporated into the building blocks prior to the assembly process.

Generally, MOFs comprise a network of nodes and ligands, wherein a node has a connectivity capability at three or more functional sites, and a ligand has a connectivity capability at two functional sites each of which connect to a node. Nodes are typically metal ions or metal containing clusters, and, in some instances, ligands with node connectivity capability at two, three, or more functional sites can also be characterized as nodes. In some instances, ligands can include two functional sites capable of each connecting to a node, and one or more additional functional sites which do not connect to nodes within a particular framework. A MBB can comprise a metal-based node and an organic ligand which extrapolate to form a coordination network. Such coordination networks have advantageous crystalline and porous characteristics affecting structural integrity and interaction with foreign species (e.g., gases). The particular combination of nodes and ligands within a framework will dictate the framework topology and functionality.

The metal-organic framework may be characterized by the formula [(node)ₓ(ligand)_{y}(solvent)_{z}]. The node may be characterized by the formula MₐM_{b}F₅ (O/H₂O)_{w}, where Mₐ is Ni²⁺ and Mb is one or more of Nb⁵⁺, Al³⁺, Fe³⁺, Fe⁵⁺, and Ga³⁺. In general, Mb may include any metals with a +3 or +5 oxidation state (e.g., trivalent metal cations or pentavalent metal cations), including, but not limited to, one or more of Al³⁺, Fe³⁺, La³⁺, Rh³⁺, Ti³⁺, Cr³⁺, Ga³⁺, In³⁺, Fe⁵⁺, Nb⁵⁺, V³⁺, and V⁵⁺.

The metal-organic framework may be characterized by the formula MₐM_{b}F₅ (O/H₂O)(pyrazine)₂·x(solv), wherein Mₐ is Ni²⁺; Mb is Nb⁵⁺, Al³⁺, Fe³⁺, Fe⁵⁺, Ga³⁺, V³⁺, or V⁵⁺; x is from 0 to 10 and solv is one or more of H₂O, CO₂, DMF, EtOH, NMP, and MeOH.

An inorganic pillar of the metal-organic framework may be used to characterize the metal-organic framework. The inorganic pillar may be characterized as (M_{b}F₅(O/H₂O))²⁻, where Mb is Nb⁵⁺, Al³⁺, Fe³⁺, Fe⁵⁺, Ga³⁺, V³⁺, V⁵⁺, or any trivalent or pentavalent metal cation. The metal-organic framework may be one or more of NiNbOF₅(pyrazine)₂·2H₂O (NbOFFIVE-Ni-1) where (NbOF₅)²⁻ is the inorganic pillar, NiAlF₅(H₂O)(pyrazine)₂·2H₂O (AIFFIVEH₂O-1-Ni) where (AlF₅(H₂O))²⁻ is the inorganic pillar, and NiFeF₅(H₂O)(pyrazine)₂·4H₂O (FeFFIVEH₂O-1-Ni) where (FeF₅(H₂O))²⁻ is the inorganic pillar.

The MOFs may include a periodic array of open metal coordination sites and fluorine moieties within a contracted square-shaped one-dimensional channel. The MOFs may include a double-bonded oxygen exposed within a confined space. The MOFs may crystallize in a tetragonal space group and adopt a primitive cubic (pcu) topology. The MOFs may be tuned via selection of the metal cation to introduce open metal coordination sites to enhance the affinity for one or more fluids.

The ligand may include any bi-functional ligand. In general, the ligand may include any nitrogen-containing ligand with two nitrogen atoms. The ligand may include pyrazine. The ligand may include one or more nitrogen atoms or two or more nitrogen atoms. The ligand may include a nitrogen-containing heterocyclic ligand, such as one or more of pyridine, pyrazine, pyrimidine, triazine, imidazole, triazole, oxadiazole, and thiadiazole.

The solvent may include any chemical species present after fabrication of the metal-organic framework. The solvent may include water. The solvent may include one or more of water, dimethylformamide (DMF), diethylformamide (DEF), and alcohols, among other types of solvents. The solvent may include one or more of water, carbon dioxide, DMF, ethanol, methanol, and N-Methyl-2-pyrrolidone.

The metal-organic framework may include fluorinated metal-organic frameworks characterized by square grids and pillars. The metal-organic framework may include a pillar characterized by the formula MbF₅(O/H₂O), where Mb is Al³⁺, Fe³⁺, Fe⁵⁺, Ga³⁺ and Nb⁵⁺. The pillar may include an inorganic pillar or inorganic building block. The pillar may be characterized by the chemical formula: (AlF₅(H₂O))₂—. The pillar may be characterized by the chemical formula: (NbOF₅)²⁻. The metal-organic framework may include a square grid characterized by the formula (Mb (ligand) x), where Mₐ is Ni and the ligand is pyrazine. The square grid may be characterized by the formula (Ni(pyrazine)₂). The pillar and square grid may assemble and/or associate to form a metal-organic framework characterized by one or more of the following chemical formulas: NiNbOF₅(pyrazine)₂·x(solv) (NbOFFIVE-1-Ni) and NiAlF₅(H₂O)(pyrazine)₂·x(solv) (AIFFIVE-1-Ni). For example, the metal-organic framework may be characterized by the chemical formula: NiNbOF₅(pyrazine)₂·x(solv). For example, the metal-organic framework may be characterized by the chemical formula: NiAlF₅(H₂O)(pyrazine)₂·x(solv). The metal-organic frameworks may include a periodic array of open metal coordination sites and fluorine moieties within a contracted square-shaped one-dimensional channel. For example, the metal-organic frameworks may include AIFFIVE-1-Ni, wherein the AIFFIVE-1-Ni includes three pendant fluoride groups with a fluoride-fluoride distance of about 3.613 Å and one potential open metal site. For example, the metal-organic framework may include NbOFFIVE-1-Ni, wherein the NbOFFIVE-1-Ni includes four pendant fluoride groups with a fluoride-fluoride distance of about 3.210 and no open metal site.

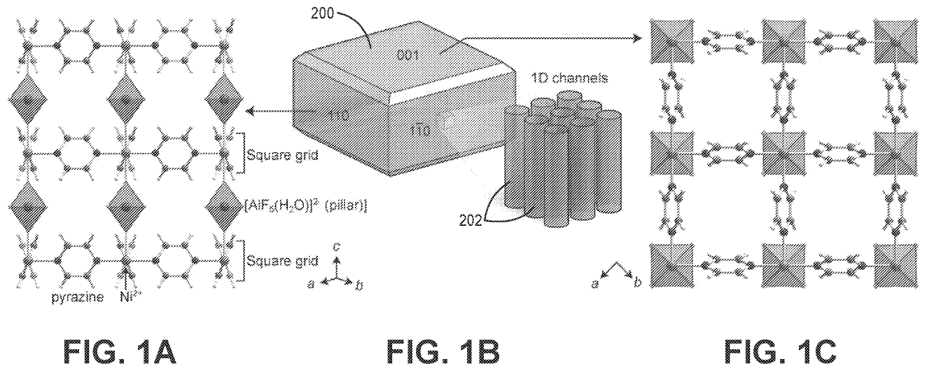

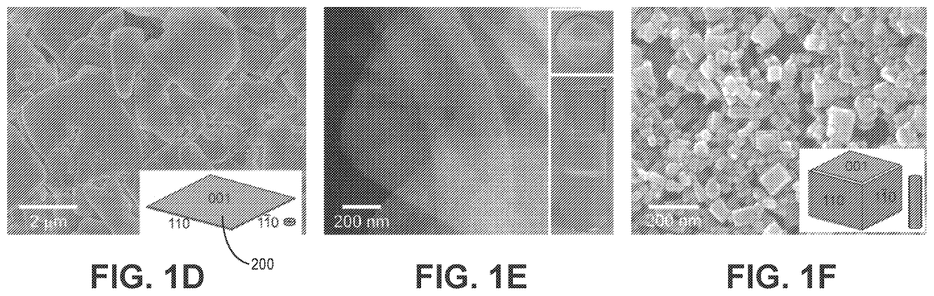

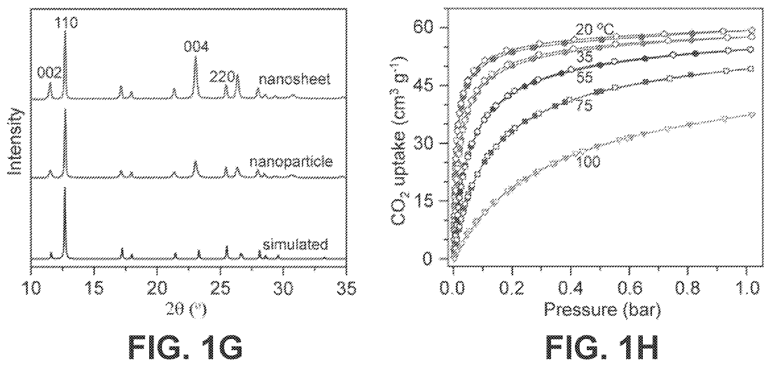

MOF Nanosheets: FIG. 1A is a structure view of an AIFFIVE-1-Ni nanosheet (nanosheet 200) along the [110] or [1-10] direction. FIG. 1B is a schematic illustration of the bipyramidal morphology of the nanosheet 200 and one dimensional (1D) channels 202. FIG. 1C is a structure view of the nanosheet 200 along the [110] direction. FIGS. 1D-1H are discussed below under Example 1 in the Examples section.

The 2-periodic square-grid layer constructed by linking Ni(II) with pyrazine ligand is pillared by [AlF₅(H₂O)]²⁻ anions in the third dimension to construct a 3-periodic framework/structure with the primitive cubic (pcu) underlying topology and pore walls comprised of [AlF₅(H₂O)]²⁻ anions, prohibiting access to the pore system in [110] and [1-10] direction. The structure consists of 1D ultra-small channels 202 that run along the [001] direction. The channels 202 are accessible to only relatively small gas molecules (e.g. He, H₂, CO₂, O₂, H₂S, N₂ etc.). The channels 202 are generally oriented in one direction that generally matches with a direction of gas flow through the nanosheets 200.

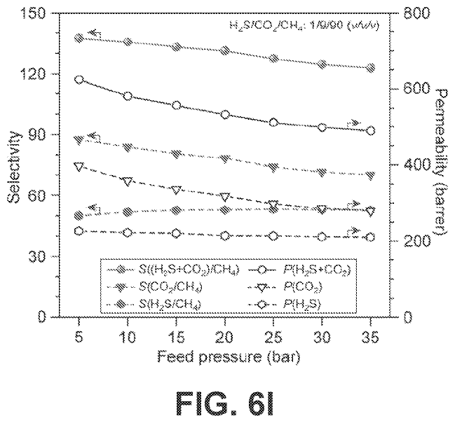

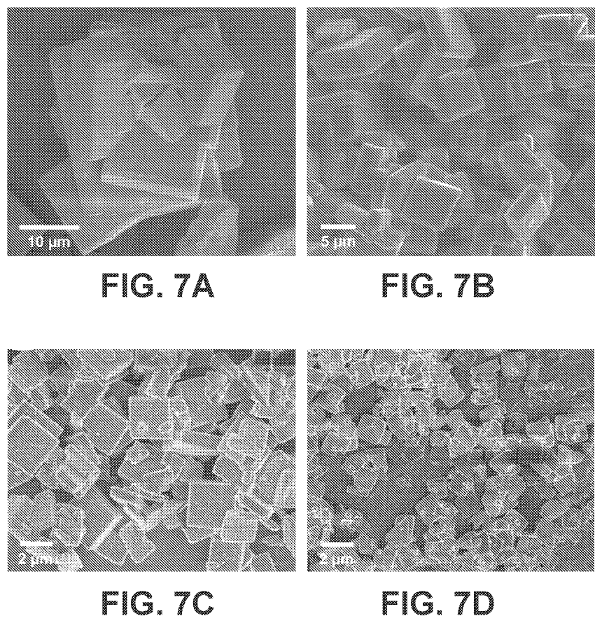

A comparison of the AIFFIVE-1-Ni nanosheet (nanosheet 200) to AIFFIVE-1-Ni crystals was performed. A scanning electron microscopy (SEM) image of AIFFIVE-1-Ni crystals obtained by conventional hydrothermal synthesis, suggest that the material is not well suited for membrane fabrication (FIG. 7). Grinding large particles into nanoparticles may not improve their gas separation performances as the majority of the nanoparticles may expose the non-accessible (110) and (1-10) facets. The 1D channels 202 of AIFFIVE-1-Ni can only be fully exploited if the morphology is controlled into nanosheets with completely exposed (001) facets. Therefore, using the methods and systems disclosed herein, the crystallographic growth along the c-direction (see FIG. 1B) is significantly reduced or suppressed relative to the desired growth along the a- and b-directions to yield high-aspect-ratio nanosheets.

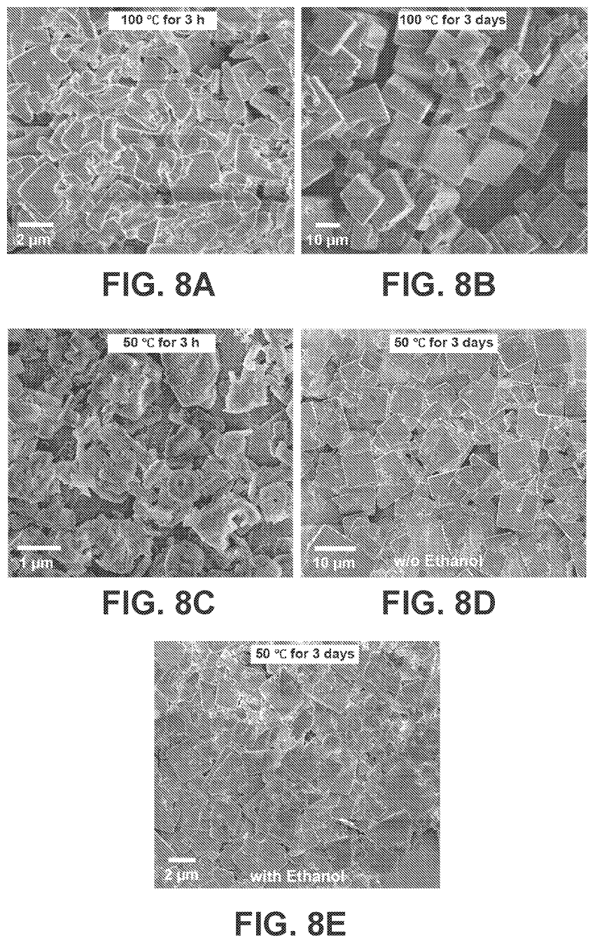

Examples 1 and 2 of the Examples section below provide a method for synthesizing the MOF nanosheets described herein. Performing the nanosheet synthesis under a reduced [AlF₅(H₂O)]²⁻ pillaring units concentration along with decreasing synthesis temperature can promote large lateral dimensions and prevent/minimize growth in the c-direction (see FIG. 1A and FIGS. 7 and 8). Further, the addition of ethanol into the reaction mixture can be effective to further reduce/minimize thickness while maintaining the nanosheet morphology.

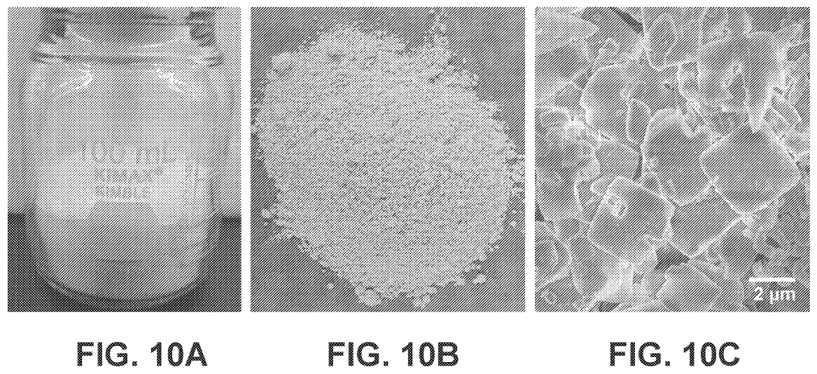

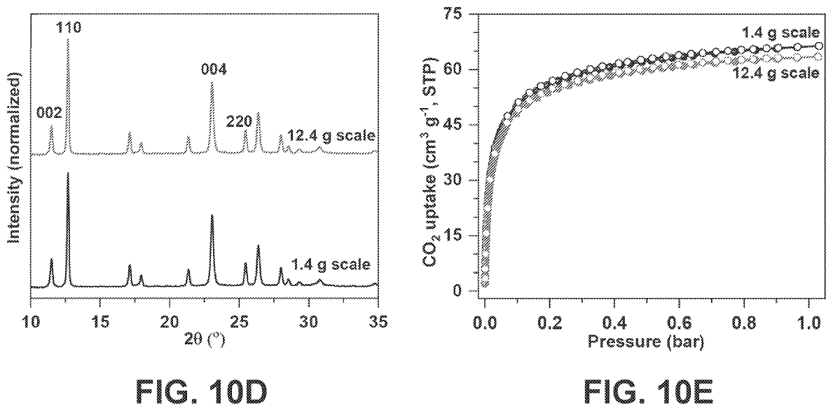

Using the methods and systems disclosed herein, the MOF nanosheet 200 can be prepared from a 3D periodic fluorinated MOF with a contracted pore system. The MOF nanosheet 200 can be prepared/synthesized without the use of a surfactant, modulator or template. Synthesis can be accomplished at a relatively low temperature, for example, 55 degrees Celsius. The MOF nanosheet 200 can be defect-free, free of undesirable substances, and scalable (FIG. 10). As described further below, a plurality of nanosheets 200 can be incorporated into a polymer matrix such that the nanosheets can have in-plane alignment with one another.

The nanosheet 200 can have the formula MₐM_{b}F₅ (O/H₂O)(pyrazine)₂·x(solv), wherein Mₐ is Ni²⁺, Mb is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH. As described above and shown in FIG. 1B, the nanosheet 200 can comprise a plurality of 1D channels 202 extending through the nanosheet 200 in the c direction. The nanosheet 200 can have an aspect ratio of at least 20, the aspect ratio being defined as the ratio of a lateral dimension of the nanosheet (in an a or b direction) to a thickness of the nanosheet (in the c direction). In some embodiments, the aspect range can be between about 20 and about 80. In some embodiments, the aspect ratio can be between about 25 and about 50.

In some embodiments, the thickness of the nanosheet 200 can range between about 20 and about 50 nm. In some embodiments, the lateral dimension of the nanosheet can range between about 0.5 and about 4 μm. In some embodiments, the MOF nanosheet 200 can include AIFFIVE-1-Ni. In some embodiments, the MOF nanosheet 200 can include FeFFIVE-1-Ni. In some embodiments, the MOF nanosheet 200 can include NbOFFIVE-1-Ni. Growth in the c direction of the nanosheet 200 can be controlled, in part, by limiting an amount of a pillar component during synthesis of the nanosheet 200. In some embodiments, a ratio of pyrazine to the pillar component is between about 10 and about 120. In other embodiments, the ratio is between about 10 and about 60. In some embodiments, a ratio of nickel to a pillar component is between about 5 and about 20. In other embodiments, the ratio of nickel to the pillar component is between about 5 and about 10. In some embodiments, ethanol can be used in the formation of the nanosheet 200 and ethanol can aid in controlling the thickness of the nanosheet.

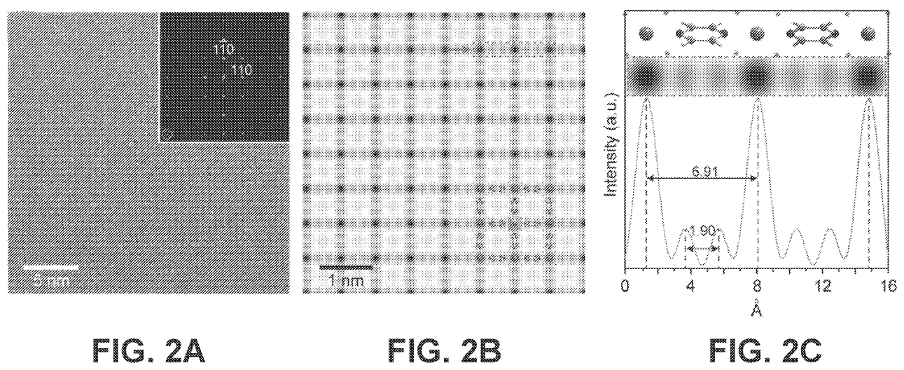

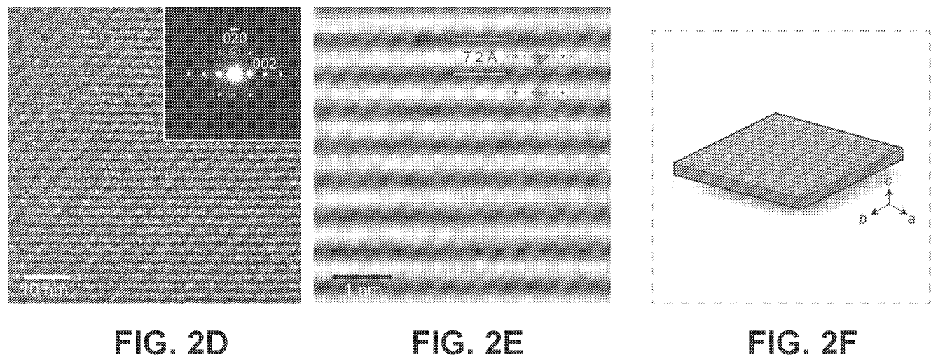

FIGS. 2A-2F are described below under Example 1 of the Examples section.

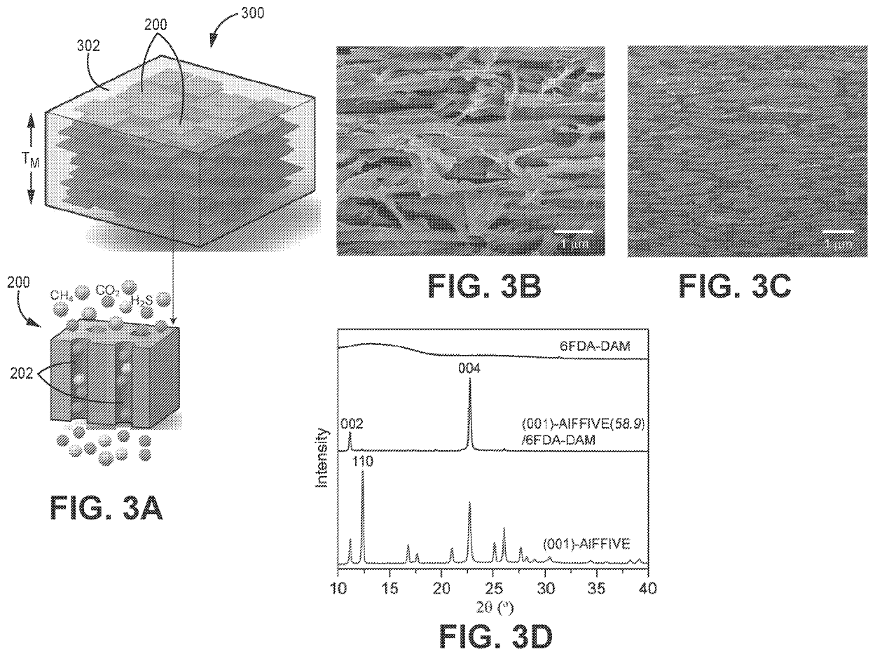

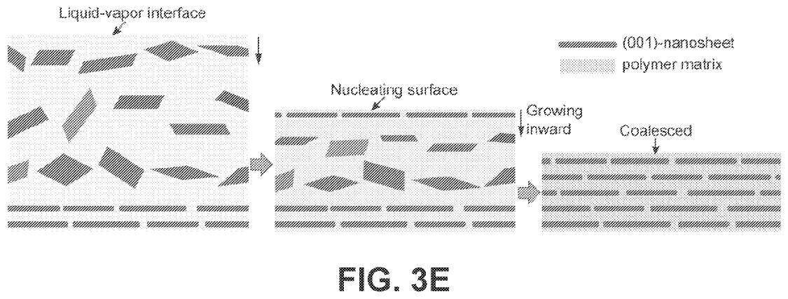

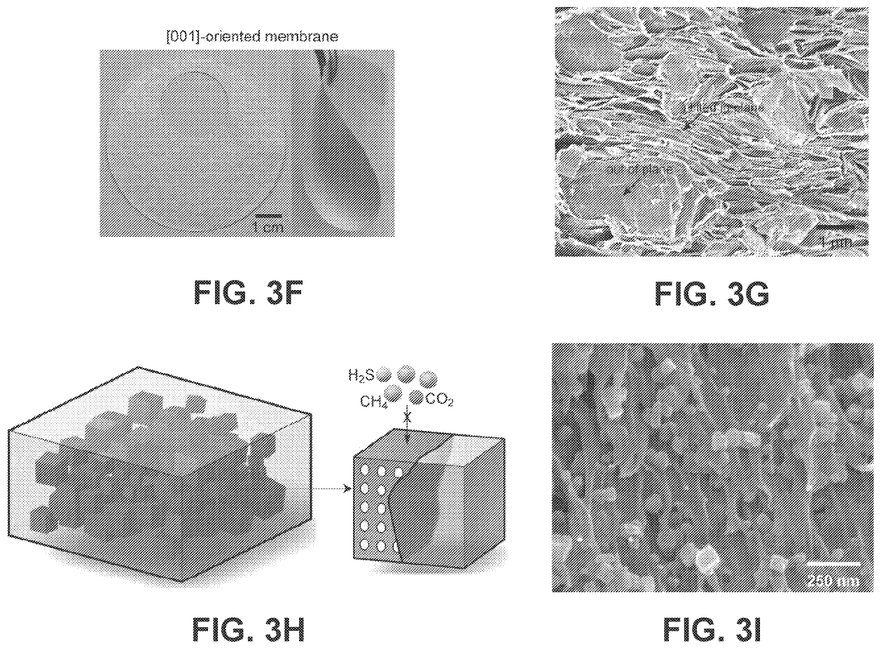

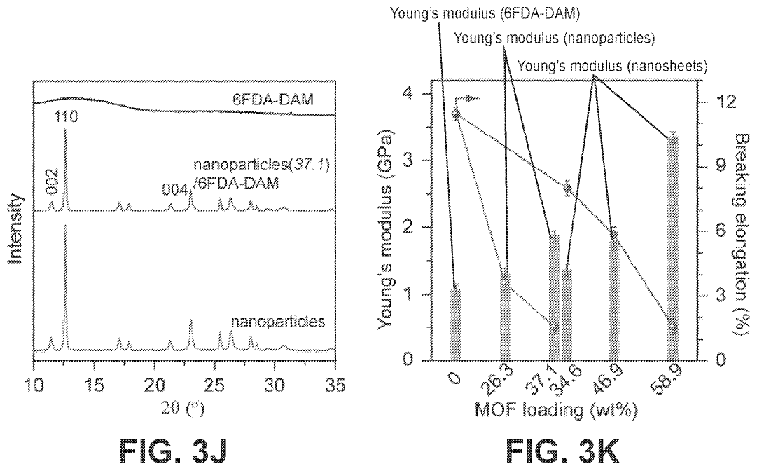

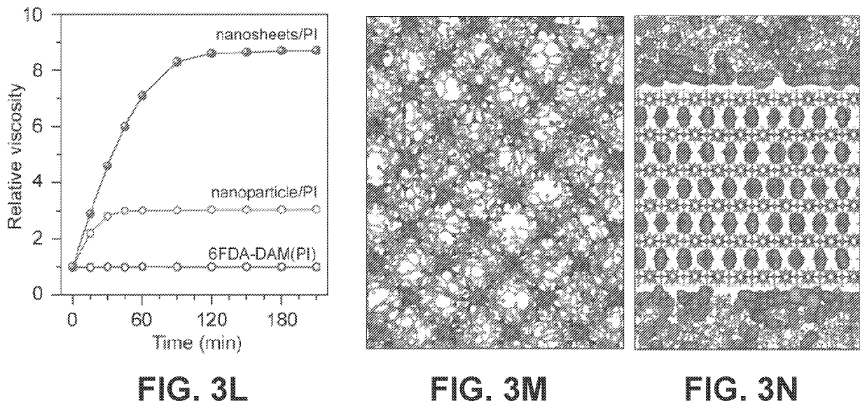

MMMOF Membrane: FIG. 3A is a schematic illustration of a [001]-oriented membrane 300 comprising a plurality of nanosheets 200 incorporated into a polymer matrix 302. The membrane 300 can also be referred to as a MMMOF membrane. Through the synthesis process for making the membrane 300, the nanosheets 200 can align with another. FIG. 3A also includes an expanded schematic of a cross-section of a nanosheet 200 from the membrane 300, the nanosheet 200 having a plurality of channels 202 formed in the nanosheet 200 for diffusion of gases. FIGS. 3B-3N are described below under Example 5 of the Examples section.

The nanosheets 200 of the membrane 300 can comprise a square grid pillared by an by an inorganic building block, the square grid being Ni(pyrazine)₂ and the inorganic building block selected from [NbOF_{5]}²⁻, [AlF₅(H₂O)]²⁻, [FeF₅(H₂O)]²⁻ and [GaF₅(H₂O]²⁻. The nanosheets 200 are incorporated into the polymer matrix 302 during formation of the membrane 300 such that the incorporated nanosheets are in-plane aligned with one another. Given this alignment of the nanosheets 200 in the membrane 300, the various 1D channels 202 of the nanosheets 200 are parallel with one another. The 1D channels 202 are parallel to a gas diffusion direction through the membrane 300.

A uniform [001]-oriented/c-oriented MMMOF membrane and translation of the 1D channel alignment from a plurality of single nanosheets into a macroscopic continuous membrane makes it feasible for an efficient molecular separation. In some embodiments, the polymer matrix 302 can be formed of at least one of 6FDA-based polyimides and 6FDA-based co-polyimides polymers. Commercially available state-of-the-art polyimide 6FDA-DAM, and lab synthesized 6FDA-DAM-DAT(1:1) and 6FDA-DAT polyimides can be used as polymer matrices owing to their high thermal and chemical stabilities, good mechanical strength, and excellent processability. In some embodiments, the polymer matrix 302 can be formed of one or more polymers that are chemically stable under exposure to acid gases. In some embodiments, the polymer matrix 302 can include one or more polymers that are thermally stable at temperatures up to about 200-300 degrees Celsius. In some embodiments, the polymer matrix 302 can include one or more polymers that are resistant to solvents, including polar and non-polar solvents.

The polymer matrix 302 can have a thickness T_{M}. In some embodiments, the thickness T_{M} is between about 40 and about 150 μm. In other embodiments, the thickness T_{M} is between about 50 and about 70 μm.

The design of the membrane 300 allows for high MOF loading. Because the nanosheets 200 have in-plane alignment with one another, there is efficient use of space by the nanosheets 200 within the membrane 300. As such, its possible for the nanosheets 200 to make up a high percentage of a total weight of the membrane 300. Moreover, the nanosheets 200 have an enhanced/strong interaction with the polymer of the polymer matrix 302. Nanosheet loading, as used herein, can refer to a weight percent of the nanosheets 200 in the membrane 300. In some embodiments, a weight of the plurality of nanosheets in the membrane 300 is at least 40 percent of a total weight of the membrane 300. In other embodiments, the weight of the plurality of nanosheets in the membrane 300 is between about 40 and about 65 percent of the membrane 300, between about 45 and about 65 percent, between about 50 and about 64 percent, between about 55 and about 64 percent, between about 58 and about 64 percent, and between about 60 and about 64 percent.

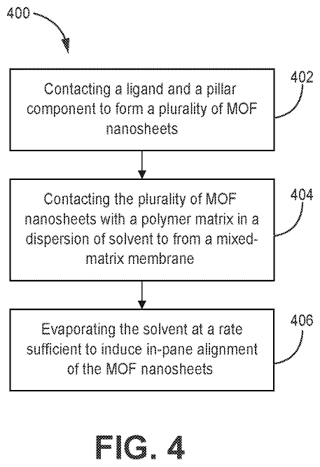

In some embodiments, the membrane 300 can be formed on a porous support. (See Example 6 below.) In some embodiments, the porous support can be formed of a-alumina. FIG. 4 is a flowchart illustrating steps in a method 400 utilized to make a mixed matrix MOF (MMMOF) membrane. At step 402, a ligand and a pillar component can be contacted together to form a plurality of MOF nanosheets. The ligand and pillar component can be contacted together at a ligand to pillar ratio between about 10 and about 120. In some embodiments, the ligand to pillar ratio is between about 10 and about 60. By limiting an amount of the pillar component, the growth of the nanosheets in a vertical direction (i.e. thickness) can be controlled. In other words, the amount of pillar component used in the synthesis of the nanosheets can help achieve a high aspect ratio for the nanosheets. In some embodiments, the ligand is pyrazine. In some embodiments, the pillar component is one or more of [NbOF_{5]}²⁻, [AlF₅(H₂O)]²⁻, [FeF₅(H₂O)]²⁻ and [GaF₅(H₂O]²⁻.

In some embodiments, a ratio of nickel to the pillar component under step 402 can be between about 5 and about 20. In other embodiments, the ratio of nickel to the pillar component can be between about 5 and about 10.

At step 404, the plurality of MOF nanosheets from step 402 can be contacted with a polymer matrix in a dispersion of solvent to form the MMMOF membrane. An amount of solvent used in step 404 can impact in-plane alignment of the nanosheets in the polymer matrix. In some embodiments, the solvent is used at a mass ratio, relative to a sum of the nanosheet and polymer, of at least 20. In some embodiments, the mass ratio of solvent to nanosheet-polymer sum is between about 22 and about 35. In some embodiments, centrifugal force can be used to aid in in-plane alignment. Step 404 can include pouring the casted solution onto a Teflon dish or other level contained surface.

At step 406, the solvent is slowly evaporated to induce in-plane alignment of the MOF nanosheets in the polymer matrix. In some embodiments, the solvent is chloroform. In some embodiments, evaporation takes place over a time ranging between about 6 and about 10 hours. In some embodiments, evaporation takes place at room temperature. In some embodiments, membrane fabrication can be performed by placing the casting solution in a glove bag to prevent rapid solvent evaporation. In some embodiments, the solution can be left in the glove bag overnight at room temperature, thus allowing the solvent to evaporate slowly. In some embodiments, the glove bag can be pre-saturated with solvent vapor prior to inserting the solution into the glove bag.

In some embodiments, the method 400 can include drying the resulting membrane from step 406. The membrane can be dried in a vacuum oven to remove any residual solvent. In some embodiments, drying can include placing the membrane in a vacuum oven at 200 degrees Celsius for a time ranging between about 15 and about 20 hours.

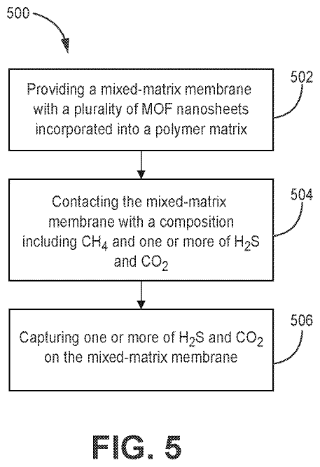

FIG. 5 is a flowchart illustrating steps in a method 500 utilized to capture chemical species from a composition including CH4 and one or more of H₂S and CO₂. At step 502, a MMMOF membrane is provided, the MMMOF membrane having a plurality of MOF nanosheets incorporated into a polymer matrix such that the incorporated nanosheets are in-plane aligned with one another and 1D channels in the nanosheets are parallel with one another. In some embodiments, a weight of the plurality of nanosheets in the mixed-matrix membrane is at least 40 percent of a total weight of the membrane. In other embodiments, the weight of the plurality of nanosheets is between about 55 and about 65 percent of the total weight of the membrane.

At step 504, the MMMOF membrane is contacted with a composition including CH4 and one or more of H₂S and CO₂. The feed composition can include a variety of concentrations for CH4, H₂S and CO₂. In some embodiments, a concentration of the composition is 50 percent CO₂ and 50 percent CH4. In some embodiments, a concentration of the composition is 20 percent CO₂ and 80 percent CH4. In some embodiments, a concentration of the composition is between about 1 and 5 percent H₂S, between about 5 and 18 percent CO₂, and between about 80 and 90 percent CH4. In some embodiments, the concentration is about 1 percent H₂S, about 9 percent CO₂, and about 90 percent CH4. In some embodiments, the concentration is about 2 percent H₂S, about 18 percent CO₂, and about 80 percent CH4. In some embodiments, the concentration is about 5 percent H₂S, about 5 percent CO₂, and about 90 percent CH4.

The composition can be fed to the MMMOF membrane at feed pressures between about 5 and about 35 bar. In some embodiments, the feed pressure is 35 bar. In some embodiments, the feed temperature is between about 20 and about 100 degrees Celsius. In other embodiments, the feed temperature is between about 75 and about 100 degrees Celsius.

At step 506, the MMMOF membrane captures one or more of H₂S and CO₂. The capture occurs via diffusion of one or more of H₂S and CO₂ through the 1D channels of the nanosheets. The MMMOF membrane, having in-plane aligned nanosheets in a polymer matrix, results in more effective transport of the molecules in the membrane. Example 7 below includes results from studying the gas separation properties of the MMMOF membrane. Those results include enhanced CO₂/CH4 selectivity.

For existing membrane designs, increasing the temperature at contact significantly affects the CO₂/CH4 separation. Membranes using pure polymer and nanoparticle membranes both exhibited a deterioration in selectivity and permeability at high temperatures. In contrast, the MMMOF membranes exhibited increased CO₂ permeability with increasing temperature, while retaining selectivity. The CO₂/CH4 separation at elevated temperatures is the consequence of: enhanced CO₂ diffusion via 1D channels of the MOF nanosheets, uniform in-plane alignment of the nanosheets, and high nanosheet loading.

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### Examples

### Materials

The following materials were used in the Examples below:

Nickel (II) nitrate hexahydrate (Ni(NO₃)₂·6H₂O, 99.99%, Aldrich), nickel (II) acetate tetrahydrate (Ni(OCOCH₃)₂·4H₂O, 99%, Organics), iron (III) nitrate nonahydrate (Fe(NO₃)₂·9H₂O, 99.95%, Aldrich), aluminum (III) nitrate nonahydrate (Al(NO₃)₃·9H₂O, 99.99%, Aldrich), aluminum (III) hydroxide hydrate (Al(OH)₃·xH₂O, Aldrich), pyrazine (C₄H₄N₂, 99%, Aldrich), hydrofluoric acid (HF, 48 wt % in H₂O), methylpyridine (C₆H₇N, 99%, Sigma-Aldrich), acetic anhydride ((CH₃CO)₂O, 98%, Sigma-Aldrich), N-methyl-2-pyrrolidone (NMP, CH₉NO, 99.5%, Sigma-Aldrich), chloroform (CHCl₃, 99.8%, Sigma-Aldrich), tetrahydrofuran (THF, 99%, Sigma-Aldrich), dichloromethane (DCM, 99.9%, Sigma-Aldrich), methanol (CH₃OH, 99.9%, VWR), ethanol (C₂H₅OH, 99.7%, VWR), were purchased and used.

4,4′-(Hexafluoroisopropylidene)diphthalic anhydride (C₁₉H₆F₆O₆, 6FDA, 99%, Sigma-Aldrich), diamine 2,4,6-trimethyl-1,3-diaminobenzene ((CH₃)₃C₆H(NH₂)₂, DAM, 96%, Sigma-Aldrich), 2,6-diaminotoluene (DAT) (CH₃C₆H₃(NH₂)₂, DAT, 97%, Sigma-Aldrich) were purchased and purified by sublimation. Polyimide 6FDA-DAM (Mw =330 kDa, PDI: 2.48) was purchased from Akron Polymer Systems, Inc.

H₂ (99.999%), N₂ (99.999%), CO₂ (99.999%), CH₄ (99.999%), C₃H₆ (99.5%), C₃H₈ (99.5%) and mixed gases consisting of CO₂/CH₄: 50/50, 20/80, 10/90 and H₂S/CO₂/CH₄=1/9/90, 2/18/80, 5/5/90 were purchased from Air Liquid and AHG.

### Example 1—Synthesis of (001)-AIFFIVE-1-Ni(C₈H₁₄AlF₅N₄NiO₃) Nanosheets

Pyrazine (C₄H₄N₂, 1.80 g, 22.03 mmol) was dissolved in 9 ml of 2:1 (v/v) mixture ethanol-H₂O. Subsequently, nickel acetate tetrahydrate (Ni(OCOCH₃)₂·4H₂O, 2.20 g, 8.84 mmol) was added into the above solution and the solution was sonicated for 2 minutes. Separately, aluminum hydroxide (Al(OH)₃, 0.32 g, 4.10 mmol) was dissolved in 4 ml of 3:1 (v/v) mixture HF—H₂O. These two solutions were mixed together and sonicated for 3 minutes, and a sky blue mixture was formed. The solvothermal reaction was carried out at 50° C. for 3 days under a static condition. The precipitated product was collected by centrifugation at 5000 rpm, and washed with total 300 ml of water, and subsequently washed with 60 ml of ethanol. Finally, nanosheets was dispersed in required amount of CHCl₃, THF or DCM solution.

(001)-AIFFIVE-1-Ni nanosheets stock solution: To prevent agglomeration, nanosheets was not dried before film casting and formation. Concentrations of nanosheets in CHCl₃, THF or DCM solution was adjusted to be around 100 mg of MOF/ml solution.

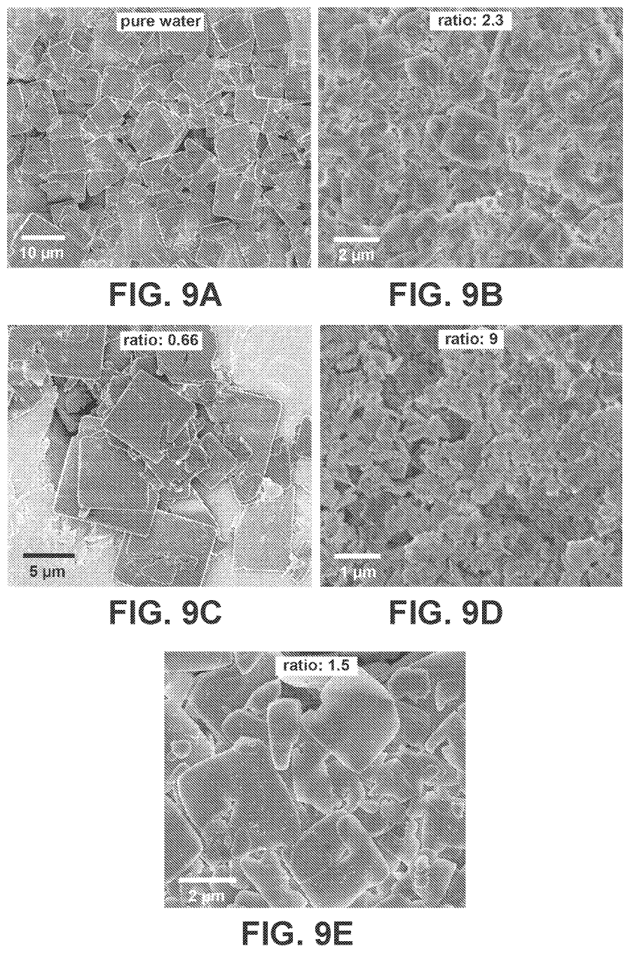

Adjusting the synthesis conditions afforded the crystal morphology control from aggregated truncated bipyramidal morphology to nanosheets (FIG. 1D and FIGS. 7 to 9). SEM images reveal that synthesized square-shaped nanosheets exhibit an average lateral dimension of 0.5-4 μm and thickness in the range of 20-50 nm, resulting in an aspect ratio greater than 25 (FIG. 1D). A scanning transmission electron microscopy (STEM) image of nanosheets (FIG. 1E) corroborates the higher aspect ratio. The nanosheets dispersion is supported by the observed Tyndall effect using a green laser (FIG. 1E, inset). Powder X-ray diffraction (PXRD) pattern of the material (FIG. 1G), shows preferred orientation effect of (001)-nanosheets with the 00l (l=2n) reflections significantly enhanced, further confirming the successful synthesis of nanosheets with AIFFIVE-1-Ni structure.

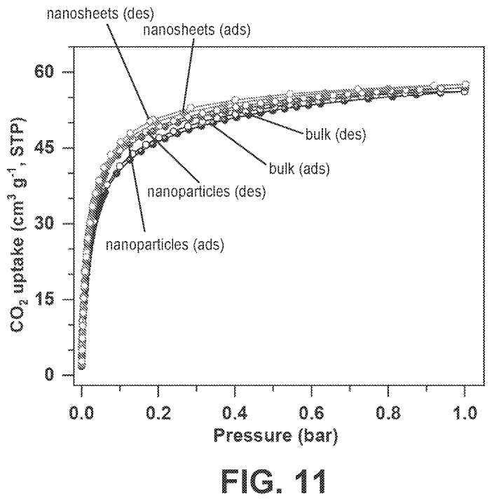

For comparison, nanoparticles were also synthesized (FIG. 1F). See Supplementary Examples and Methods below for nanoparticle synthesis. SEM images reveal that nanoparticles are fairly uniform with particle size of about 50-120 nm and PXRD confirmed AIFFIVE-1-Ni structure (FIG. 1G). The CO₂ sorption isotherms affirm that bulk material, nanosheets and nanoparticles exhibit similar CO₂ uptake capacity (FIG. 11). Variable temperature CO₂ adsorption isotherms on nanosheets are shown in FIG. 1H. The versatility and scope of the MOF nanosheets was further evaluated with the fabrication of FeFFIVE-1-Ni nanosheets—see Example 3 below.

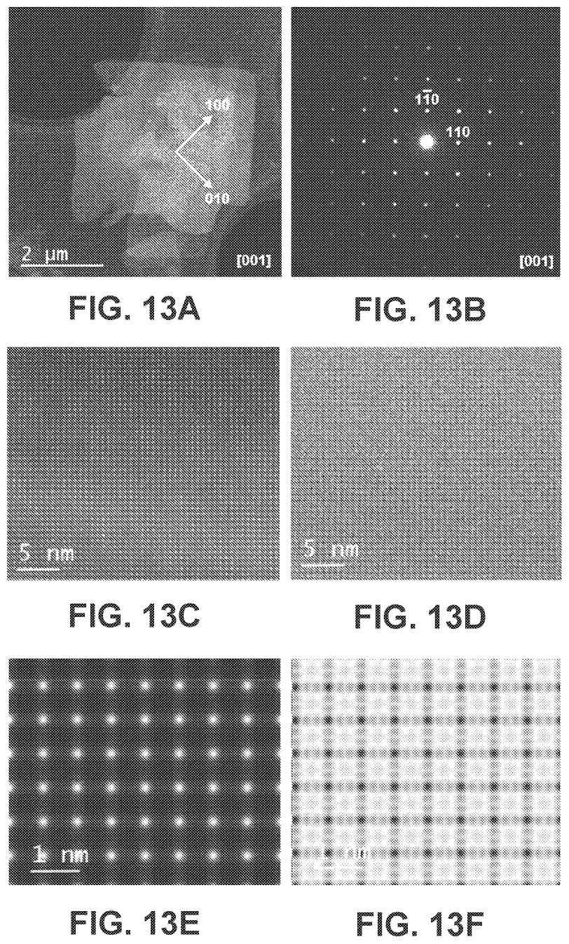

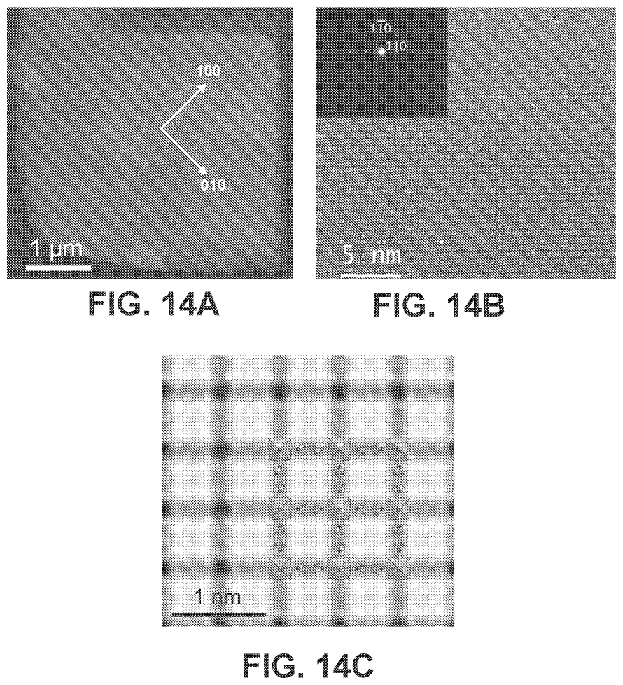

FIG. 2 shows Cₛ-corrected STEM images of the AIFFIVE-1-Ni nanosheet acquired from different zone axes. Annular Bright-Field (ABF) images taken with the Cₛ-corrected STEM from the nanosheet along the [001] and the [100] directions were shown in FIG. 2, A and D, respectively. The images offer an unambiguous visualization of the atomic structure, and the corresponding Fourier Diffractogram (FD), and selected area electron diffraction (SAED) pattern were inserted at the top right in the images with indices based on the space group I4/mcm with a=9.86 Å and c=15.25 Å. The image resolution was confirmed to be 1.6 Å by 0-60 reflection marked by a red circle in the FD of FIG. 2A, and was among the highest spatial resolution ever achieved for any MOFs. This observation (and FIGS. 13 and 14) corroborates the preferential crystal orientation, (001)-AIFFIVE-1-Ni nanosheets. Symmetry averaged image of FIG. 2A with p4mmm improved signal-to-noise ratio greatly and specified the atoms (FIG. 2B). Strong dark spots were observed with separation of ≈6.91 Å, consistent with the distance between adjacent inorganic extended chains (columns) formed by —F—Ni—F—Al—F—(FIG. 2C). Additionally, two weak dark elongated signals were also observed between the strong dark spots (separated by ≈1.9 Å), which can be attributed to a part of pyrazine, 2 carbon and 1 nitrogen atoms, acting as a linker between adjacent Ni(II).

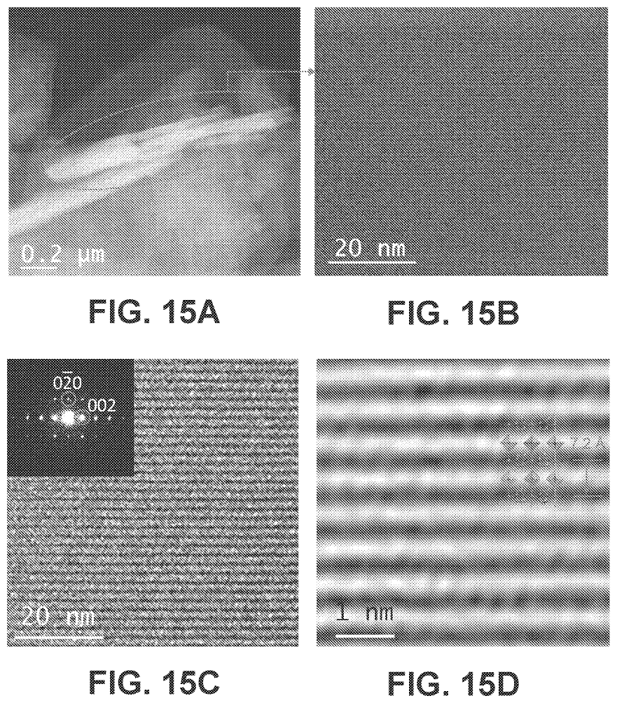

High-resolution ABF images were taken with the [100] incidence, which is perpendicular to the direction (FIG. 2D and FIG. 15). FIG. 2D visualizes the square grid of Ni(II) and pyrazine pillared by [AlF₅(H₂O)]²⁻, where the dark contrast is associated with Ni(II). The crystal structure of AIFFIVE-1-Ni along [100] direction matches well the corresponding experimental ABF image (FIG. 2E, and FIG. 15). This in-depth STEM study confirms the successful synthesis of (001)-AIFFIVE-1-Ni nanosheets (also referred to as (001)-AIFFIVE or (001)-nanosheets) with excellent crystallinity and maximum exposure of 1D channels (FIG. 2F), which is a highly desirable morphology for achieving in-plane alignment of nanosheets in the polymer matrix.

### Example 2—Scale-Up Synthesis of (001)-AIFFIVE-1-Ni Nanosheets

In a typical synthetic procedure, pyrazine (18 g) was dissolved in 90 ml of 2:1 (v/v) mixture ethanol-H₂O. Subsequently, nickel acetate tetrahydrate (22 g) was added into the above solution and the solution was sonicated for 4 minutes. Separately, aluminum hydroxide (3.2 g) was dissolved in 40 ml of 3:1 (v/v) mixture HF—H₂O. These two solutions were mixed together and sonicated for 10 minutes. The solvothermal reaction was carried out at 50° C. for 3 days under a static condition. The precipitated product was collected by centrifugation at 5000 rpm, and washed with water, and subsequently washed with ethanol. The obtained yield is 12.4 g (FIG. 10).

### Example 3—Synthesis of FeFFIVE-1-Ni Nanosheets

Pyrazine (C₄H₄N₂, 1.80 g, 22.03 mmol) was dissolved in 9 ml of 2:1 (v/v) mixture ethanol-H₂O. Subsequently, nickel acetate tetrahydrate (Ni(OCOCH₃)₂·4H₂O, 2.20 g, 8.84 mmol) was added into the above solution and the solution was sonicated for 2 minutes. Separately, iron nitrate nonahydrate (Fe(NO₃)₂·9H₂O, 1.63 g, 4.03 mmol) was dissolved in 5 ml of 4:1 (v/v) mixture HF—H₂O. These two solutions were mixed together and sonicated for 3 minutes. The solvothermal reaction was carried out at 100° C. for 12 hours under a static condition. The precipitated product was collected by centrifugation at 5000 rpm, and washed with total 300 ml of water, and subsequently washed with 60 ml of ethanol.

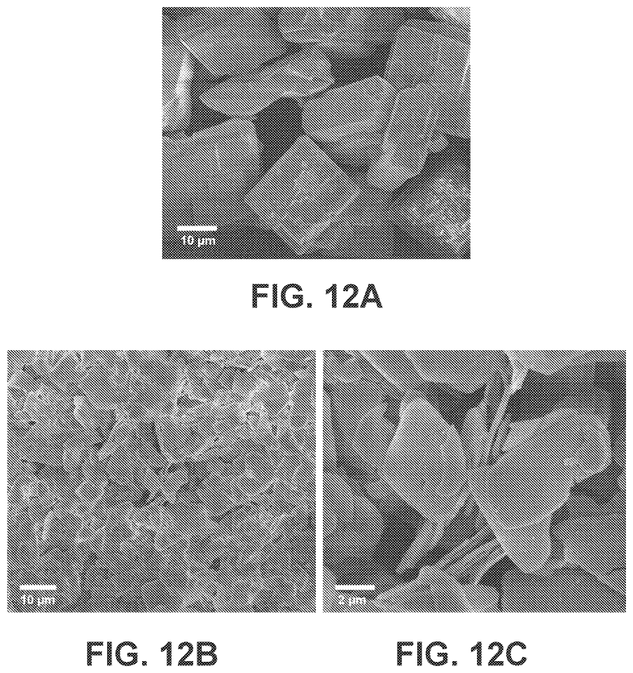

See FIG. 12 for SEM images comparing FeFFIVE-1-Ni crystals and nanosheets.

### Example 4—Synthesis of 6FDA-Polyimide Polymers

Polyimide polymers were synthesized via condensation of dianhydride monomers with a diamine. Typically, stoichiometric amounts of monomers and diamines were agitated and reacted in a 20 wt % 1-methyl-2-pyrrolidinone (NMP) solution under N₂ purge at low temperature (~5° C.) for 24 h to produce a high molecular weight polyamide acid (PAA) solution. Then chemical imidization was achieved in the presence of 3-methylpyridine and acetic anhydride at ambient temperature for 24 h under N₂ purge, and the resulting polyimide was precipitated and washed with methanol and dried at 210° C. under vacuum for 24 h. Monomers comprising (4,4′ hexafluoroisopropylidene)diphthalic anhydride (6FDA) and 2,6-diaminotoluene (DAT) were used to synthesize 6FDA-DAT polymer. The molecular weight of the synthesized 6FDA-DAT was 164,000 g mol-1 with a polydispersity index (PDI) of 1.92. Also, monomers comprising 6FDA, 2,4,6-trimethyl-1,3-phenylenediamine (DAM) and 2,6-diaminotoluene (DAT) were used to synthesize 6FDA-DAM-DAT with the DAM/DAT molar ratio of 1:1 according to reported procedure. The molecular weight of the synthesized 6FDA-DAM-DAT was 165,000 g mol-1 with a polydispersity index (PDI) of 2.12. Prior use, 6FDA was purified once by vacuum sublimation, DAM and DAT were purified three times by vacuum sublimation. N-methyl-2-pyrrolidone (NMP) was vacuum distilled immediately before use. Finally, all the polymer was precipitated into methanol, washed with methanol three times, and dried over several days under vacuum at 120° C.

### Example 5—[001]-Oriented ((001)-AIFFIVE/6FDA-Polyimides) MMMOF Membranes Fabrications

Uniformly 001-oriented AIFFIVE-1-Ni nanosheets/mixed-matrix metal-organic framework (MMMOF) membranes were prepared by “slow evaporation-induced in plane alignment” of (001)-AIFFIVE nanosheets in a polymer matrix. MMMOF membranes with various nanosheets loading in a thickness range of 50-70 μm were fabricated by dissolving the appropriate amount of polyimides (6FDA-DAM, 6FDA-DAM-DAT or 6FDA-DAT) and (001)-AIFFIVE nanosheets in CHCl₃ solvent.

Polymer solution preparation: A polymer solution was prepared by dissolving 150 mg of dried polyimides (6FDA-DAM, 6FDA-DAM-DAT or 6FDA-DAT) in 2 mL of CHCl₃ by shaking on a mechanical shaker for 3 h at room temperature.

MOF suspension preparation: A required amount of aliquot from (001)-AIFFIVE nanosheets stock solution (1.02 ml for 40 wt %, 1.50 ml for 50 wt % and 2.25 ml for 60 wt % MMMOF membranes) was added in a 25 ml glass vial and a required amount of CHCl₃ was added in order to maintain a total volume of 2.5 ml.

To this MOF suspension, 10% of the polymer solution was added and the suspension further stirred for 30 min (priming). After that, the remaining polymer solution was added to the MOF suspension and stirred for 150 minutes at 35° C. The resulting casting solution was poured in a Teflon dish on a leveled surface, which was placed in a glove bag pre-saturated with CHCl₃ vapour for at least 1 h. The dish was left in the glove bag overnight at room temperature to allow the CHCl₃ solvent to evaporate slowly. The freestanding [001]-oriented MMMOF membrane was then dried in a vacuum oven at 200° C. for 20 h to remove any residual CHCl₃.

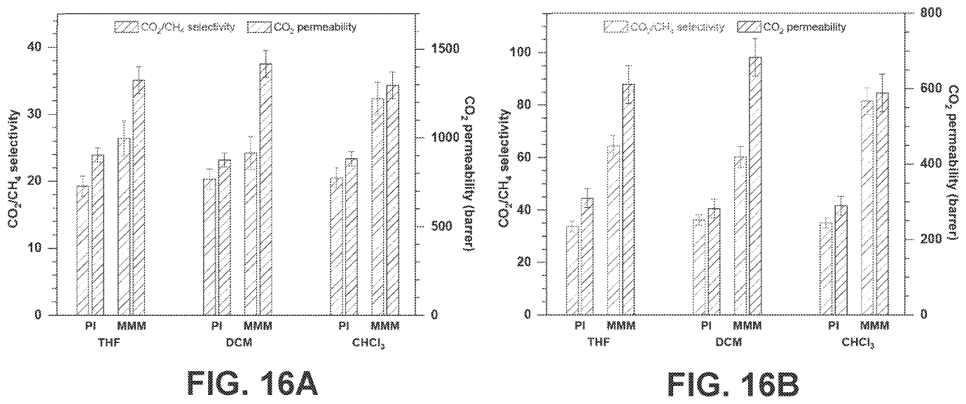

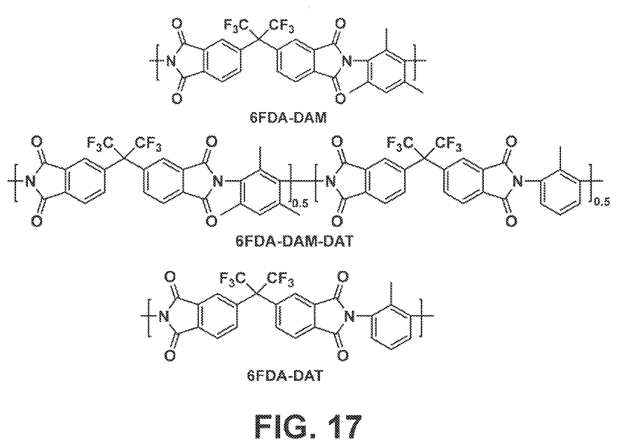

Three different solvents (CHCl₃, THF, and DCM) were evaluated as dispersant mediums to evaluate the effect of solvents for fabrication of the MMMOF membrane and resultant CO₂/CH₄ separation. A solution-casting method was performed to fabricate pure polymeric and MMMOF membranes with a thickness of 50-70 μm (supplementary method). The solvents effect in pure polymeric membranes was minimal. In the MMMOF membrane, CHCl₃ presented higher CO₂/CH₄ selectivity followed by THF and DCM (FIGS. 16 and 17, and table S1). By evaluating the nanosheets' dispersibility in different solvents and allowing the nanosheets to sediment, it was observed that nanosheets begin sedimentation after ~6 to 8 hours in DCM, ~22 to 25 hours in THE, and no sedimentation in CHCl₃ even after 5 days. Thus, higher selectivity can be attributed to the nanosheets having better dispersibility that prevents nanosheets sedimentation and/or agglomeration during membrane fabrication, resulting in homogeneous nanosheet alignment inside the polymer matrix.

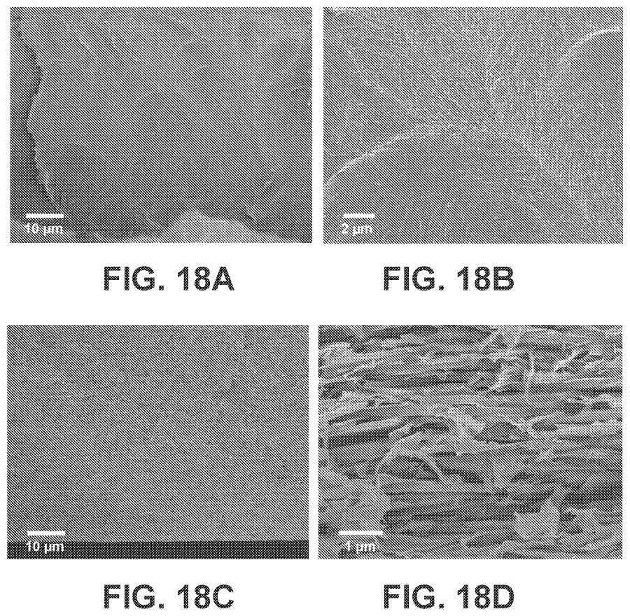

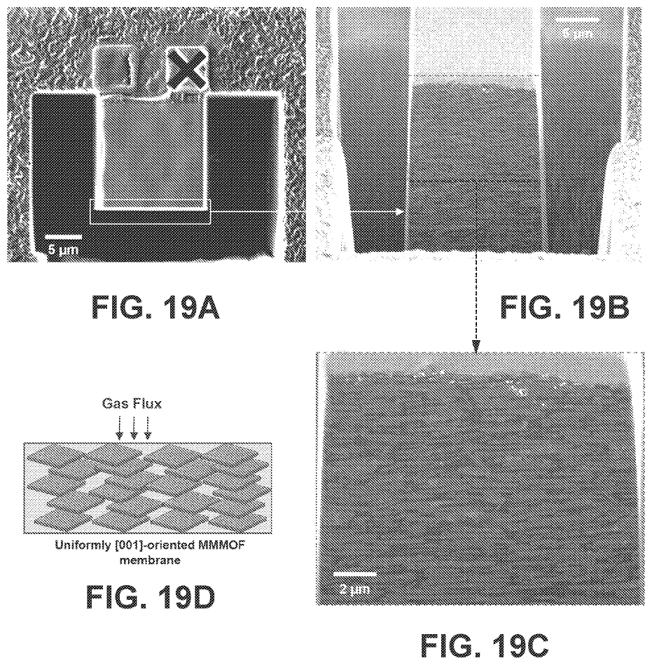

The MMMOF membrane formed above had 58.9 wt % nanosheets in 6FDA-DAM [(001)-AIFFIVE(58.9)/6FDA-DAM (parenthesis refer to MOF nanosheet loading by wt %). The cross-section SEM images in FIG. 3B and FIG. 18 reveal a uniform in-plane alignment of nanosheets in the polymer matrix. The focused ion beam SEM (FIB-SEM) images on an extensive area evidence that the majority of nanosheets are uniformly and in-plane aligned throughout the membrane (FIG. 3C, FIG. 19). There is an excellent nanosheets-polymer interface compatibility for the MMMOF membrane. XRD patterns of associated membrane (FIG. 3D) show only two major Bragg diffractions (indexed as the (002) and (004) crystallographic planes of AIFFIVE-1-Ni structure) corroborating the strong preferential in-plane alignment of (001)-nanosheets and the attainment of the desired uniform [001]-oriented MMMOF continuous membrane. These results demonstrate that the successful translation of single (001)-nanosheets into a [001]-oriented macroscopic membrane, where 1D channels of nanosheets are all parallel, an ideal scenario for distinct molecular separation (FIG. 3A).

Here, the (001)-nanosheets in-plane (c-axis) alignment is induced by a slow evaporation of solvent in the course of the membrane fabrication process. This “slow evaporation-induced in-plane alignment of nanosheets” is shown in FIG. 3E. During slow solvent evaporation, nanosheets gradually self-arrange according to the minimum energy configuration. The nanosheets concentration gradient and presence of the liquid-vapor interface may assists as a nucleating surface origins in-plane aligned nanosheets domains to grow gradually inward (FIG. 3E). If the solvent evaporation process is relatively fast, the nanosheets alignment may be kinetically affected and the final alignment may consolidate into a thermodynamically unfavored state (FIG. 3G). In addition, solvent/(nanosheet+polymer) mass ratio of 22-35 was found to be an optimal range for suitable in-plane alignment. Centrifugal force can also align nanosheets, accordingly [001]-oriented ultrathin membrane on porous α-Al₂O₃ support (see Example 6 below) was prepared by spin coating method.

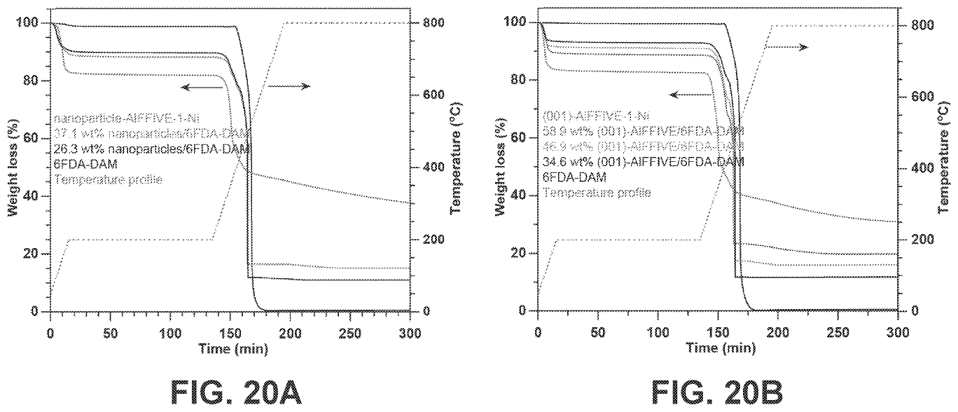

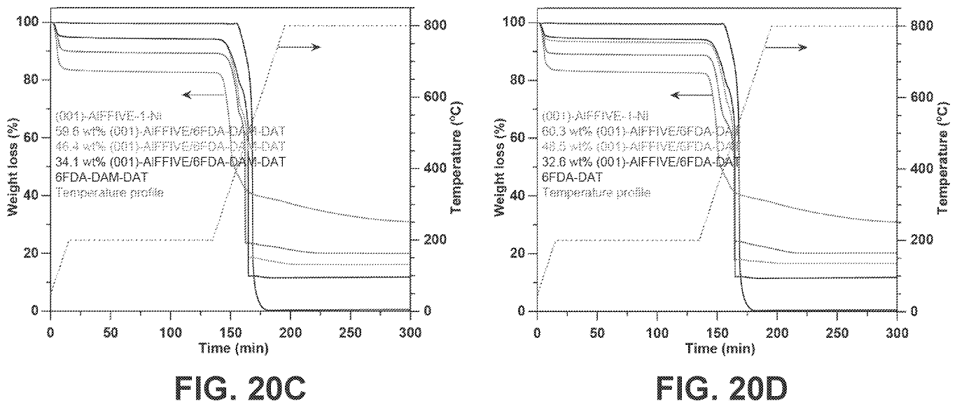

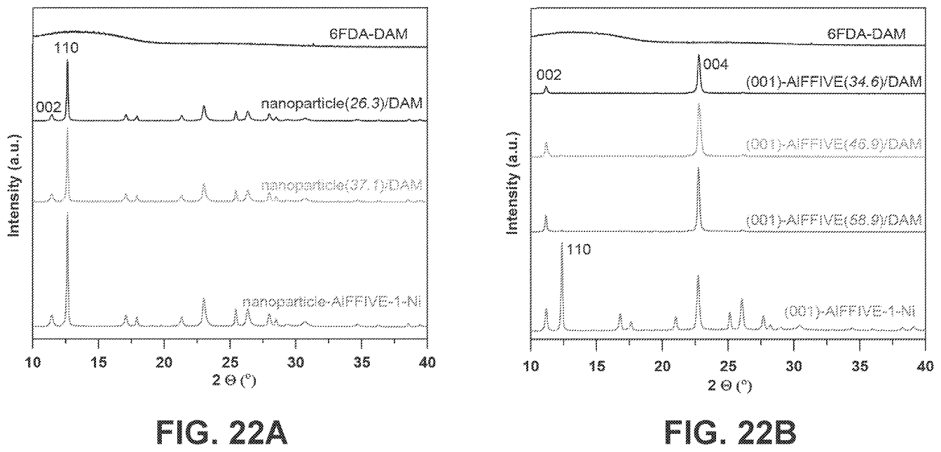

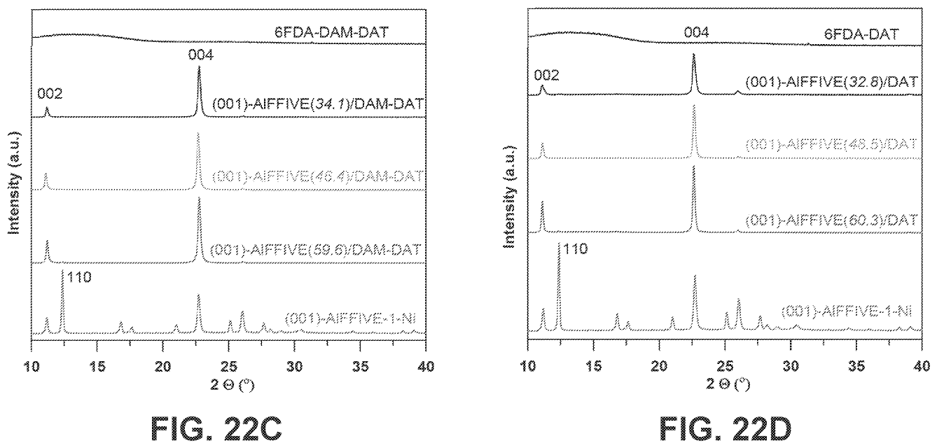

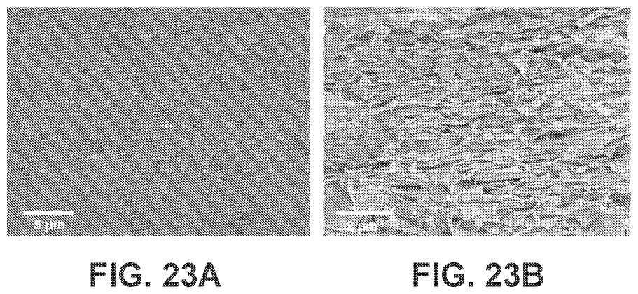

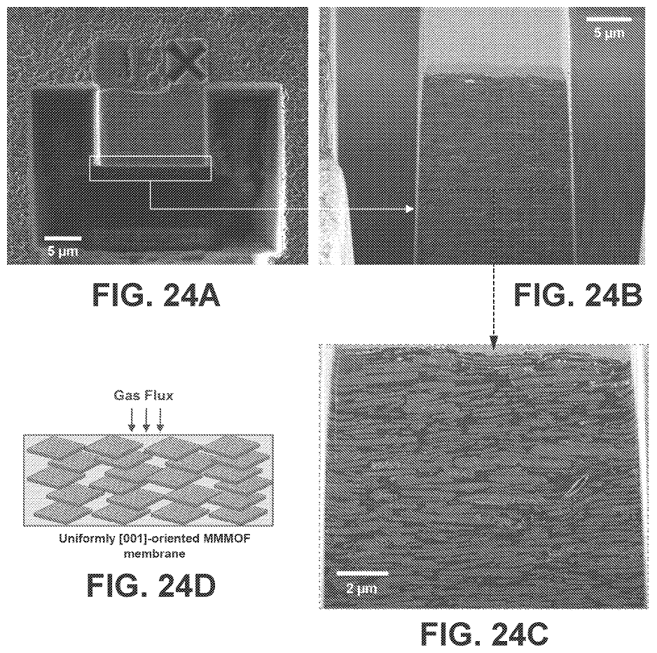

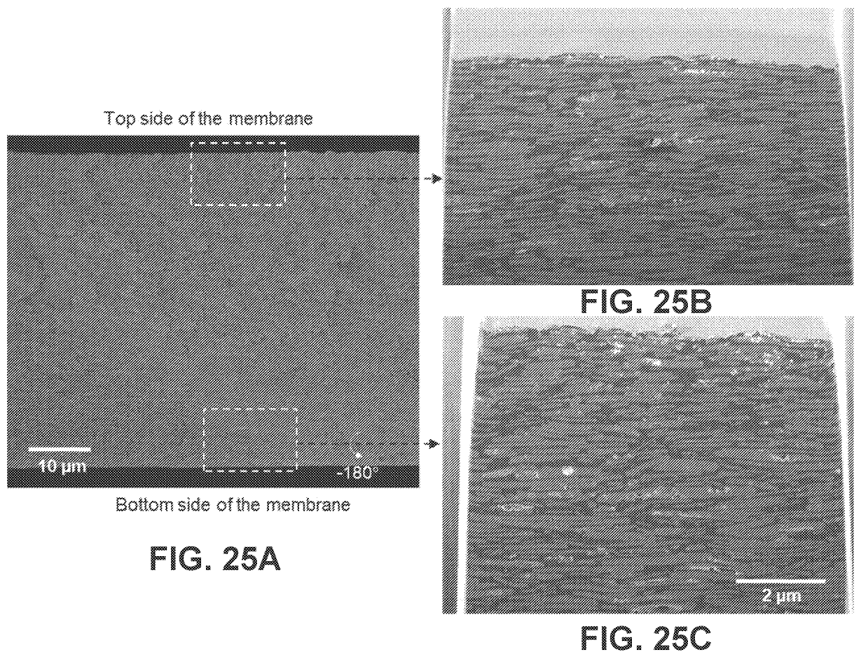

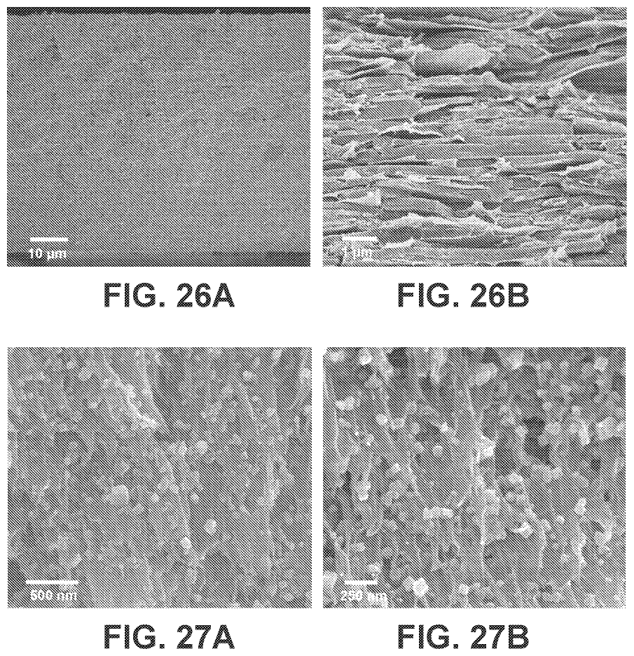

MOF loading, and associated properties of membranes were additionally analyzed by thermogravimetric analysis, Fourier transform infrared spectroscopy and XRD (FIGS. 20 to 22). Nanosheets were obtained with loadings up to 59.9 wt % in 6FDA-DAM-DAT and 60.3 wt % in 6FDA-DAT, importantly, nanosheets loadings (up to 60 wt %) are remarkably high than isotropic fillers loadings (<35 wt %). The ability to increase nanosheets loading offers an opportunity to closely mimic the associated pure MOF membrane, as well as to improve the separation performance of the membranes since the agglomeration, sedimentation, and random orientation of nanosheets within the polymer matrix is circumvented at high loadings. In the present case, no such adverse effects were observed (FIGS. 23 to 26).

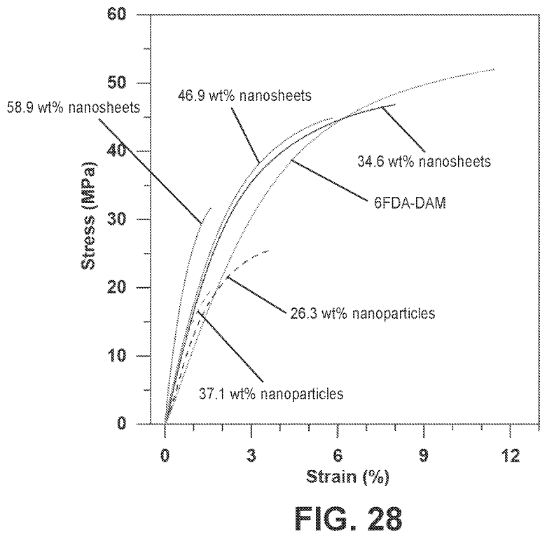

Schematic illustrations of randomly oriented AIFFIVE-1-Ni nanoparticles embedded in the polymer matrix is shown in FIG. 3H. The cross-section SEM image and XRD patterns of 37.1 wt % nanoparticles in 6FDA-DAM polymer showed a random orientation of the nanoparticles inside a polymer matrix (FIGS. 31 and 3J, and FIG. 27). Young's modulus and elongation strain of nanoparticles and nanosheets containing membranes were evaluated (FIG. 3K, and FIG. 28). It was found that the incorporation of nanoparticles or nanosheets into a polymer matrix results in an enhancement of Young's modulus and this enhancement was substantial in nanosheets containing membranes (FIG. 3K and table S3), which can be attributed to the better compatibility between nanosheets and polymer. Membranes fabricated using nanoparticles maintain good mechanical properties at relatively low MOF loading (26.3 wt %). Nanoparticle loadings up to 37.1 wt % were possible before the membrane became defective or too fragile to handle for gas separation studies. High loading (58.9 wt %) was possible using nanosheets (FIG. 3K, and FIG. 28). Nanosheets proffered smooth and extended external surface area compared to nanoparticles, which promoted interactions with the polymer. The optimum nanosheets loading was found up to 64 wt %. Beyond this limit the resultant membrane was difficult to handle for gas separation studies due to its apparent fragility and plausible defects, resulting in relatively high permeability with lower selectivity.

It was determined that there was an enhanced interaction between nanosheets and polymer. The MOF-polymer suspension was prepared by stirring (250 rpm) at 35° C. for 2 hours before membrane casting. The MOF-polymer suspension became viscous and the relative viscosity change of nanosheets-polymer was considerably higher than that of nanoparticle-polymer suspension (FIG. 3L). The higher viscosity of suspension implies the enhanced nanosheets-polymer interaction, possibly hydrogen bonding interaction between the imide groups of the 6FDA and the H of the pyrazine from (001)-nanosheets is plausibly providing better mechanical properties of nanosheet-incorporated membranes.

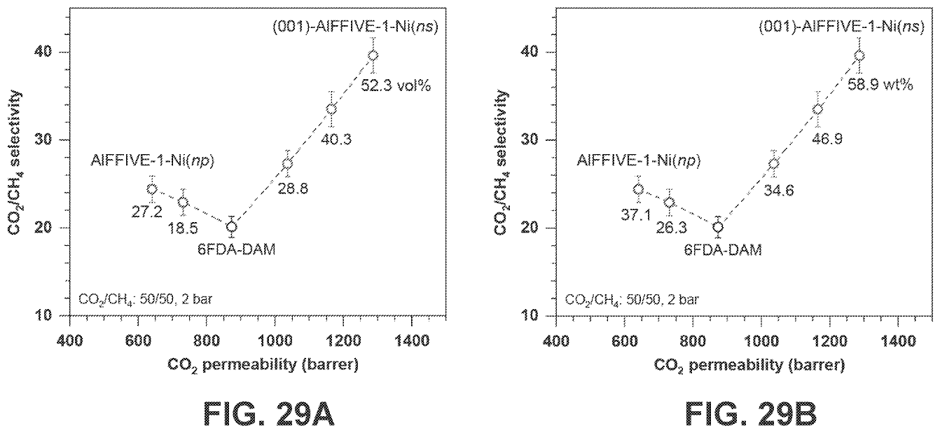

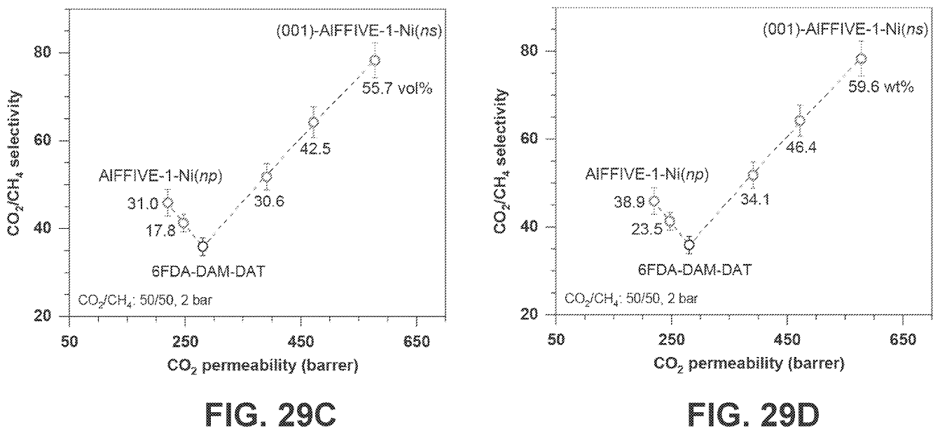

The gas separation performances of nanoparticles and (001)-nanosheets containing membranes were assessed under an equimolar CO₂/CH₄ mixture, and compared based on the volume and weight fraction (FIG. 29). Regardless, the nanosheet membranes demonstrated substantially better separation. Even at similar MOF loading nanosheets offered higher permeability and selectivity (FIG. 29). Nanoparticles always compensate permeability to gain selectivity that can be attributed to random orientation of nanoparticles with non-permeable (110) and (1-10) facets perpendicular to gas diffusion direction (FIG. 3I), ascertaining the importance of (001)-nanosheet morphology.

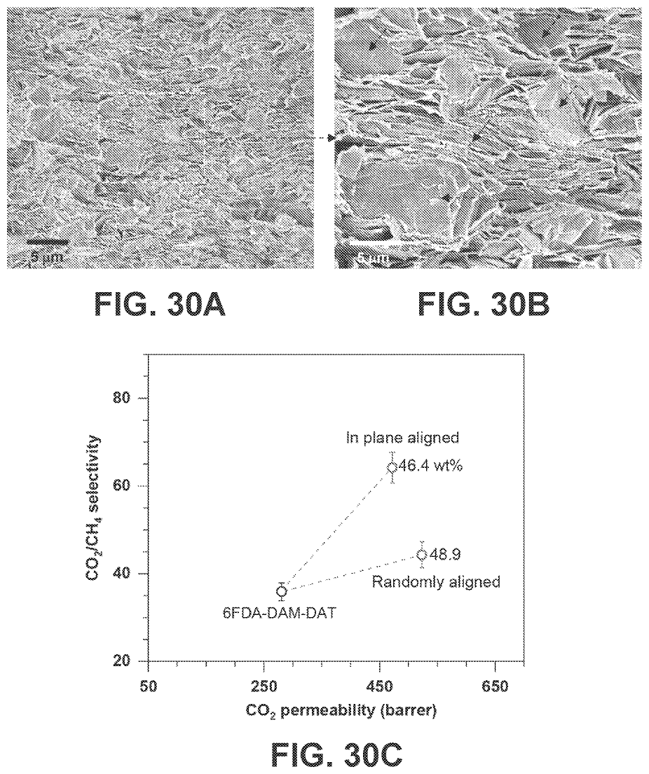

A membrane was fabricated using (001)-nanosheets in randomly aligned fashion and evaluated CO₂/CH₄ separation (FIG. 30). The membrane presented high permeability but significantly reduced selectivity, presumably due to the presence of non-selective gas diffusion path associated to discontinuity of nanosheets staking as revealed by SEM images (FIG. 3G, and FIGS. 30A and 30B). This comparative study corroborates that in-plane alignment is essential to maximize membrane performance (FIG. 30C).

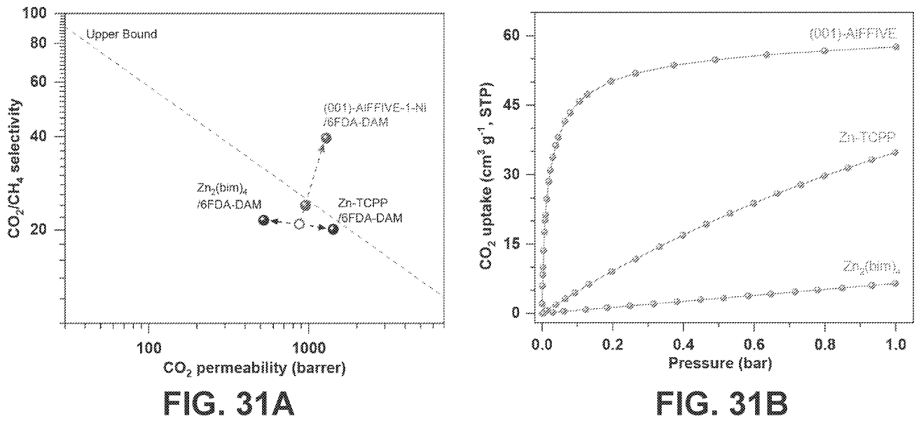

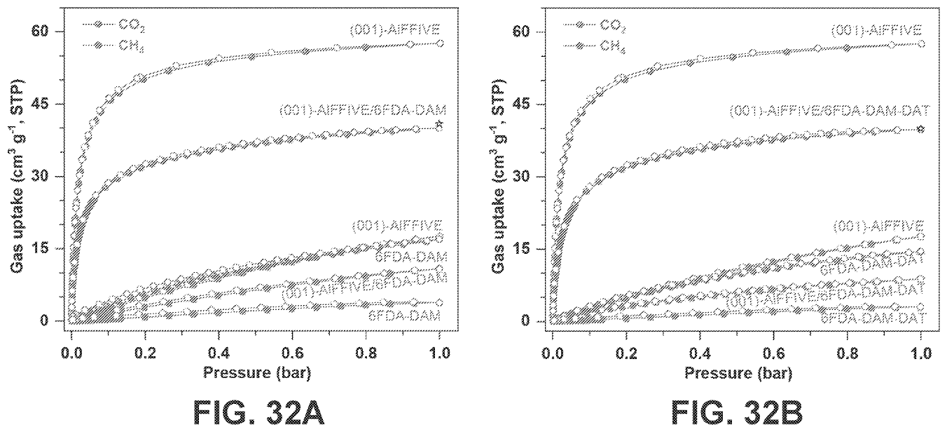

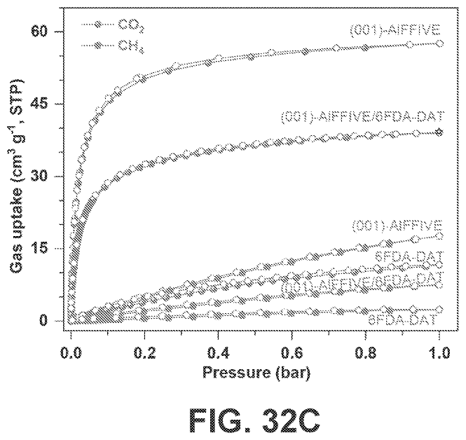

Further evaluations were done on the impact of pore size/shape. Host-guest interactions are critical for concurrent enhancement of selectivity and permeability. Accordingly, three MOFs were selected affording their attainment as nanosheets morphology and with different pore system features. Ultra-small pore (~2.1 Å), Zn2(bim)4 nanosheets showed a negligible improvement in the selectivity associated with a substantial decrease in permeability. Relatively large pore (~6.2 Å), Zn-TCPP nanosheets showed higher permeability but associated with reduced selectivity (FIG. 31). These results are in line with CO₂ adsorption isotherms of associated MOF nanosheets (FIG. 31). Only (001)-AIFFIVE nanosheets MMMOF demonstrated a significant concurrent enhancement of selectivity and permeability.

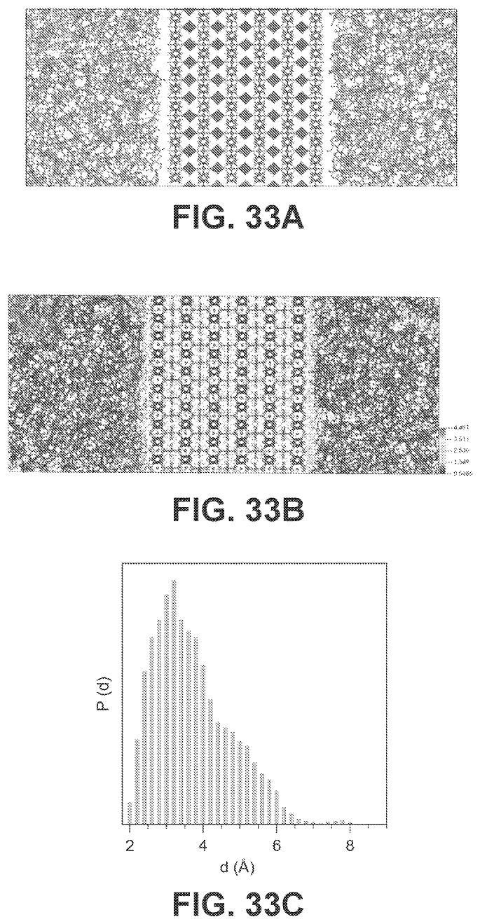

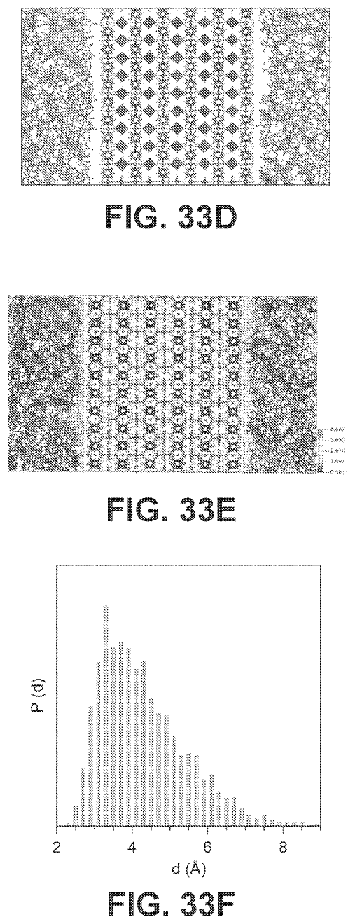

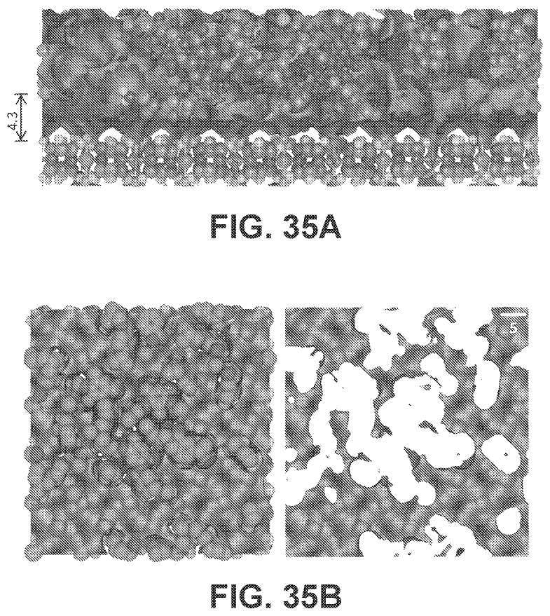

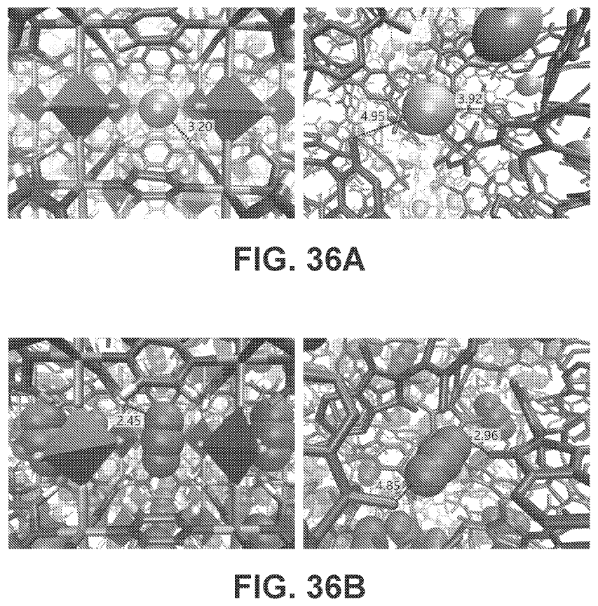

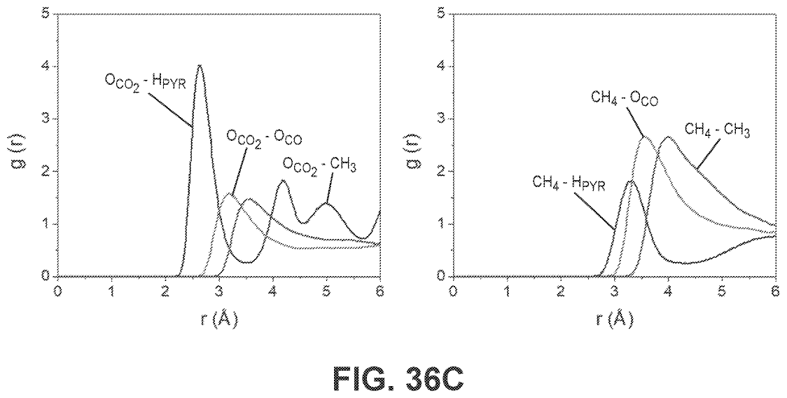

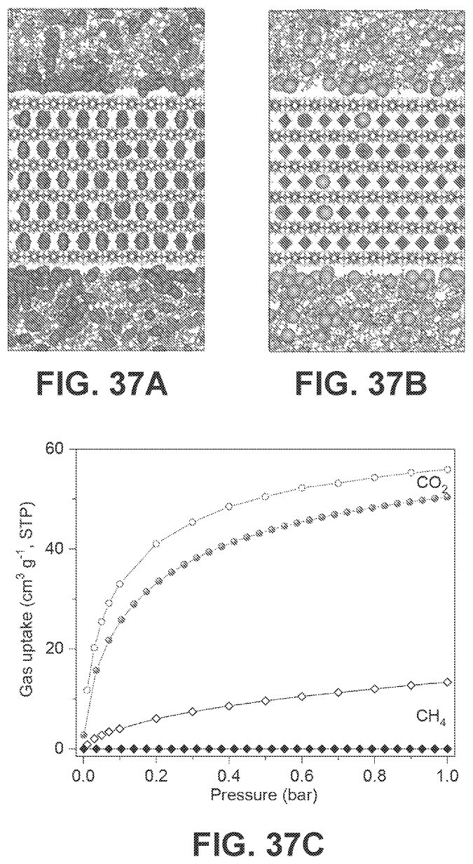

The in silico constructed (001)-AIFFIVE/polymer composite model is illustrated in FIG. 3M. (Also see FIGS. 33 to 36). The top view reveals that polymer covers 1D channel of (001)-nanosheets (FIG. 3M), forming interlocked perpendicular pore zones. The side view confirms that the polymer remains at the MOF surface, thus no polymer penetration into the pores (FIG. 33). A second nanosheet/6FDA-DAM composite model was constructed corresponding to a 42 wt % (001)-nanosheets loading in complement to the pristine one associated with a 59 wt % (001)-nanosheets loading (FIG. 33). The association of two components in the interfacial region is held by means of continued hydrogen bonding interactions with a nanosheets-polymer interface distances that ranges from 2.5 to 6.5 Å for both membranes (FIGS. 33C and 33F). The so-created interfacial region is characterized by the presence of interconnected pores from 2.5 to 4.0 Å size (FIG. 35). This restricted dimension a priori prevents the gas to spread along the direction parallel to the nanosheets surface thus favoring straightforward pathways for the gas through the oriented 1D channel nanosheets/polymer, pinpointing to the importance of uniform [001]-oriented membranes for enhanced separation performance. Grand Canonical Monte Carlo (GCMC) simulations were performed to explore the CO₂ and CH₄ separation properties of the resulting membranes at 298 K. An analysis of the single-component (FIG. 37) and binary mixture (FIG. 3N and FIG. 37C) adsorption mechanism evidenced that CH₄ is almost exclusively adsorbed in the polymer phase while CO₂ equally populates the pores of the MOF and polymers (FIG. 3N and FIG. 37), confirming that nanosheet acts as a molecular barrier for CH₄. The interfacial region was found to be accessible to gas molecules, thus ensuring a connecting-path between the polymer and the oriented 1D MOF channel.

### Example 6—Ultrathin (001)-AIFFIVE/6FDA-DAM-DAT Membrane on Porous α-Al₂O₃ Support

Ultrathin (001)-AIFFIVE(50)/6FDA-DAM-DAT MMMOF membrane was prepared on a porous α-Al₂O₃ support using the spin coating method. First, 1 wt % 6FDA-DAM-DAT was dissolved in CHCl₃ and the desired amounts of (001)-AIFFIVE nanosheets (50 wt % relative to the total weight of the membrane) was added into the 6FDA-DAM-DAT solution. The mixed solution was stirred at 250 rpm for 150 minutes at 35° C. Separately, a porous α-Al₂O₃ disc was carefully polished using a SiC sandpaper (Presi, grit size P800) and washed with plenty of ethanol, and immersed in a CHCl₃ solution for 2 h to fill the pores of the support. Before spin-coating CHCl₃ droplet was wiped off. The nanosheets-polymer suspension was spin-coated onto α-Al₂O₃ substrate at the speed of 1500 rpm for 30 sec. Immediately, the substrate was placed in CHCl₃ saturated glove bag and kept for 12 h at room temperature. Finally, ultrathin MMMOF membrane were dried at 200° C. under vacuum for 15 h.

### Example 7—Gas Separation Properties of MMMOF Membrane

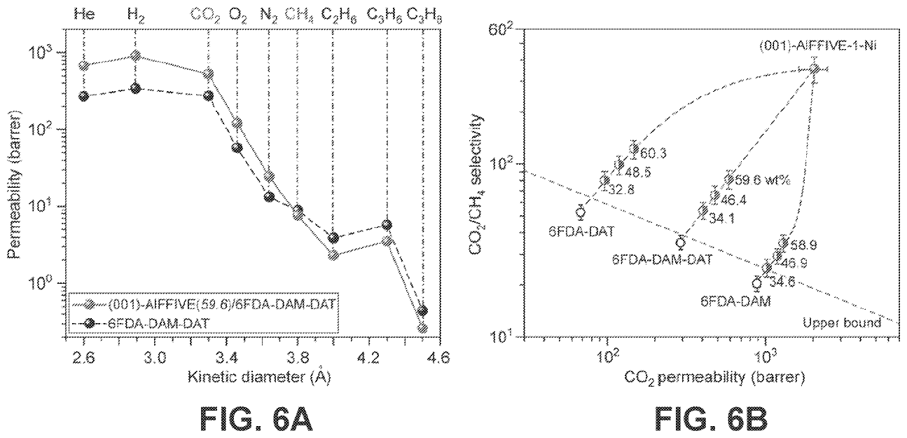

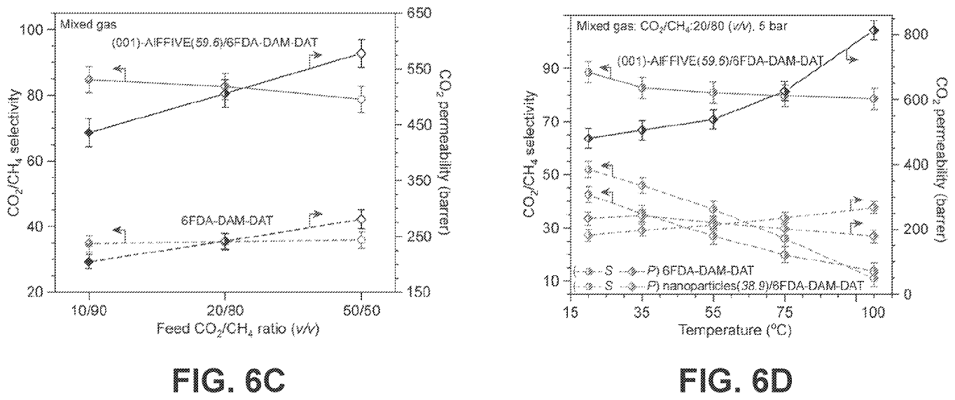

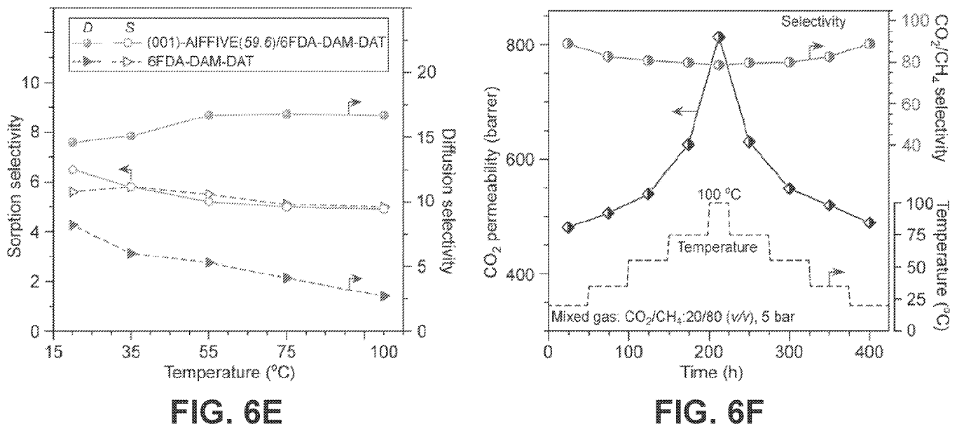

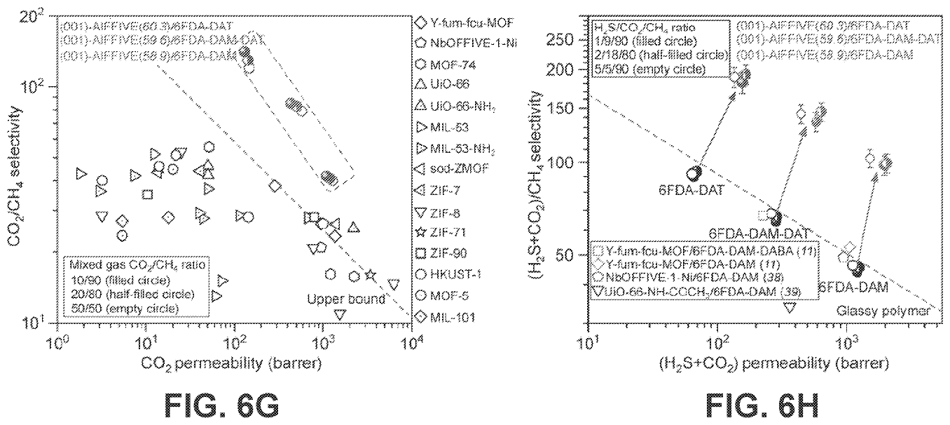

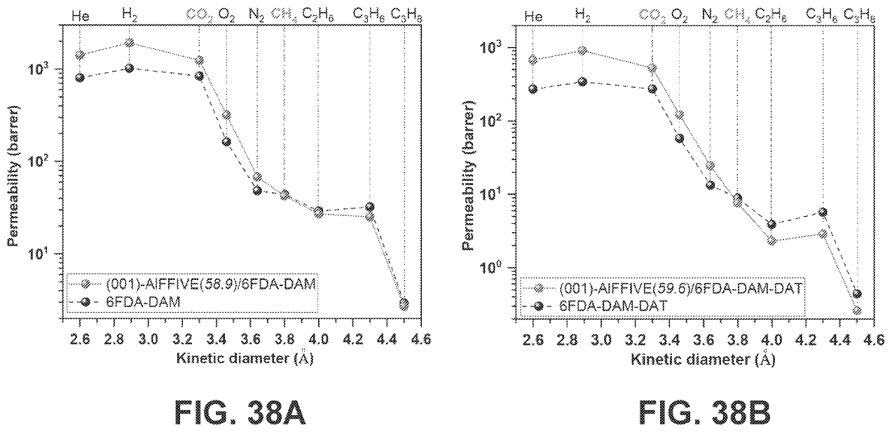

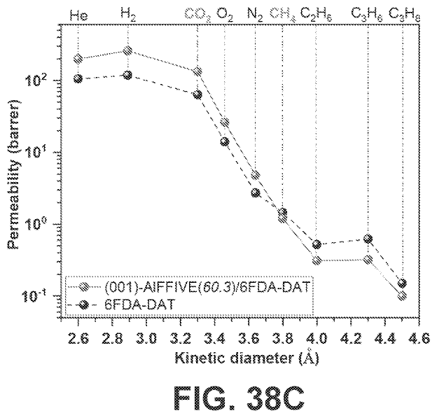

Single gas permeation was conducted on [001]-oriented membranes and associated polymer membranes using 9 different gas molecules (FIG. 38 and table S4). [001]-oriented membranes show higher CO₂ permeability as compared to its pure polymer membranes while their CH₄ permeability remain similar (FIG. 6A). This result corroborates a more effective transport of CO₂ via 1D channels of (001)-nanosheets that leads to the enhanced CO₂/CH₄ selectivity. It is a highly looked-for property in a particular MOF filler, allowing its deployment with various polymer matrices for concurrent enhancement of selectivity and permeability (FIG. 38 and table S4).

Theoretical CO₂/CH₄ selectivity and CO₂ permeability of pure (001)-AIFFIVE-1-Ni membrane were 354 and 2035 barrer (back-calculated using Maxwell model). Experimentally obtained CO₂ permeability and CO₂/CH₄ selectivity of (001)-AIFFIVE/6FDA-DAM, (001)-AIFFIVE/6FDA-DAM-DAT, and (001)-AIFFIVE/6FDA-DAT membranes at different nanosheets loading are shown (FIG. 6B, and table S5). The in-plane aligned incorporation of nanosheets into the polymer matrix prompted a substantial increase in both CO₂ permeability and CO₂/CH₄ selectivity (FIG. 6B and table S5).

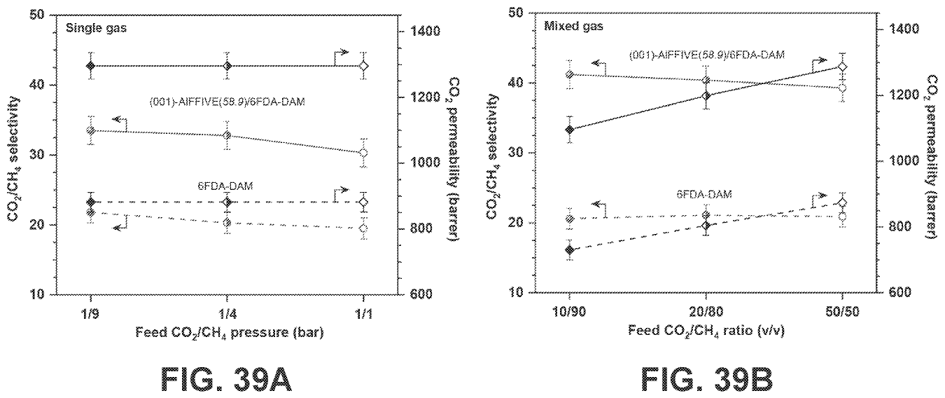

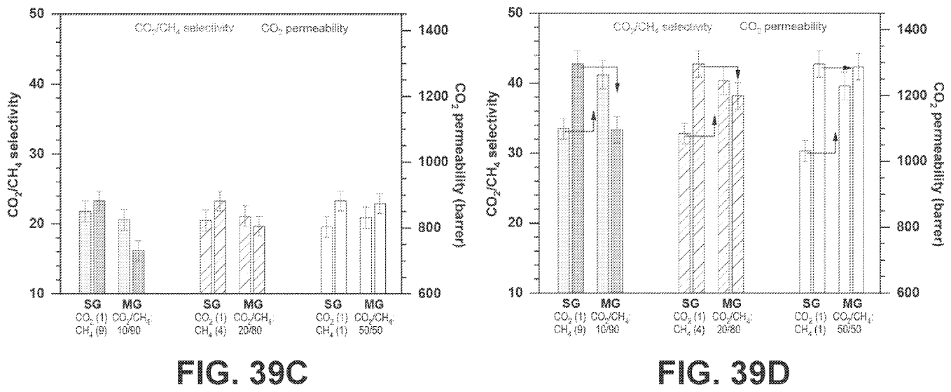

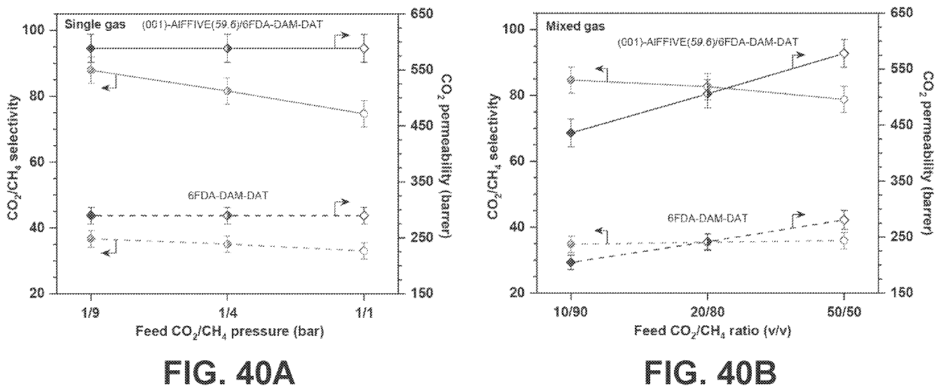

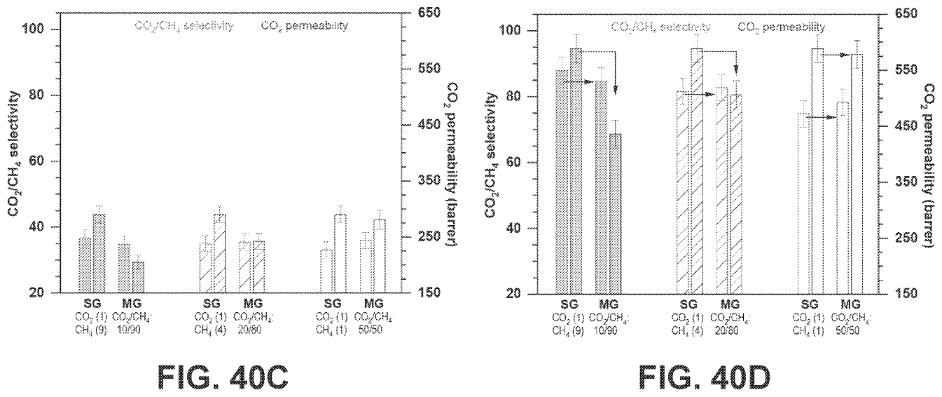

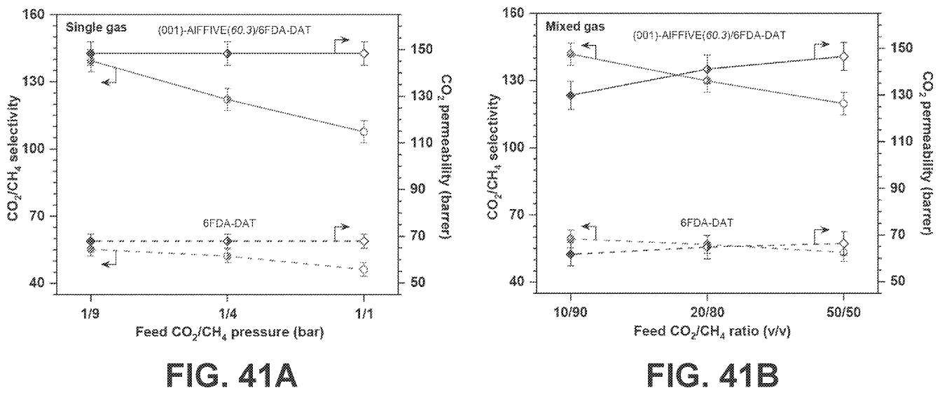

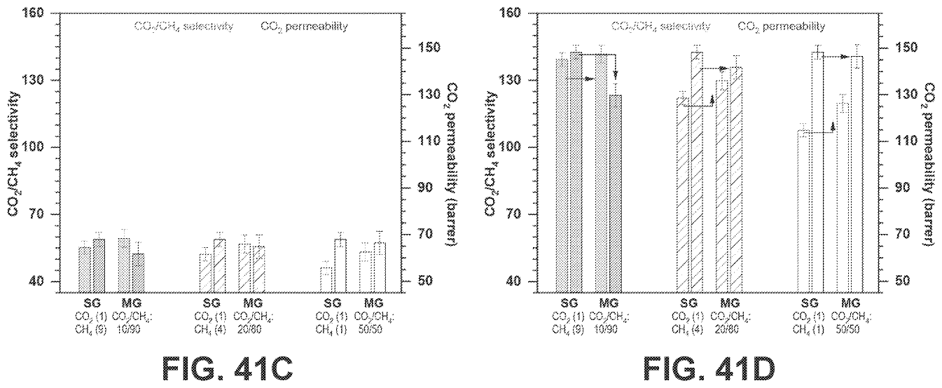

Single and mixed-gas separation studies under different CO₂ feed compositions (CO₂/CH₄: 10/90; 20/80 and 50/50) and feed pressure on [001]-oriented membranes and associated pure polymer membranes are shown (FIG. 6C and FIGS. 39 to 41). (001)-AIFFIVE/6FDA-DAM membrane exhibited a higher CO₂/CH₄ selectivity under mixed gas as compared to single gas feeds, in contrast to pure 6FDA-DAM (FIG. 39B). Under mixed gas permeation, the preferential adsorption of CO₂ in nanosheets leads to remarkably reduced CH₄ permeability and therefore, enhanced CO₂/CH₄ selectivity (FIG. 39D). (001)-AIFFIVE/6FDA-DAM-DAT and (001)-AIFFIVE/6FDA-DAT membranes presented similar single and mixed gas selectivity (FIGS. 40D and 41D).

A CO₂ concentration-dependent study revealed that mixed gas CO₂ permeability is similar to that of single gas permeability at a relatively high feed CO₂ concentration (CO₂/CH₄:50/50), nevertheless, CO₂ permeability gradually decreased as CO₂ feed concentration decreased to CO₂/CH₄:20/80 to 10/90 while selectivity was preserved (FIGS. 39D, 40D and 41D). CO₂ permeability decrease is highly likely due to the higher competition between CH₄ and CO₂. These results imply that CO₂/CH₄ separation at relatively low CO₂ concentration (CO₂/CH₄:20/80 and 10/90, typical CO₂ concentration in natural gas) is challenging but is of practical importance. Even under CO₂/CH₄:10/90 mixture, mixed gas CO₂ permeability improvement of 113% and 110%, and CO₂/CH₄ selectivity enhancement of 144% and 139% were achieved for (001)-AIFFIVE(59.6)/6FDA-DAM-DAT and (001)-AIFFIVE(60.3)/6FDA-DAT membranes, respectively, as compared to associated pure polymer membranes (FIG. 3C, FIGS. 40 and 41, and Tables S7 and S8). The enhanced separation corroborates the importance of judicious choice of MOF fillers and polymer pairs. These results also demonstrate that the relative enhancement of permeability and selectivity is pronounced in relatively low permeable polymer (table S6-8).

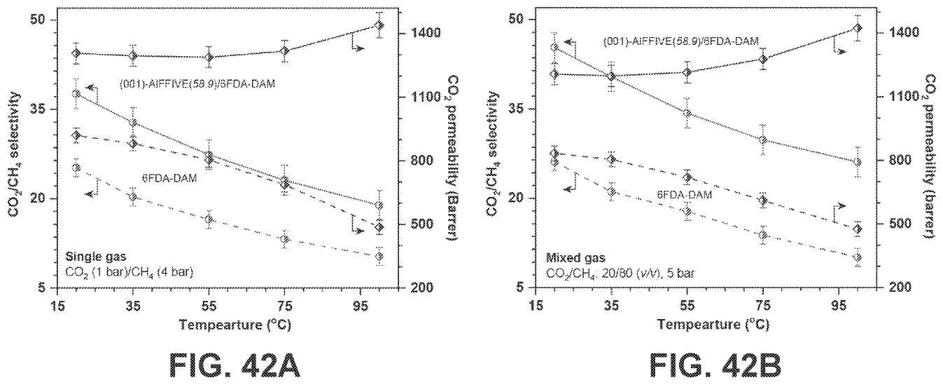

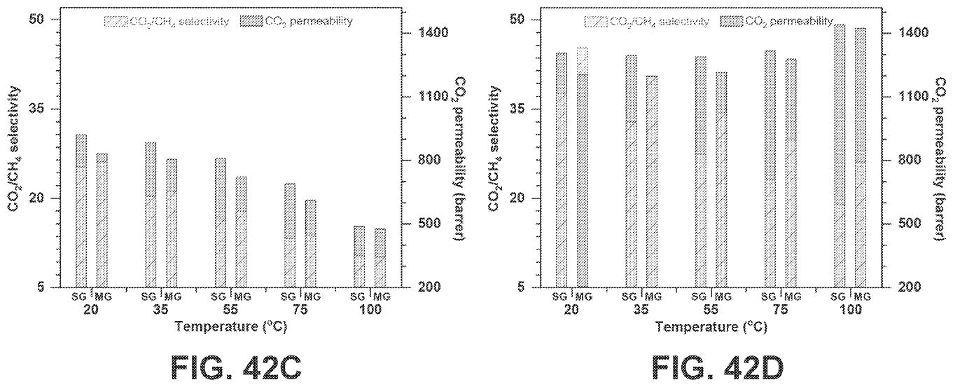

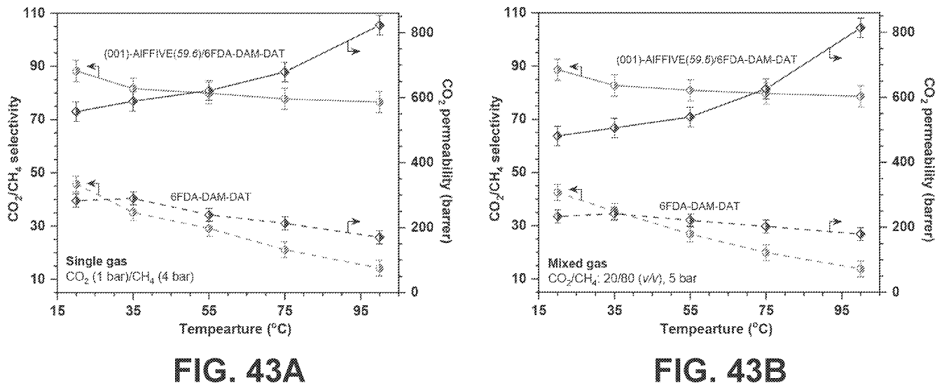

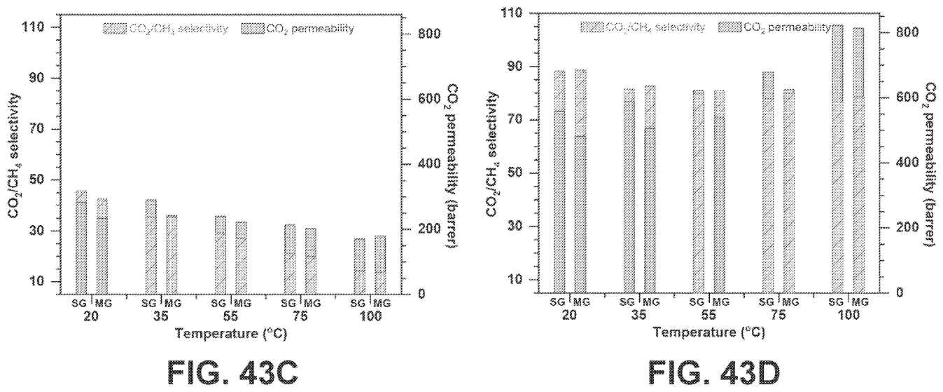

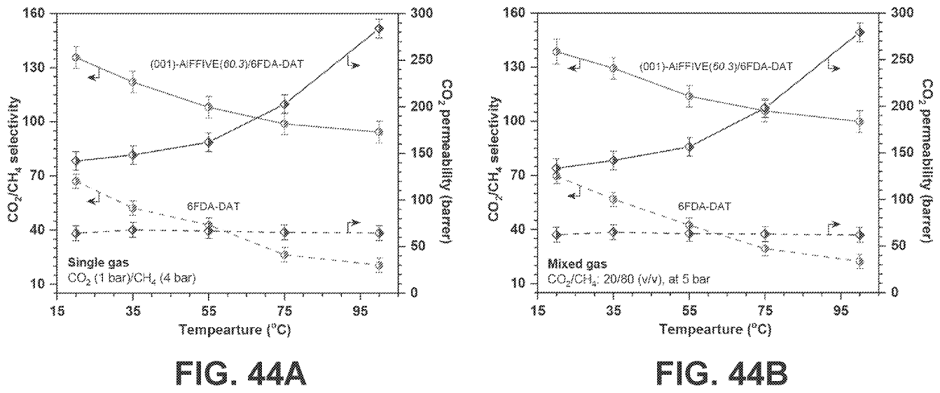

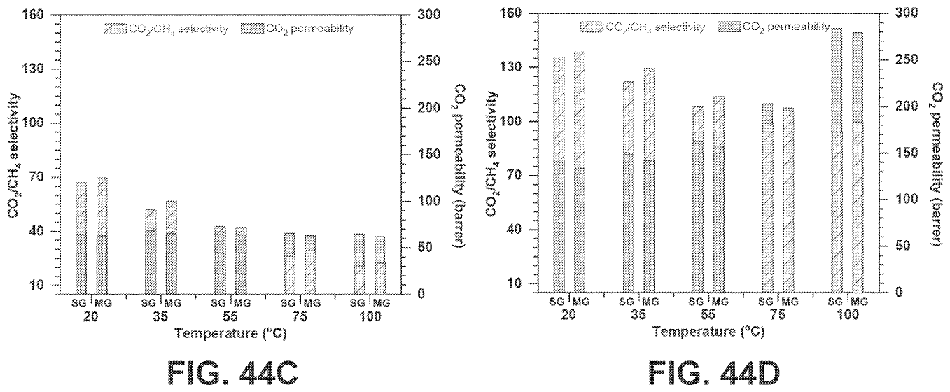

Temperature-dependent (20-100° C.) single and mixed-gas CO₂/CH₄ separation on [001]-oriented membranes and associated pure polymer membranes are shown (FIG. 6D and FIGS. 42 to 44). Increasing the permeation temperature significantly affects the CO₂/CH₄ separation. Particularly, both selectivity and permeability of pure polymeric membrane and nanoparticle membranes substantially deteriorated (FIG. 3D, FIGS. 42 to 44). In contrast, in [001]-oriented membranes, the CO₂ permeability significantly increases with increasing temperature while retaining selectivity (FIGS. 42 to 44). Likewise, variable temperature CO₂ adsorption isotherms were obtained on (001)-nanosheet powder (FIG. 1H). As the temperature increases the CO₂ adsorption lessens (weaker interactions). This decrease is pronounced for a temperature increase from 75 to 100° C., prompting a significant enhancement of CO₂ permeability at relatively higher temperatures (FIGS. 42 to 44). Notably, (001)-AIFFIVE/6FDA-DAM-DAT membrane demonstrated a drastic concurrent enhancement in CO₂ permeability of 355% and CO₂/CH₄ selectivity of 470% compared to the pure 6FDA-DAM-DAT polymer even at 100° C. and under (CO₂/CH₄: 20/80) separation (FIG. 6D and table S9 to S11). This CO₂/CH₄ separation at elevated temperature is the consequence of enhanced CO₂ diffusion via 1D channels of (001)-nanosheets, uniform in-plane alignment of nanosheets and remarkably high nanosheets loading.

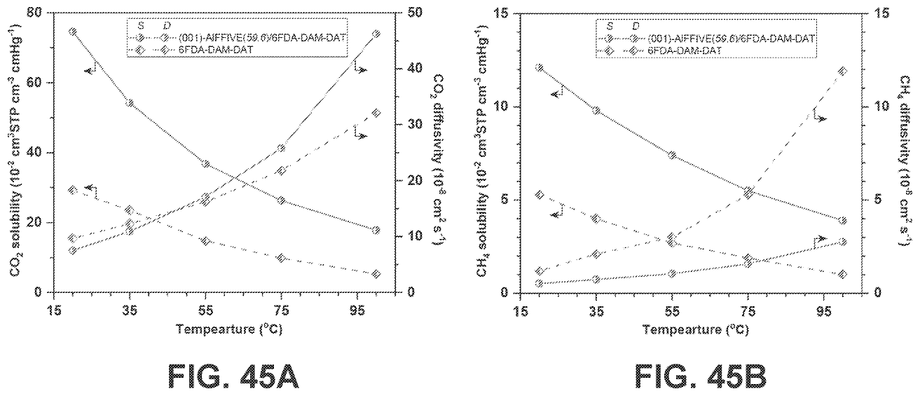

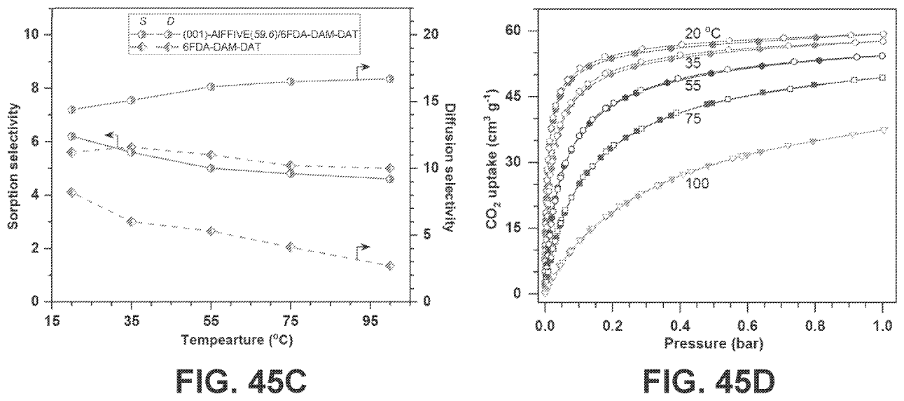

CO₂ and CH₄ permeability were deconvoluted into diffusion coefficient (diffusivity, Dᵢ) and sorption coefficient (solubility, Sᵢ) based on the solution-diffusion model (33). By changing permeation temperature membranes exhibited opposite propensity of solubility and diffusivity of the gases (CO₂ and CH₄). Specifically, increasing the temperature considerably decreases CO₂ and CH₄ solubility but substantially increases CO₂ diffusivity in both membranes (FIGS. 45A and 45B). The (001)-AIFFIVE/6FDA-DAM-DAT membrane demonstrated a significant enhancement in CO₂ diffusivity but a sharp decrease in CH₄ diffusivity, compared to 6FDA-DAM-DAT (FIGS. 45A and 45B and table S12), affording a diffusion dominated with exceptionally high CO₂/CH₄ separation in a wide range of temperatures (FIG. 45C). Membrane stability was measured under thermal stress, (001)-AIFFIVE/6FDA-DAM-DAT membrane demonstrated excellent reversibility in CO₂ permeability and CO₂/CH₄ selectivity in a wide range of temperature and a duration of least 400 h (FIG. 6F).

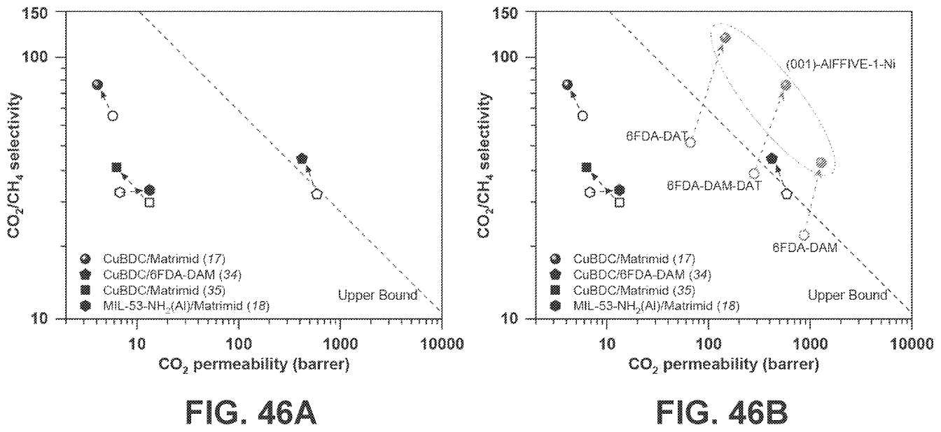

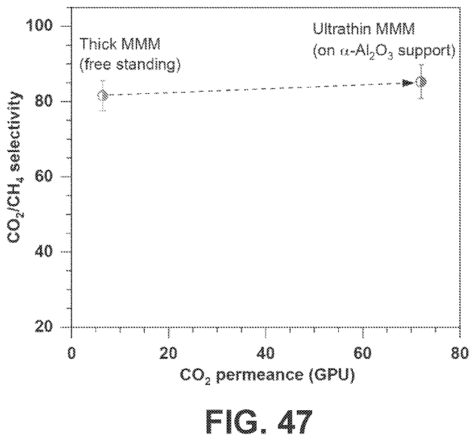

A comparison of CO₂/CH₄ separation performance of [001]-oriented membranes with other reported MOF-nanoparticles/6FDA-polyimides membranes is presented in FIG. 6G and tables S13 to S15. The performance of the [001]-oriented membranes reported here exceeds that of others reported in the literature. More appropriate comparison with MOF-nanosheets/polymer membranes attests to the superior performance of [001]-oriented membranes (FIG. 46 and table S14). The CO₂/CH₄ separation on ultrathin [001]-oriented membrane on porous a-Al₂O₃supports (see Example 6) was assessed. Preliminary results exhibited an 11 fold increase of CO₂ permeance than thick membrane and selectivity was preserved (FIG. 47). Although better separation performances have been reported for thin supported zeolite and carbon molecular sieve membrane films, this family of MMMOF membranes have a straightforward manufacture process, excellent mechanical properties and stability to stream, with no signs of plasticization were observed for more than 30 days,

As CO₂/CH₄ separation at relatively low CO₂ concentrations (10%) is more challenging than that of high concentration (50%), the latter concentration is typically analyzed for study purposes (Table S15). Importantly, [001]-oriented membranes demonstrated outstanding separation at relatively low CO₂ concentration. Correspondingly, gas separation to the ternary mixture was under realistic raw natural gas composition (H₂S/CO₂/CH₄: 1/9/90; 2/18/90 and 5/5/90). For natural gas purification, both CO₂ and H₂S must be removed from CH₄, hence the acid gas removal performance can be evaluated by measuring the total acid gas permeability [P(CO₂)+P(H₂S)] and selectivity [P(CO₂)+P(H₂S)]/P(CH₄)](12). Even under H₂S/CO₂/CH₄:1/9/90 mixture, the mixed gas (H₂S+CO₂) permeability improvement of 63%, 104% and 140%, and (H₂S+CO₂)/CH₄ selectivity enhancement of 123%, 112% and 103% were achieved for the (001)-AIFFIVE(58.9)/6FDA-DAM, (001)-AIFFIVE(59.6)/6FDA-DAM-DAT and (001)-AIFFIVE(60.3)/6FDA-DAT membranes, respectively, compared to the associated pure polymer membranes (Table S16). AIFFIVE-1-Ni has a similar adsorption selectivity (H₂S/CO₂ selectivity close to 1), therefore it is capable of removing both gases simultaneously. The results herein demonstrated that an adsorbent separation selectivity can be translated into the processable matrix.

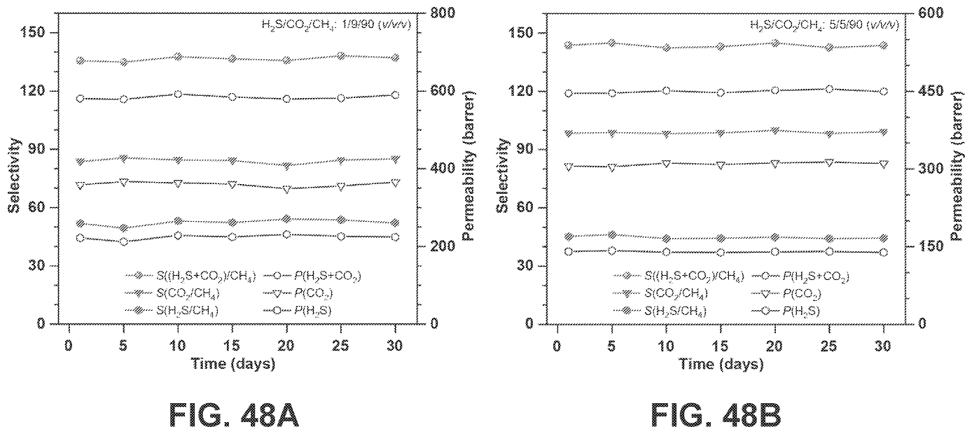

The comparative study reveals that the performance of the [001]-oriented membranes reported here exceeds that of others reported in the literature (FIG. 6H). The performance stability of membrane under continuously mixed gas permeation conditions is a critical test to assess the membrane longevity and the reproducibility of its associated properties. Direct application of our best-performing membranes to a 1/9/90: H₂S/CO₂/CH₄ mixture leads to 6/85/09:H₂S/CO₂/CH₄ mixture in permeate site at least 30 days of continuous operation (FIG. 48).

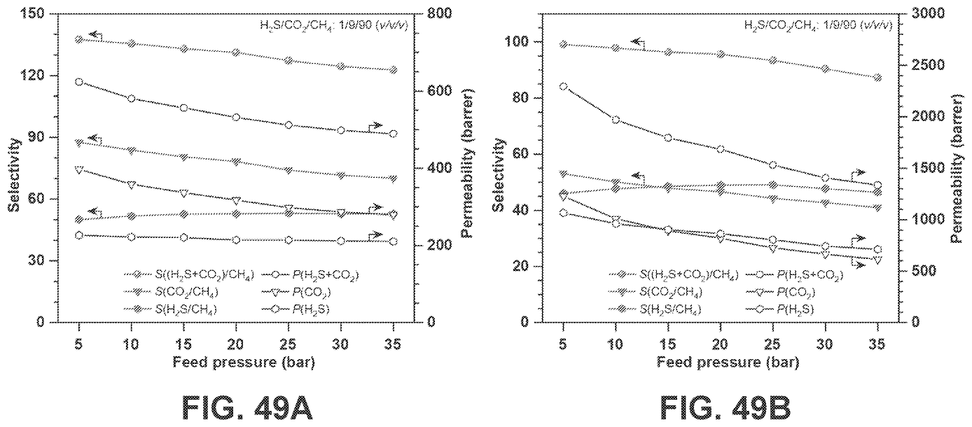

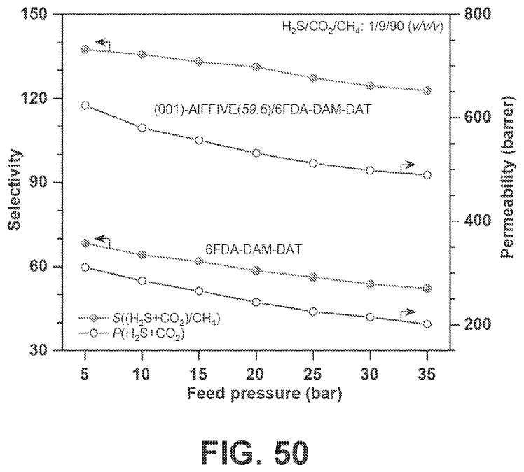

The separation performance of [001]-oriented membranes was further evaluated under high feed pressure that reflects practical natural gas purification. Membrane permeation was studied under high feed pressures up to 35 bar (FIG. 6I and FIG. 49). Importantly, no abrupt selectivity and/or permeability loss occurred in the [001]-oriented membranes for the total acidic gas removal even under 35 bar pressure (FIGS. 49 and 50).

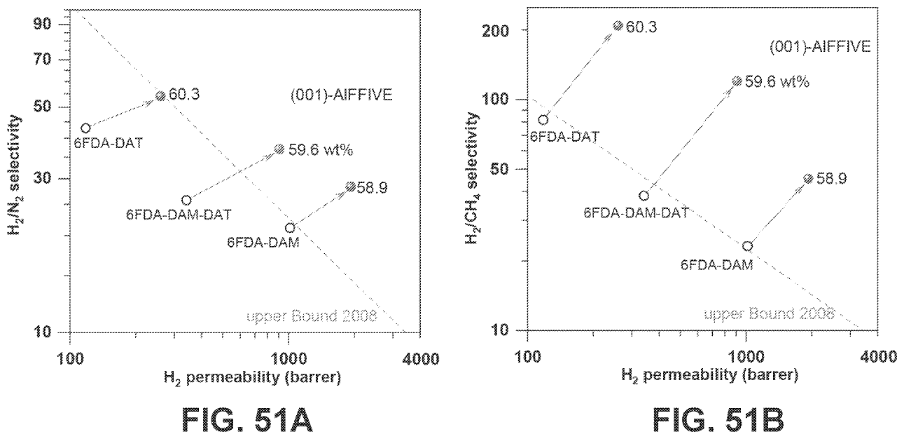

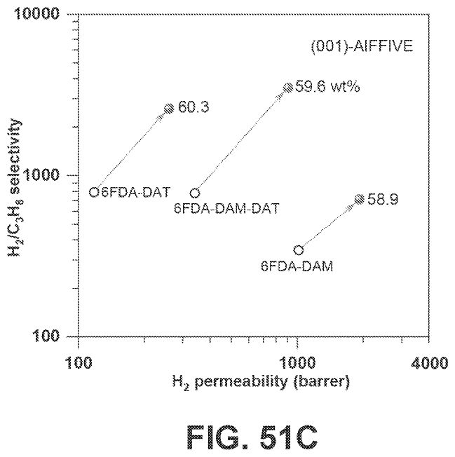

The separation performances of oriented membranes were further tested for other gas pairs, including H₂/N₂, H₂/CH₄ and H₂/C3H₈ and subsequently compared with the literature in FIG. 51. The resultant membranes exhibited excellent selectivity and permeability enhancement for these gas pairs, far beyond the upper-bounds for polymeric membranes.

### SUPPLEMENTARY EXAMPLES AND METHODS

Synthesis of AIFFIVE-1-Ni nanoparticles (C₈H₁₄AlF₅N₄NiO₃) Pyrazine (C₄H₄N₂, 1.80 g, 22.03 mmol) was dissolved in 9 ml of 2:1 (v/v) mixture ethanol-H₂O. Subsequently, nickel acetate tetrahydrate (Ni(OCOCH₃)₂·4H₂O, 2.20 g, 8.84 mmol) was added into the above solution and the solution was sonicated for 2 minutes. Separately, aluminum hydroxide (Al(OH) 3, 0.70 g, 8.97 mmol) was dissolved in 7 ml of 6:1 (v/v) mixture HF—H₂O. These two solutions were mixed together and sonicated for 5 minutes, a sky blue mixture was formed. The solvothermal reaction was carried out at 80° C. for 6 hours under a static condition. The precipitated product was collected by centrifugation at 5000 rpm, and washed with total 300 ml of water, and subsequently washed with 60 ml of ethanol. Finally, nanosheets was dispersed in required amount of CHCl₃ solution.

AIFFIVE-1-Ni nanoparticles stock solution To prevent agglomeration, nanoparticles was not dried before film casting and formation. Concentrations of nanoparticles in CHCl₃ solution was determined by drying 1 ml of aliquot to find the mass of nanoparticles, and resulting stock solutions were found to be 70 mg/ml.

Synthesis of Zn₂(Bim)₃ nanosheets and Zn-TCPP nanosheets These nanosheets were synthesized according to the reported procedures: Zn₂(Bim)₃ nanosheets in Y. Peng, Y. Li, Y. Ban, W. Yang, Two-dimensional metal-organic framework nanosheets for membrane-based gas separation. Angew. Chem. Int. Ed. 56, 9757-9761 (2017), and Zn-TCPP nanosheets in Wang et al., General approach to metal-organic framework nanosheets with controllable thickness by using metal hydroxides as precursors. Front. Mater. 7, 37 (2020).

Membrane Fabrication General: Membrane fabrication was performed in a glove bag filled with CHCl₃ or THF or DCM vapor in order to prevent a rapid solvent evaporation from the emerging membrane. Prior to gas adsorption and permeation measurements, membranes were thermally treated at 200° C. for 20 h under a dynamic vacuum to remove any residual solvent or water in polymers as well as within pores of MOF.

Pure polyimide membranes Polyimides (6FDA-DAM, 6FDA-DAM-DAT or 6FDA-DAT) were dried in a vacuum oven at 150° C. overnight before being dissolved in CHCl₃. Pure polyimide (6FDA-DAM, 6FDA-DAM-DAT or 6FDA-DAT) membrane with desired thickness (typically 75 μm) was fabricated by dissolving 250 mg of dried polyimide in 3.5 mL of CHCl₃. The solution was mixed on a mechanical shaker overnight to dissolve the polymer. The resulting casting solution was poured in a glass Petri dish on a leveled surface, which was placed in a glove bag pre-saturated with CHCl₃ vapour for at least 1 h. The film was left in the glove bag overnight to allow the CHCl₃ solvent to evaporate slowly.

Randomly arranged (001)-AIFFIVE/6FDA-DAM-DAT MMMOF membranes fabrications. Randomly arranged (001)-AIFFIVE/6FDA-DAM-DAT MMMOF membrane was fabricated under the same conditions as for uniformly [001]-oriented MMMOF membranes but the glove bag was not saturated with CHCl₃ vapour so that the CHCl₃ solvent can evaporate first.

AIFFIVE-1-Ni nanoparticles/6FDA-polyimides mixed-matrix membranes Randomly arranged AIFFIVE-1-Ni nanoparticles MMMs with various nanoparticles loading were fabricated under the same conditions as for uniformly [001]-oriented MMMOF membranes but using MOF nanoparticles suspension.

### Nanosheets, Nanoparticles and MMMOF Membranes Characterizations

Imaging of nanosheets, nanoparticles and MMMOF membranes: The AIFFIVE-1-Ni nanosheets or nanoparticles morphology and their orientation/alignment in MMMOF membranes were examined by scanning electron microscopy (SEM) analysis using a field-emission scanning electron microscope (FE-SEM) FEI Nova Nano SEM450 and Magellan 400-FEG operating at an acceleration voltage of 3 kV and an emission current of 40 pA, and 1.5 kV and an emission current of 13 pA, respectively. SEM samples was prepared by dispersing the nanosheets or nanoparticles in ethanol and drop-casting onto an aluminium SEM pin stubs. In order to obtain cross-sectional SEM image, the MMMOF membrane was cryogenically fracturing in liquid nitrogen to preserve their microstructures. To dissipate charge, the sample was sputter coated with ~3 nm of Iridium.

FIB-SEM analysis of [001]-oriented MMMOF membranes: Focused ion beam scanning electron microscopy (FIB-SEM) experiments were performed in Helios G4 UX DualBeam (FEI) microscopes. Slices with a nominal thickness of 50 nm were milled away by the FIB, operating at 5 kV and 25 pA. Between 110 and 434 individual SEM micrographs of the consecutive cross-sections exposed on milling were recorded, at magnifications of 12,000-45,000, with a secondary electron detector operated at 1 kV. The stack of images was aligned to an external feature on the membrane surface using a cross-correlation algorithm, and a stretching operation in the y direction was performed to correct the foreshortening caused by the tilt angle between the specimen cross-section and the SEM detector.

Identification of MOF structure and nanosheets or nanoparticles orientation in MMMOF membranes: The nanosheets structure and orientation was determined using X-ray diffraction (XRD) analysis. The XRD was collected on a Bruker D8 Advance diffractometer (Cu K_{α} λ=1.54056 Å) in Bragg-Brentano θ-θ geometry with an operating power of 40 kV/40 mA and automatic divergence slit (irradiated length=0.6 mm), and a flat plate sample holder. The data were collected at room temperature by the continuous-count method (3° min-1) in the range 20=4-40°.

Quantifying of MOF nanosheets or nanoparticles loading in MMMOF membranes:

The loading of nanosheets or nanoparticles in mixed-matrix membrane was determined by a thermogravimetric analysis method using a TA Q-5000 analyzer. Typically ~10 mg of nanosheets or nanocrystals powder was first activated under flowing N₂ at 200° C. for 135 minutes to ensure activation, then heated to 800° C. at a heating rate of 10° C. min-1 under flowing O₂ and temperature held at 800° C. for 2 h. The residual metal oxide mass was subsequently compared to the initial activated mass of the MOF. The same protocol was performed for nanosheets or nanoparticles containing mixed-matrix membranes. The percentage of mass remaining after 800° C. for 2 h under flowing O₂ is attributed to metal oxide, and from this mass the amount of activated nanosheets or nanoparticles present in the hybrid membranes was obtained. Typical TGA curves for determining the nanosheets or nanoparticles loading in the mixed-matrix membranes are shown in FIG. 20.

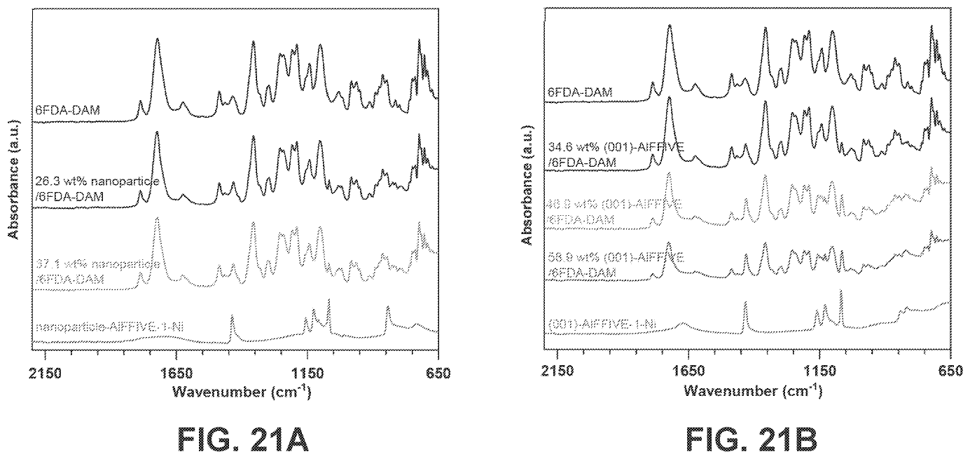

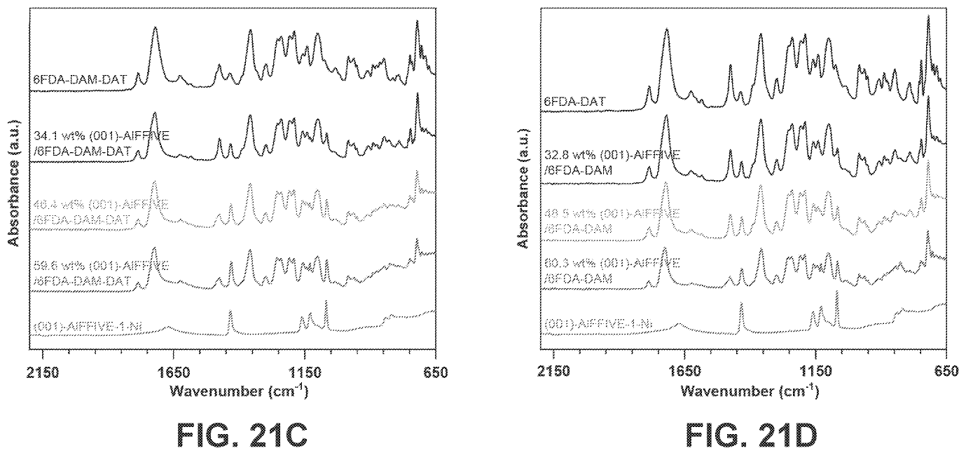

Attenuated total reflectance Fourier transform infrared (ATR-FTIR) spectra were recorded by a Thermo Scientific Nicolet 6700 spectrophotometer at a resolution of 4 cm-1 with 64 scans in the spectral range 4000-600 cm-1, and the corresponding IR spectra are shown in FIG. 21.

Dynamic Mechanical Analysis (DMA) Tensile experiments were conducted using a Q800 DMA (TA Instruments) with a tensile clamp accessory in the controlled force mode. Films were first cut into strips that were 5.3 mm wide and approximately 25 mm long. Each strip was kept isothermal at 25° C. for 15 min, and the tensile force was ramped at 1 N/min until fracture. A minimum of three valid measurements were performed for each sample, which were characterized by a clean brittle fracture in the middle of the strip. The stress-strain curves shown in this work represent one of the measurements taken.

Rheological Characterization The viscosities of the MOF-polymer suspension was determined using a Brookfield's CAP-2000+ Viscometer. The measurement was conducted at 35° C., speed of rotation 400 RPM for 50 second using 38 μL MOF-polymer suspension.

Gas adsorption measurements The gas adsorption measurements were performed using Micromeritics ASAP 2020 and Vstar vapor adsorption analyzer from Quantachrome instruments. Samples consisting of ~100 mg of nanosheets, nanoparticles, pure polymer membrane, or MMMOF membrane were loaded into a preweighed glass tube, and heated at 200° C. for 12 h under a dynamic vacuum. The mass of the activated sample was then used as the basis for the adsorption measurements. After an adsorption isotherm was measured, the sample was reactivated at 150° C. for 6 h before measuring a subsequent adsorption isotherm.

Nuclear Magnetic Resonance (NMR) spectroscopy 1H NMR was run on a 400 MHz instrument using CDCl₃ as the solvent.

Gel Permeation Chromatography (GPC) The weight-averaged molecular weight, number-averaged molecular weight, and polydispersity index for the prepared polymer were estimated using an Agilent 1260 size exclusion chromatography (SEC) system calibrated relative to polystyrene and using tetrahydrofuran (THF) or chloroform (CHCl₃) as the solvent.

### Gas Permeation Measurements

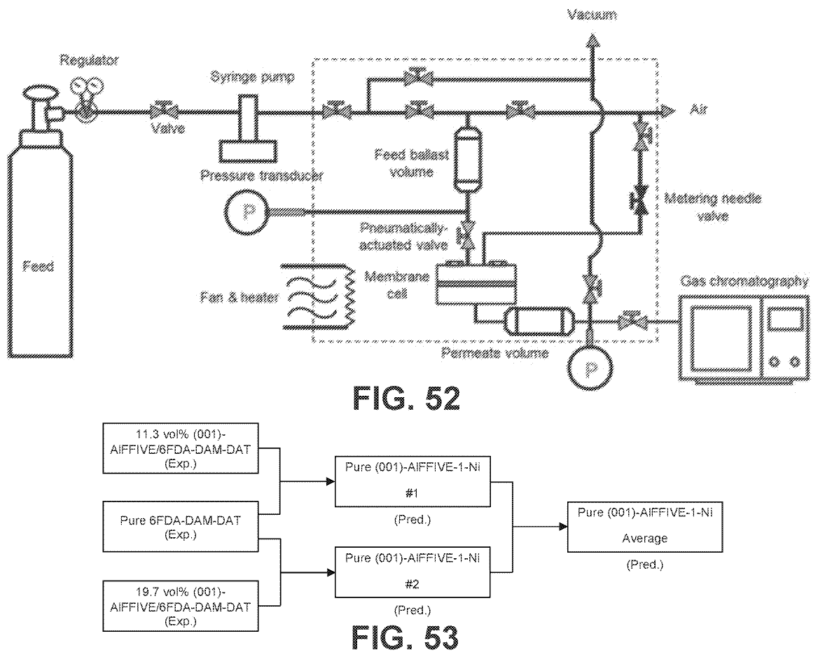

Pure gas permeation measurements: Gas permeation properties of membrane was conducted using a permeation system that was constructed in-house (FIG. 52). The pure gas permeation properties were evaluated by a variable-pressure constant-volume methods at 35° C. and 2 atm for He, H₂, CO₂, O₂, N₂, CH₄, C₂H₆, C₃H₆ and C₃H₈. Detailed description of the permeation cell set-up and testing procedure has been described elsewhere. The round membrane was mounted on the permeation cell and masked with adhesive aluminum tape and sealed by epoxy resins. On curing, a small area of membrane remained exposed, and the area of membrane accessible to gas transport was determined using a scanner. The membrane thickness was measured with a depth gauge. The permeation systems was evacuated at 35° C. for 12 h before performing any permeation test. The slope of downstream pressure vs. time (dp/dt) at the steady state condition was used for the calculation of gas permeability with accordance to the below equation:

$$P = \frac{Vl}{{p}_{o} ART} \frac{dp}{dt} \times {10}^{10} \qquad ( 1 )$$

where P refers to the gas permeability of a membrane in barrer (1 barrer=10-10 cm³ (STP) cm cm⁻² s⁻¹ cmHg⁻¹), V is the volume of downstream chamber (cm³), l is the membrane thickness (cm), p₀ is the upstream pressure (cmHg), A refers to the effective area of membrane (cm²), R is the gas constant (0.278 cm³ cmHg cm⁻³ (STP) K⁻¹), T is the operating temperature (K).

The ideal selectivity of gas A to gas B, «A/B, was evaluated based on the equation as follows:

$${α}_{A / B} = \frac{{P}_{A}}{{P}_{B}} \qquad ( 2 )$$

where P_{A} and P_{B} denote the permeability of gases A and B, respectively.

Based on the solution-diffusion model, permeability is defined as a product of diffusivity (D) and solubility (S). Thus, ideal permeability selectivity (α_{P}) is the product of diffusivity selectivity (α_{D}) and solubility selectivity (α_{S}):

$$P = D \times S \qquad ( 3 )$$

$${α}_{A / B} = {α}_{P} = {α}_{D} \times {α}_{S} = \frac{{D}_{A}}{{D}_{B}} \times \frac{{S}_{A}}{{S}_{B}} \qquad ( 4 )$$

where D_{A} and D_{B} are the diffusion coefficients for components A and B, respectively, with a unit of cm²/s, whereas S_{A} and S_{B} are the solubility coefficients of components A and B, respectively, with a unit of cm³ (STP)/(cm³ cmHg).

The diffusivity coefficient D (cm² s⁻¹) was determined from the time lag method using the following equation:

$$D = \frac{{l}^{2}}{6 θ} \qquad ( 5 )$$

where l is the membrane thickness and 0 is the time lag(s).

The solubility coefficient S (cm³ (STP) cm³ cmHg⁻¹), was obtained indirectly as the ratio of the permeability to the diffusion coefficient as following equation:

$$S = P / D \qquad ( 6 )$$

Maxwell Back-calculations. The Maxwell model was used to predict the gas permeation properties of the mixed-matrix membrane and to back-calculate the permeability and selectivity of molecular sieve filler (FIG. 53). The model was originally developed by James C. Maxwell to predict the dielectric properties of the composite materials. The constructive equations governing electrical conduction and the flux through membranes are close analogs, permitting the applicability of Maxwell's equation to predict the gas transport properties in mixed matrix membranes. The Maxwell model is given by:

$${P}_{MMM} = {P}_{P} [ \frac{{P}_{s} + 2 {P}_{p} - 2 {ϕ}_{s} ( {P}_{p} - {P}_{s} )}{{P}_{s} + 2 {P}_{p} + {ϕ}_{s} ( {P}_{p} - {P}_{s} )} ] \qquad ( 7 )$$

where P_{MMM} is the permeability in the mixed matrix membrane; Pₚ is the permeability in the polymer matrix; Pₛ is the permeability in dispersed molecular sieve filler, and φₛ is the volume fraction of molecular sieve filler in the mixed matrix membrane. The major requirements for applying the Maxwell model are satisfied for our prediction. They are (i) the contact between two phases at the nanosheets-polymer interface are defect-free. (ii) The volume of the nanosheets is carefully calculated and the used value of a volume fraction of the nanosheet is less than 0.2 (0<φ<0.2). (iii) The nanosheets are homogeneously distributed in a polymer matrix; (iv) The incorporation of nanosheets does not change the properties of the neighboring polymer phase.

Mixed gas permeation measurements: A binary gas mixture (CO₂/CH₄: 10/90; 20/80 and 50/50) and ternary gas mixture (H₂S/CO₂/CH₄: 1/9/90; 2/18/80 and 5/5/90) were used for mixed-gas permeation tests. The mixed-gas permeation measurement was performed using the modified single-gas permeation equipment integrated with micro-gas chromatography (Agilent 490 Micro-GC). Pure polymeric and MMMOF membranes were evaluated at a total mixed gas feed pressure of 2-35 bar at 25-100° C. The stage cut (the flow rate ratio of permeate to feed) was maintained below 1% to avoid concentration polarization on the upstream side of the permeation cell and keep the driving force across the membrane constant throughout the course of the experiment. The gas mixture was allowed to permeate the membrane until a steady-state permeation rate was reached (>5 time lags). The permeate volume was then evacuated and allowed to accumulate under steady-state conditions. The permeate gas was then expanded into an evacuated volume and analyzed with a GC. The mixed gas permeability of component i was measured by following equation

$${P}_{i} = {10}^{10} \frac{{y}_{i}}{{x}_{i} {p}_{0}} \frac{V l}{ART} \frac{dp}{dt} \qquad ( 8 )$$

where y and x are the mole fractions in permeate and feed respectively, and the p₀ is the feed pressure of the component i.

The separation factor α was calculated as the ratio of the permeability of two components i and j.

$${α}_{i / j} = \frac{{y}_{i} / {y}_{j}}{{x}_{i} / {x}_{j}} \qquad ( 9 )$$

### Atomic Structure Analysis of AIFFIVE-1-Ni Nanosheets

STEM analysis: High-resolution spherical aberration-corrected (Cₛ-corrected) scanning transmission electron microscopy (STEM) was performed using a JEOL Grand ARM operated at 300 kV. The microscope is equipped with a cold field emission gun and a double corrector for the STEM and TEM modes assuring a point resolution in either case of 0.7 Å. Prior to AIFFIVE-1-Ni nanosheets data acquisition, the nanosheets were dispersed by sonication for 10 minutes in absolute ethanol. Few drops of the suspension were placed onto a holey carbon copper microgrid.

STEM is the most appropriate technique for local atomic structure examination in porous materials. Nevertheless, MOFs are extremely electron beam sensitive to afford the attainment of high-resolution images. Thus, acquiring data is not straightforward and low dose techniques are imperative. Because of this major drawback, the number of frameworks analyzed using this technique is still relatively scarce. In the present work, the microscope was used in STEM mode, which focused the electron beam into a very fine spot (below 1 Å) and obtain enough structural information from the irradiated area, and then it is scanned over the area of interest, while the rest of the crystal remains ‘untouched’. This approach is very beneficial as it allows acquiring numerous images from a single MOF crystal. By controlling the e-beam dose, it allowed us to obtain very high-quality atomic resolution images of the extremely electron beam sensitive and ultra-microporous AIFFIVE-1-Ni nanosheets. Furthermore, this technique permits the simultaneous acquisition of different signals, High Angle Annular Dark Field (HAADF), Annular Dark Field (ADF) together with Annular Bright Field (ABF) images. In the current study, both ADF and ABF detectors were simultaneously used, ADF is convenient for imaging the metal nodes, and ABF is useful for light materials imaging even under low-dose conditions. A more detailed analysis of ADF and ABF images is shown (FIG. 13). Besides the opposite contrast between the two detectors, it is possible to appreciate in both cases a clear location of the metals that appear as bright or dark spots in the ADF and ABF images respectively. However, ABF provides a higher degree of information in terms of the lighter atoms.

Multi-slice STEM simulations: To simulate the STEM-ADF data of the AIFFIVE-1-Ni nanosheets along the and orientation, the QSTEM program was used. The crystal supercell dimensions used were 48.28×103.22× 23.8 Å3, where 20 Å was used as ideal thickness because of the good match between the experimental and simulated data and because of the information that was obtained from the SEM observations. The parameters used were: Cₛ=0 mm, Uacc=300 kV, an inner collection angle of 20 mrad and half-convergence angle of 15 mrad.

### Computational Methods

AIFFIVE-1-Ni microscopic surface model: The crystal structure of AIFFIVE-1-Ni was taken from our previous experimental work. This structure was first geometry optimized at the Density Functional Theory (DFT) level with both the positions of the atoms of the framework and the cell parameters fully relaxed. These calculations were performed using the Vienna ab initio Simulation Package (VASP, version 5.4.4) with a plane wave energy cutoff of 650 eV and convergence criteria of 10⁻⁵ eV and 10⁻² eV/Å respectively for the energy and sum of the atomic forces. The 2s²p², 1s¹, 3d⁸4s², 3s²3p¹, 2s²2p⁵, and 2s²2p³ atomic orbitals were treated as valence states for C, H, Ni, Al, F, and N, respectively. The electronic exchange-correlation interaction was treated using the Perdew-Burke-Ernzerhof (PBE) functional within the generalized gradient approximation (GGA). The first Brillouin zone was set with a 3×3×2 Monkhorst-Pack special k-point mesh. The van der Waals correction DFT-D3 method was used to accurately account for long-range dispersion interactions. In order to better describe the d states of Ni in the AIFFIVE-1-Ni model, an Hubbard U correction of 6.4 eV was applied consistent with previous works reported on Ni-containing systems. The resulting DFT-optimized cell parameters are in excellent agreement with the corresponding experimental data as reported in table S17.

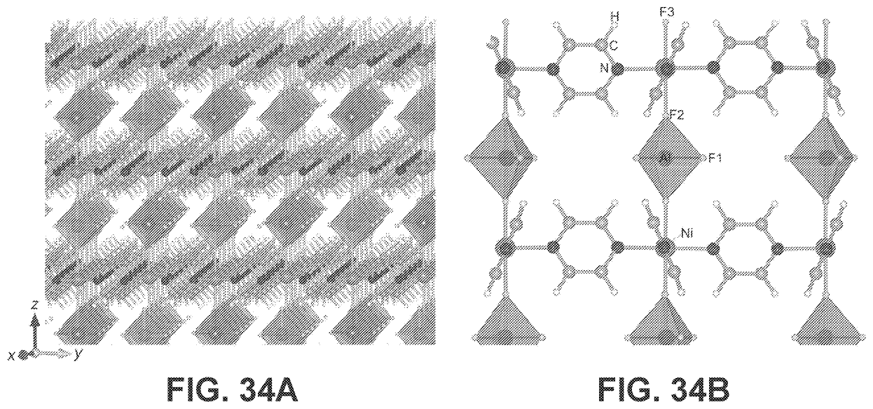

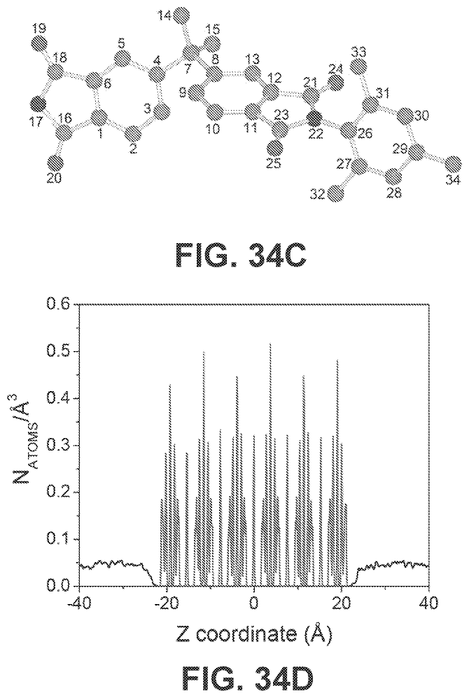

This DFT optimized structure model was further employed to construct an atomistic AIFFIVE-1-Ni surface model. In accordance to the experimental STEM images (FIG. 2A), the plane (001) was chosen to orient the cleavage of the surface. The resulting surface slab model slab has a z-length of approximately 42.65 Å (FIG. 34) to avoid the surface to interact with itself due to periodic boundary conditions and its dimension along the x and y directions is 9.79 Å. The resulting model has a zero dipole in the direction perpendicular to the surface slab. This surface model was then geometry-optimized using the same level of theory and parameters as for the optimization of the bulk model.

Partial atomic charges were calculated for this surface model using the density derived electrostatic and chemical (DDEC) method as implemented in the VASP package.

A final surface slab model was then constructed to be further used in the force field simulations by duplicating 5 times the surface model in the x and y directions giving final x and y lengths of 48.93 Å (FIG. 34). In these calculations, this surface slab model was treated as a fully flexible framework with intra-molecular potential parameters taken from the Universal Force Field (UFF) while 12-6 Lennard-Jones (LJ) van der Waals and coulombic contributions were considered to model the intermolecular interactions. The 12-6 LJ parameters were taken from the generic forcefields DREIDING and UFF for the atoms of the organic and inorganic nodes respectively. FIG. 34 provides an illustration of the atom types present in the AIFFIVE-1-Ni (001) surface model and table S18 lists their respective charges and van der Waals parameters.

This flexible force field implemented for the description of AIFFIVE-1-Ni (001) surface model was validated by using Molecular Dynamics (MD) simulations in the NPT ensemble using the Berendsen thermostat and barostat with a relaxation time of 0.1 ps and 0.5 psrespectively. The resulting force field relaxed cell parameters and geometric features are in good agreement with those obtained for the DFT-optimized crystal structures (table S19).

6FDA-DAM microscopic model The 6FDA-DAM polymer model was taken from our previous work (61). It was constructed starting with a united-atom monomer illustrated in FIG. 34 and applying a controlled polymerization procedure that involves several MD cycles performed with the LAMMPS package followed by the corresponding linking of the monomeric units, as implemented in the polymatic code. A detailed workflow of the computational approach can be found in our previous works. The terminations of the resulting polymer were achieved as follows: on one end, the replacement of a nitrogen atom (N17 in FIG. 34) by an oxygen atom and, on the other end, the addition of —NH₂ group to a carbon atom (C30 in FIG. 34C). This polymer model was treated as fully flexible in our calculations: bonded interactions were modeled using the analytical expression and parameters described by the generic forcefield GAFF while the non-bonded interactions were treated by a 12-6 LJ potential contribution and a coulombic term, with parameters taken from our previous work and reminded in table S20.

AIFFIVE-1-Ni/6FDA-DAM microscopic composite model The construction of the (001)-AIFFIVE-1-Ni/6FDA-DAM composite model was obtained using the computational strategy previously developed and validated on a series of MOF/Polymer systems. First, the atomic coordinates of the 6FDA-DAM polymer model were unwrapped in the z-direction and the simulation box was adjusted according to the lattice parameters of the (001)-AIFFIVE-1-Ni structure model leading to a system with the following dimension 48.93 Å×48.93 Å×170.00 Å, including the presence of the vacuum in the z direction. Then, the 6FDA-DAM model was brought into contact with the AIFFIVE-1-Ni slab model, and submitted to a 21-steps MD simulation routine integrating NVT and NPT cycles with T and P kept constant by using the Berendsen thermostat and barostat with respective relaxation times of 0.1 ps and 0.5 ps in a modified version of the DL_POLY Classic code. This procedure allowed the equilibration of the polymer, leading to a well-packed (001)-AIFFIVE-1-Ni/6FDA-DAM MMMOF membrane. The interactions between the MOF surface and the polymer were treated by a sum of 12-6 LJ van der Waals and coulombic terms, the cross 12-6 LJ parameters were obtained using the Lorentz Berthelot mixing rules. The two components of the composite were treated as fully flexible with the force field parameters detailed above. The van der Waals interactions were handled with a 12 Å cutoff while the electrostatic interactions were calculated using the Ewald summation method with a tolerance of 10⁻⁶. NVT (T=300 K) MD calculations were performed during a total simulation time of 10 nanoseconds (ns) with a time step of 1 femtosecond (fs). 10 independent (001)-AIFFIVE-1-Ni/6FDA-DAM composites were built in order to improve the statistics by circumventing the fact that several configurations may be trapped in local minima. The interface formed between the two components of the composite was further characterized by calculating the distribution of the minimum MOF/polymer site-to-site distances at the interface (FIGS. 33C and 33F, and FIG. 35).

Prediction of the adsorption/separation properties of the AIFFIVE-1-Ni/6FDA-DAM composite Single-component (CO₂, CH₄) and equimolar binary mixture adsorption isotherms were calculated for the AIFFIVE-1-Ni/6FDA-DAM composite by grand canonical Monte Carlo (GCMC) simulations at 298 K. These calculations were carried out using a simulation box including the (001)-AIFFIVE-1-Ni/6FDA-DAM model described above. Gas/composite interactions were described by a sum of coulombic and 12-6 LJ contributions. The former ones were obtained implementing the Ewald summation with a 10⁻⁶ precision while the latter one was calculated considering a 12 Å cutoff radius. For each state point of these simulations, 1×10⁵ Monte Carlo cycles following 5×10³ equilibration cycles (number of steps=number of cycles×number of molecules) were used as implemented in the RASPA software. The composite was described using the force field parameters detailed above. CO₂ was described by the EPM2 model corresponding to 3 atom-centered charged LJ sites while CH₄ was modeled by a single uncharged LJ site, as described by the united-atom TraPPE model. LJ crossed parameters were calculated using the Lorentz-Berthelot mixing rules. The adsorption enthalpies of each component were evaluated using the revised Widom's test particle insertion method. Preferential interactions/locations of the guest species were evaluated through a careful inspection of the representative snapshots and the calculations of several radial distribution functions (RDFs) between guests and composite averaged over all the GCMC configurations.

### Supplemental Tables

TABLE S1
Effects of solvents on membrane fabrication for the permeation
properties of the pure polymer and (001)-AlFFIVE MMMs.

| | CO₂ Permeability (barrer) | | | CO₂/CH₄ Selectivity | | |
|---|---|---|---|---|---|---|
| Membranes | THF | DCM | CHCl₃ | THF | DCM | CHCl₃ |
| 6FDA-DAM | 903.4 | 874.3 | 881.9 | 19.3 | 19.8 | 20.3 |
| (001)-AlFFIVE(58.9)/6FDA-DAM | 1325.6 | 1416.3 | 1295.7 | 26.4 | 24.2 | 32.8 |
| 6FDA-DAM-DAT | 309.6 | 281.8 | 289.7 | 33.7 | 36.2 | 35.1 |
| (001)-AlFFIVE(59.6)/6FDA-DAM-DAT | 611.3 | 683.2 | 588.6 | 64.5 | 60.2 | 81.6 |

Pure CO₂ permeation at 1 bar and pure CH₄ permeation at 4 bar, permeation measured at 35° C. 1 barrer = 10⁻¹⁰ cm³ (STP) cm/cm² s cmHg. Tetrahydrofuran (THF), dichloromethane (DCM), Chloroform (CHCl₃).

TABLE S2
Table. S2. Physical properties of solvents.

| Solvents | RP | Density (g/ml) | BP (° C.) |
|---|---|---|---|
| THF | 0.207 | 0.886 | 66.0 |
| DCM | 0.309 | 1.326 | 39.8 |
| CHCl₃ | 0.259 | 1.498 | 61.2 |

TABLE S3
Table. S3. Mechanical properties of MOFs containing MMMs at 298 K.

| | MOF loading | Young's modulus | Breaking | |
|---|---|---|---|---|
| Membranes | (wt %) | (GPa) | elongataion (%) | Ref. |
| AlFFIVE-np/6FDA-DAM | 26.3 | 1.30 | 3.59 | This |
| | 37.1 | 1.87 | 1.58 | work |
| (001)-AlFFIVE-ns/6FDA-DAM | 34.6 | 1.36 | 8.01 | |
| | 46.9 | 1.79 | 5.84 | |
| | 58.9 | 3.35 | 1.64 | |
| UiO-66-CN/PIM-1 | 20 | 1.26 | 4.30 | 71 |
| UiO-66-CN/sPIM-1 | 20 | 1.30 | 3.45 | |
| NbOFFIVE-1-Ni/6FDA-Durene | 33 | 1.55 | 2.35 | 72 |
| Zn(pyrz)₂(SiF₆)/6FDA-TMPDA | 20 | 1.15 | na | 73 |
| UiO-66-NH₂/ODPA-DAM | 27 | na | 2.05 | 74 |
| UiO-66-NH₂@PI/ODPA-DAM | 27 | na | 2.85 | |
| MIL-101/SPEEK | 40 | 1.42 | na | 75 |
| ZIF-7/PI | 50 | 0.50 | 4.5 | 76 |

np: nanoparticles, ns: nanosheets; na: not available.

TABLE S4
Single gas permeation properties of [001]-oriented MMMOF membranes,
and pure polymeric membranes using 9 different gas molecules.

| | Permeability (barrer) | | | | | | | | |
|---|---|---|---|---|---|---|---|---|---|
| Membranes | He | H₂ | CO₂ | O₂ | N₂ | CH₄ | C₂H₆ | C₃H₆ | C₃H₈ |
| 6FDA-DAM | 804.2 | 1016.5 | 841.4 | 163.0 | 48.2 | 43.9 | 29.1 | 32.2 | 3.0 |
| (001)-AlFFIVE(58.9)/6FDA-DAM | 1416.0 | 1925.6 | 1243.5 | 319.2 | 68.1 | 42.4 | 27.1 | 25.1 | 2.7 |
| 6FDA-DAM-DAT | 270.1 | 341.6 | 277.9 | 57.6 | 13.3 | 8.9 | 3.9 | 5.7 | 0.4 |
| (001)-AlFFIVE(59.6)/6FDA-DAM-DAT | 675.9 | 908.6 | 524.3 | 120.6 | 24.5 | 7.6 | 2.3 | 2.9 | 0.3 |
| 6FDA-DAT | 105.3 | 118.3 | 63.4 | 14.0 | 2.7 | 1.5 | 0.5 | 0.6 | 0.2 |
| (001)-AlFFIVE(60.3)/6FDA-DAT | 198.5 | 259.5 | 132.5 | 26.1 | 4.8 | 1.2 | 0.3 | 0.3 | 0.1 |

| | Selectivity | | | | | | | | |
|---|---|---|---|---|---|---|---|---|---|
| Membranes | He/H₂ | H₂/CO₂ | O₂/N₂ | H₂/N₂ | N₂/CH₄ | CO₂/N₂ | CO₂/CH₄ | H₂/CH₄ | H₂/C₃H₈ |
| 6FDA-DAM | 0.8 | 1.2 | 3.4 | 21.1 | 1.1 | 17.5 | 19.6 | 23.2 | 344.6 |
| (001)-AlFFIVE(58.9)/6FDA-DAM | 0.7 | 1.5 | 4.7 | 28.3 | 1.6 | 18.3 | 29.3 | 45.4 | 713.2 |
| 6FDA-DAM-DAT | 0.8 | 1.2 | 4.3 | 25.7 | 1.5 | 20.9 | 31.2 | 38.3 | 776.4 |
| (001)-AlFFIVE(59.6)/6FDA-DAM-DAT | 0.7 | 1.7 | 4.9 | 37.0 | 3.2 | 21.4 | 69.3 | 120.2 | 3494.7 |
| 6FDA-DAT | 0.9 | 1.9 | 5.2 | 43.7 | 1.9 | 23.4 | 43.7 | 81.6 | 788.7 |
| (001)-AlFFIVE(60.3)/6FDA-DAT | 0.8 | 2.0 | 5.4 | 54.1 | 3.9 | 27.6 | 106.9 | 209.3 | 2595.0 |

Gas permeation at 2 atm at 35° C. 1 barrer = 10⁻¹⁰ cm³ (STP) cm/cm² s cmHg; 1 atm = 101 kPa.

TABLE S5
Table. S5. Single gas CO₂/CH₄ separation performances of [001]-oriented
MMMOF membranes at different nanosheets loading.

| | Permeability (barrer) | | CO₂/CH₄ | Enhancement (%) | |
|---|---|---|---|---|---|
| Membranes | CO₂ | CH₄ | Selectivity | P | S |
| 6FDA-DAM | 881.9 | 43.4 | 20.3 | 0.0 | 0.0 |
| (001)-AlFFIVE(34.6)/6FDA-DAM | 1021.5 | 40.7 | 25.1 | 15.8 | 23.5 |
| (001)-AlFFIVE(46.9)/6FDA-DAM | 1186.3 | 40.3 | 29.4 | 34.5 | 44.9 |
| (001)-AlFFIVE(58.9)/6FDA-DAM | 1295.7 | 39.5 | 32.8 | 46.9 | 61.4 |
| 6FDA-DAM-DAT | 289.7 | 8.3 | 35.1 | 0.0 | 0.0 |
| (001)-AlFFIVE(34.1)/6FDA-DAM-DAT | 403.7 | 7.5 | 53.9 | 39.4 | 53.5 |
| (001)-AlFFIVE(46.4)/6FDA-DAM-DAT | 480.9 | 7.2 | 66.4 | 66.0 | 89.2 |
| (001)-AlFFIVE(59.6)/6FDA-DAM-DAT | 588.6 | 7.2 | 81.6 | 103.2 | 132.5 |
| 6FDA-DAT | 67.9 | 1.3 | 52.2 | 0.0 | 0.0 |
| (001)-AlFFIVE(32.8)/6FDA-DAT | 96.6 | 1.2 | 80.5 | 42.3 | 54.1 |
| (001)-AlFFIVE(48.5)/6FDA-DAT | 119.2 | 1.2 | 99.1 | 75.6 | 89.7 |
| (001)-AlFFIVE(60.3)/6FDA-DAT | 148.3 | 1.2 | 122.1 | 118.4 | 133.8 |

Pure CO₂ permeation at 1 atm and pure CH₄ permeation at 4 atm, permeation measured at 35° C. 1 barrer = 10⁻¹⁰ cm³ (STP) cm/cm² s cmHg.

TABLE S6
Single and mixed gas permeation under different feed CO₂ concentration
on 6FDA-DAM and (001)-AlFFIVE(58.9)/6FDA-DAM membrane.

| Single gas | | | | | | Mixed gas | | | | | |
|---|---|---|---|---|---|---|---|---|---|---|---|
| Feed | | CO₂ Parmeability | | CO₂/CH₄ | | Feed | Feed | CO₂ Permeability | | CO₂/CH₄ | |
| pressure (psi) | | (barrer) | | Selectivity | | CO₂:CH₄ | Pressure | (barrer) | | Selectivity | |
| CO₂ | CH₄ | PI | MMM | PI | MMM | ratio | (psi) | PI | MMM | PI | MMM |
| 15 | 15 | 881.9 | 1295.7 | 19.5 | 29.3 | 50:50 | 30 | 873.4 | 1287.4 | 20.9 | 39.6 |
| 15 | 60 | | | 20.3 | 32.8 | 20:80 | 75 | 804.6 | 1198.8 | 21.1 | 40.4 |
| 15 | 130 | | | 21.8 | 33.5 | 10:90 | 150 | 730.2 | 1095.4 | 20.6 | 41.2 |

Permeation measured at 35° C. 1 Barrer = 10⁻¹⁰ cm³ (STP) cm/cm² s cmHg.

TABLE S7
Single and mixed gas permeation under different feed CO₂ concentration
on 6FDA-DAM-DAT and (001)-AlFFIVE(59.6)/6FDA-DAM-DAT membrane.

| Single gas | | | | | | Mixed gas | | | | | |
|---|---|---|---|---|---|---|---|---|---|---|---|
| Feed | | CO₂ Permeability | | CO₂/CH₄ | | Feed | Feed | CO₂ Permeability | | CO₂/CH₄ | |
| pressure (psi) | | (barrer) | | Selectivity | | CO₂:CH₄ | Pressure | (barrer) | | Selectivity | |
| CO₂ | CH₄ | PI | MMM | PI | MMM | ratio | (psi) | PI | MMM | PI | MMM |
| 15 | 15 | 289.7 | 588.6 | 33.0 | 74.7 | 50:50 | 30 | 280.5 | 578.0 | 35.9 | 78.3 |
| 15 | 60 | | | 35.1 | 81.6 | 20:80 | 75 | 241.6 | 505.8 | 35.4 | 82.7 |
| 15 | 130 | | | 36.7 | 87.9 | 10:90 | 150 | 204.7 | 435.9 | 34.8 | 84.7 |

Permeation measured at 35° C. 1 barrer = 10⁻¹⁰ cm³ (STP) cm/cm² s cmHg.

TABLE S8
Single and mixed gas permeation under different feed composition
on 6FDA-DAT and (001)-AlFFIVE(60.3)/6FDA-DAT membrane.

| Single gas | | | | | | Mixed gas | | | | | |
|---|---|---|---|---|---|---|---|---|---|---|---|
| Feed | | CO₂ Permeability | | CO₂/CH₄ | | Feed | Feed | CO₂ Permeability | | CO₂/CH₄ | |
| pressure (psi) | | (barrer) | | Selectivity | | CO₂:CH₄ | Pressure | (barrer) | | Selectivity | |
| CO₂ | CH₄ | PI | MMM | PI | MMM | ratio | (psi) | PI | MMM | PI | MMM |
| 15 | 15 | 67.9 | 148.3 | 46.1 | 107.7 | 50:50 | 30 | 66.4 | 146.5 | 53.3 | 119.7 |
| 15 | 60 | | | 52.2 | 122.1 | 20:80 | 75 | 64.8 | 141.8 | 56.8 | 129.4 |
| 15 | 130 | | | 55.2 | 139.4 | 10:90 | 150 | 61.7 | 129.8 | 59.3 | 141.8 |

Permeation measured at 35° C. 1 barrer = 10⁻¹⁰ cm³ (STP) cm/cm² s cmHg.

TABLE S9
Temperature dependent (20-100° C.) single and mixed gas
CO₂/CH₄ separation on 6FDA-DAM and (001)-AlFFIVE(58.9)/6FDA-DAM membrane.

| | Single gas | | | | Mixed gas | | | |
|---|---|---|---|---|---|---|---|---|
| Permeation | CO₂ Permeability (barrer) | | CO₂/CH₄ Selectivity | | CO₂ Permeability (barrer) | | CO₂/CH₄ Selectivity | |
| temperature (° C.) | PI | MMM | PI | MMM | PI | MMM | PI | MMM |
| 20 | 919.6 | 1306.5 | 25.2 | 37.6 | 832.5 | 1206.7 | 26.1 | 45.3 |
| 35 | 881.9 | 1295.7 | 20.3 | 32.8 | 804.6 | 1198.0 | 21.1 | 40.4 |
| 55 | 809.6 | 1288.7 | 16.5 | 27.4 | 719.9 | 1215.4 | 17.8 | 34.3 |
| 75 | 687.8 | 1317.3 | 13.2 | 23.1 | 611.2 | 1278.2 | 13.8 | 29.8 |
| 100 | 487.7 | 1439.6 | 10.3 | 18.9 | 475.0 | 1423.5 | 10.1 | 26.1 |

Single gas: CO₂ feed pressure 15 psi, CH₄ feed pressure 60 psi. Mixed gas: CO₂/CH₄; 20/80 (v/v), feed pressure 75 psi.

TABLE S10
Temperature dependent (20-100° C.) single and mixed gas CO₂/CH₄
separation on 6FDA-DAM-DAT and (001)-AlFFIVE(59.6)/6FDA-DAM-DAT membrane.

| | Single gas | | | | Mixed gas | | | |
|---|---|---|---|---|---|---|---|---|
| Permeation | CO₂ Permeability (barrer) | | CO₂/CH₄ Selectivity | | CO₂ Permeability (barrer) | | CO₂/CH₄ Selectivity | |
| temperature (° C.) | PI | MMM | PI | MMM | PI | MMM | PI | MMM |
| 20 | 283.1 | 556.9 | 45.8 | 88.3 | 233.4 | 480.9 | 42.5 | 88.6 |
| 35 | 289.7 | 588.6 | 35.1 | 81.6 | 241.6 | 505.8 | 35.4 | 82.7 |
| 55 | 239.4 | 621.9 | 29.2 | 79.7 | 221.3 | 539.3 | 26.9 | 80.9 |
| 75 | 213.2 | 678.8 | 21.1 | 77.9 | 202.5 | 625.9 | 19.9 | 79.7 |
| 100 | 170.0 | 822.8 | 14.2 | 76.8 | 179.1 | 813.7 | 13.8 | 78.6 |

Single gas: CO₂ feed pressure 15 psi, CH₄ feed pressure 60 psi. Mixed gas: CO₂/CH₄; 20/80 (v/v), feed pressure 75 psi.

TABLE S11
Temperature dependent (20-100° C.) single and mixed gas
CO₂/CH₄ separation on 6FDA-DAT and (001)-AlFFIVE(60.3)/6FDA-DAT membrane.

| | Single gas | | | | Mixed gas | | | |
|---|---|---|---|---|---|---|---|---|
| Permeation | CO₂ Permeability (barrer) | | CO₂/CH₄ Selectivity | | CO₂ Permeability (barrer) | | CO₂/CH₄ Selectivity | |
| temperature (° C.) | PI | MMM | PI | MMM | PI | MMM | PI | MMM |
| 20 | 64.4 | 142.1 | 67.1 | 135.7 | 62.4 | 133.5 | 69.5 | 138.6 |
| 35 | 67.9 | 148.3 | 52.2 | 122.1 | 64.8 | 141.8 | 56.8 | 129.4 |
| 55 | 66.7 | 162.0 | 42.8 | 108.1 | 63.2 | 156.4 | 42.4 | 113.9 |
| 75 | 65.2 | 202.8 | 26.3 | 98.9 | 62.8 | 198.2 | 29.4 | 105.7 |
| 100 | 64.6 | 283.9 | 20.5 | 94.3 | 61.9 | 279.3 | 22.3 | 99.8 |

Single gas: CO₂ feed pressure 15 psi, CH₄ feed pressure 60 psi. Mixed gas: CO₂/CH₄; 20/80 (v/v), feed pressure 75 psi.

TABLE S12
Solubility and diffusivity of CO₂ and CH₄, and CO₂/CH₄ sorption selectivity and diffusion selectivity
in (001)-AlFFIVE/6FDA-DAM-DAT and pure 6FDA-DAM-DAT membranes obtained temperature range of 20-100° C.

| | | Permeability | | | Solubility (10 [symbol] | | Diffusivity | | Selectivity | |
|---|---|---|---|---|---|---|---|---|---|---|
| | Temperature | (barrer) | | Selectivity | cm³(STP)/cmHg/cm²) | | (10 [symbol] cm³/s) | | Solubility | Diffusivity |
| Membranes | (° C.) | CO₂ | CH₄ | CO₂/CH₄ | CO₂ | CH₄ | CO₂ | CH₄ | CO₂/CH₄ | CO₂/CH₄ |
| 6FDA-DAM-DAT | 20 | 283.1 | 6.2 | 45.9 | 29.2 | 5.3 | 9.7 | 1.2 | 5.6 | 8.2 |
| | 35 | 289.6 | 8.3 | 35.1 | 23.5 | 4.0 | 12.3 | 2.1 | 5.8 | 6.0 |
| | 55 | 239.3 | 8.2 | 29.1 | 14.8 | 2.7 | 16.2 | 3.0 | 5.5 | 5.3 |
| | 75 | 213.2 | 10.1 | 21.1 | 9.8 | 1.9 | 21.8 | 5.3 | 5.1 | 4.1 |
| | 100 | 170.1 | 12.0 | 14.2 | 5.3 | 1.0 | 32.1 | 11.9 | 5.2 | 2.7 |
| (001)- | 20 | 556.9 | 6.3 | 88.3 | 74.6 | 12.1 | 7.5 | 0.5 | 6.2 | 14.4 |
| AlFFIVE(58.9)/6FDA- | 35 | 588.6 | 7.2 | 81.6 | 54.2 | 9.8 | 10.9 | 0.7 | 5.6 | 14.7 |
| DAM-DAT | 55 | 621.8 | 7.8 | 79.7 | 36.8 | 7.4 | 16.9 | 1.1 | 5.0 | 16.1 |
| | 75 | 678.5 | 8.7 | 77.9 | 26.3 | 5.5 | 25.8 | 1.6 | 4.8 | 16.3 |
| | 100 | 822.7 | 10.7 | 76.8 | 17.8 | 3.9 | 46.2 | 2.7 | 4.6 | 16.7 |

CO₂ feed pressure 15 psi, CH₄ feed pressure 60 psi. [symbol]
indicates data missing or illegible when filed

TABLE S13
A comparison of single and mixed gas CO₂/CH₄ separation performances, and selectivity (S) and permeability
(P) enhancement of MOFs/6FDA-polyimides MMMs with (001)-oriented MMMOF membranes developed in this study.

| | | | Measurement | | | CO₂ permeability | | | CO₂/CH₄ | | | |
|---|---|---|---|---|---|---|---|---|---|---|---|---|
| | | | condition | | | (barrer) | | | selectivity | | | |
| | | MOF | P | CO₂/CH₄ | T | | | P [symbol] | | | S [symbol] | |
| MOFs | Polymers | (wt %) | (bar) | ratio | (° C.) | polymer | MMM | (%) | polymer | MMM | (%) | Ref. [symbol] |
| AlFFIVE-1-Ni [symbol] | 6FDA-DAM | 58.9 | 10.0 | 10/90 | 35 | 730.2 | 1093.4 | 50.0 | 20.6 | 41.2 | 100.2 | this |
| AlFFIVE-1-Ni [symbol] | 6FDA-DAM-DAT | 59.6 | 10.0 | 10/90 | 35 | 204.7 | 435.9 | 112.9 | 34.8 | 84.7 | 143.4 | work |
| AlFFIVE-1-Ni [symbol] | 6FDA-DAT | 60.3 | 10.0 | 10/90 | 35 | 61.7 | 129.8 | 110.4 | 59.3 | 141.8 | 139.1 | |
| Y-fum-fcu-MOF | 6FDA-DAM | 30.1 | 1.4 | 100 | 35 | 716.9 | 1365.0 | 50.4 | 18.9 | 23.3 | 23.4 | 11 |
| Y-fum-fcu-MOF | 6FDA-DAM-DABA | 17.7 | 1.4 | SG | 35 | 172.7 | 286.8 | 66.0 | 37.1 | 38.0 | 2.6 | 11 |
| Y-fum-fcu-MOF | 6FDA-DAM | 20.0 | 1.4 | SG | 35 | 661.0 | 952.4 | 44.1 | 23.1 | 26.3 | 14.1 | 42 |
| NbOFFIVE-1-Ni | 6FDA-DAM | 20.0 | 1.4 | SG | 35 | 744.8 | 954.3 | 28.1 | 18.5 | 20.9 | 12.9 | 38 |
| NbOFFIVE-1-Ni | 6FDA-DAM | 20.0 | 6.9 | 50/50 | 35 | 721.3 | 1007.8 | 39.7 | 24.1 | 26.3 | 9.1 | |
| ZIF-90 | 6FDA-DAM | 15.0 | 2.0 | SG | 35 | 390.0 | 800.0 | 105.1 | 24.0 | 28.0 | 16.7 | 43 |
| MOF-74 | 6FDA-Durene | 21.0 | 1.0 | 50/50 | 35 | 843.4 | 2250.0 | 166.8 | 12.5 | 15.7 | 25.7 | |
| MOF-74 | 6FDA-DAM | 23.0 | 1.0 | 50/50 | 35 | 843.4 | 1717.0 | 44.3 | 15.5 | 16.1 | 3.9 | 44 |
| MOF-74 | 6FDA-DAT | 15.0 | 1.0 | 50/50 | 35 | 45.4 | 52.0 | 14.7 | 40.3 | 55.6 | 37.7 | |
| ZIF-8 | 6FDA-Durene | 20.0 | 10.0 | SG | 35 | 352.0 | 487.0 | 38.4 | 16.6 | 17.9 | 8.0 | 45 |
| sod-ZMOF | 6FDA-DAM | 20.0 | 2.1 | 50/50 | 35 | 1062.3 | 1408.1 | 44.2 | 22.1 | 26.2 | 35.6 | 41 |

Single gas (SG), permeation temperature 35° C. [symbol] (001)-AlFFIVE-1-Ni nanosheets, [symbol] Permeability enhancement factor. [symbol] Selectivity enhancement factor, 1 barrer = 10 [symbol] cm³ (STP) cm/cm² s cmHg; 1 bar = 100 kPa. [symbol] References in main text. [symbol]
indicates data missing or illegible when filed

TABLE S14
A comparison of mixed gas CO₂/CH₄ separation performances, and selectivity (S) and permeability (P) enhancement
of CuBDC and MIL-53-NH₂ nanosheets/polymers MMMs with (001)-oriented MMMOF membranes developed in this study.

| | | | Measurement | | | CO₂ permeability | | | CO₂/CH₄ | | | |
|---|---|---|---|---|---|---|---|---|---|---|---|---|
| | | Nano- | condition | | | (barrer) | | | selectivity | | | |
| | | sheets | P | CO₂/CH₄ | T | | | P [symbol] | | | S [symbol] | |
| MOFs | Polymers | (wt %) | (bar) | ratio | (° C.) | polymer | MMM | (%) | polymer | MMM | (%) | Ref [symbol] |
| AlFFIVE-1-Ni [symbol] | 6FDA-DAM | 58.9 | 10.0 | 10/90 | 35 | 730.2 | 1095.4 | 50.0 | 20.6 | 41.2 | 100.2 | this |
| AlFFIVE-1-Ni [symbol] | 6FDA-DAM-DAT | 59.6 | 10.0 | 10/90 | 35 | 204.7 | 435.9 | 112.9 | 34.8 | 84.7 | 143.4 | work |
| AlFFIVE-1-Ni [symbol] | 6FDA-DAT | 60.3 | 10.0 | 10/90 | 35 | 61.7 | 129.8 | 110.4 | 59.3 | 141.8 | 139.1 | |
| Cu-BDC [symbol] | Matrimid | 8.2 | 3.0 | 50/50 | 35 | 5.8 | 4.1 | −29.2 | 59.8 | 78.7 | 31.6 | 17 |
| Cu-BDC [symbol] | 6FDA-DAM | 4.0 | 1.0 | 50/50 | 25 | 590.0 | 430.0 | −27.1 | 30.0 | 43.0 | 43.3 | 34 |
| Cu-BDC [symbol] | Matrimid | 12.0 | 5.0 | 50/50 | 35 | 13.3 | 6.3 | −52.6 | 25.1 | 38.0 | 51.4 | 35 |
| NH₂-MIL-53(Al) [symbol] | Matrimid | 8.0 | 3.0 | 50/50 | 35 | 6.8 | 13.3 | 95.6 | 30.5 | 31.1 | 2.0 | 18 |

[symbol]

(001)-AlFFIVE-1-Ni nanosheets, [symbol] Cu-BDC nanosheets, [symbol] NH₂-MIL-53(Al) nanosheets. Permeation temperature 35° C. [symbol] Permeability enhancement factor, [symbol] Selectivity enhancement factor, 1 barrer = 10 [symbol] cm³ (STP) cm/cm² s cmHg; 1 bar = 100 kPa. [symbol] References in main text. [symbol]
indicates data missing or illegible when filed

TABLE S15
Overview of representative MOFs based mixed-matrix membranes for CO₂/CH₄ separation.

| | | MOF | Measurement conditions | | | CO₂ | | |
|---|---|---|---|---|---|---|---|---|
| | | loading | P | CO₂/CH₄ | T | permeability | CO₂/CH₄ | |
| MOFs | Polymer | (wt %) | (bar) | ratio | (° C.) | (barrer) | selectivity | Ref. |
| AlFFIVE-1-Ni^{Σ} | 6FDA-DAM | 58.9 | | | | 1095.4 | 41.2 | this |
| | 6FDA-DAM-DAT | 59.6 | 10.0 | 10/90 | 35 | 435.9 | 84.7 | work |
| | 6FDA-DAT | 60.3 | | | | 129.8 | 141.8 | |
| Y-fum-fcu-MOF | 6FDA-DAM | 30.1 | | | | 1365.0 | 23.3 | 11 |
| | 6FDA-DAM-DABA | 17.7 | 1.4 | single | 35 | 286.8 | 38.0 | |
| | 6FDA-DAM | 20.0 | | | | 952.4 | 26.3 | 42 |
| NbOFFIVE-1-Ni | 6FDA-DAM | 20.0 | 1.4 | single | 35 | 954.3 | 20.9 | 38 |
| | 6FDA-DAM | 20.0 | 6.9 | 50/50 | | 1007.8 | 26.3 | |
| MOF-74 | 6FDA-Durene | 21.0 | | | | 2250.0 | 15.7 | |
| | 6FDA-DAM | 23.0 | 1.0 | 50/50 | 35 | 1217.0 | 16.1 | 44 |
| | 6FDA-DAT | 15.0 | | | | 52.0 | 55.6 | |
| | PIM-1 | 20.0 | 2.0 | | 25 | 21269.0 | 19.0 | 77 |
| UiO-66 | 6FDA-ODA | 25.0 | 10.0 | single | 35 | 50.4 | 46.1 | 78 |
| | 6FDA-ODA | 25.0 | 10.0 | 50/50 | | 50.4 | 42.3 | |
| | PIM-1 | 28.0 | 5.0 | 50/50 | 25 | 10900.0 | 13.0 | 79 |
| UiO-66-NH₂ | 6FDA-ODA | 25.0 | 10.0 | 50/50 | 35 | 13.7 | 44.7 | 78 |
| | PIM-1 | 20.0 | 4.0 | single | 25 | 2210.0 | 25.1 | 14 |
| MIL-53 | 6FDA-DAM:HAB | 15.0 | 10.0 | single | 35 | 71.1 | 15.1 | 80 |
| | Matrimid ®5218 | 15.0 | 3.0 | single | 25 | 12.4 | 51.8 | 81 |
| | Ultem | 15.0 | 10.0 | 50/50 | 35 | 1.8 | 42.8 | 82 |
| | 6FDA-ODA:DAM | 20.0 | 10.0 | 50/50 | 35 | 61.5 | 13.0 | |
| MIL-53-NH₂ | 6FDA-DAM:HAB | 20.0 | 10.0 | pure | 35 | 44.3 | 27.7 | 80 |
| | PSF | 30.0 | 3.0 | 50/50 | 30 | 40.0 | 29.2 | 83 |
| | Matrimid ®5218 | 16.0 | 3.0 | 50/50 | 25 | 7.4 | 42.0 | 13 |
| | 6FDA-DAM | 20.0 | 2.0 | 50/50 | 25 | 680.0 | 27.9 | |
| | Matrimid ®9725 | 30.0 | 9.0 | 50/50 | 35 | 50.0 | 37.0 | 84 |
| | Ultem | 15.0 | 10.0 | 50/50 | 35 | 3.0 | 36.1 | 82 |
| | 6FDA-ODA:DAM | 15.0 | 10.0 | 50/50 | 25 | 113.0 | 28.5 | |
| sod-ZMOF | Matrimid ®5218 | 20.0 | 4.0 | 50/50 | 35 | 13.8 | 43.4 | 85 |
| | 6FDA-DAM | 20.0 | 2.1 | 50/50 | 35 | 1408.4 | 26.2 | 41 |
| ZIF-7 | Pebax | 34.0 | 3.8 | single | 20 | 41.0 | 44.0 | 86 |
| ZIF-8 | PSF | 5.0 | 4.0 | single | 27 | 3.2 | 28.5 | 87 |
| | Matrimid ®5218 | 30.0 | 5.0 | 50/50 | 35 | 25.0 | 53.0 | 88 |
| | Matrimid ®5218 | 50.0 | 2.7 | single | 25 | 4.7 | 124.9 | 89 |
| | PIM-1 | 43.0 | 1.0 | single | 22 | 6300.0 | 14.7 | 90 |
| | 6FDA-Durene | 50.0 | 3.5 | single | 35 | 1552.9 | 11.0 | 91 |
| | 6FDA-Durene | 41.9 | 10.0 | single | 35 | 779.0 | 20.9 | 45 |
| ZIF-71 | 6FDA-Durene | 20.0 | 3.5 | 50/50 | 35 | 3435.0 | 16.0 | 92 |
| ZIF-90 | Matrimid | 15.0 | 2.0 | single | 25 | 10.5 | 35.0 | 43 |
| | 6FDA-DAM | 15.0 | 2.0 | single | 25 | 800.0 | 28.0 | |
| HKUST-1 | Matrimid ®5218 | 30.0 | 10.0 | 50/50 | 25 | 14.0 | 46.0 | 93 |
| | PVDF | 15.0 | 5.0 | single | 25 | 3.2 | 40.1 | 94 |
| | ODPA-TMPDA | 20.0 | 2.0 | single | 35 | 142.5 | 28.0 | 95 |
| | 6FDA-ODA | 25.0 | 10.0 | single | 35 | 21.8 | 51.2 | 78 |
| MOF-5 | PEI | 25.0 | 6.0 | single | 25 | 5.4 | 23.4 | 96 |
| | Matrimid ®5218 | 30.0 | 2.0 | single | 35 | 20.2 | 44.7 | 97 |
| MIL-101 | PSF | 24.0 | 2.0 | 50/50 | 35 | 18.0 | 28.0 | 98 |
| MIL-101-NH₂ | PSF | 25.0 | 3.0 | 50/50 | 35 | 5.4 | 27.0 | 99 |

^{Σ}(001)-AlFFIVE-1-Ni nanosheets.

TABLE S16
A comparison of mixed gas H₂S/CO₂/CH₄ separation performance, and selectivity (S) and permeability
(P) enhancement of MOFs/6FDA-pol [symbol] imides MMMs with [001]-oriented MMMOF membranes.

| | | Permeability (barrer) | | | Selectivity | | | Enh [symbol] | | |
|---|---|---|---|---|---|---|---|---|---|---|
| | Gas mixture | | | H₂S + | | | (H₂S + | (%) | | |
| Membrane | (H₂S:CO₂:CH₄) | H₂S | CO₂ | CO₂ | H₂S/CH₄ | CO₂/CH₄ | CO₂)/CH₄ | P | S | Ref. |
| 6FDA-DAM | 1/9/90 [symbol] | 514.7 | 693.3 | 1208.0 | 18.7 | 25.2 | 43.9 | — | — | This |
| (001)-AlFFIVE(58.9)/6FDA-DAM | | 961. [symbol] | 1008.9 | 1970.0 | 47.7 | 50.1 | 97.8 | 63.1 | 123 | work |
| 6FDA-DAM | 2/18/80 [symbol] | 523.9 | 732.0 | 1255.9 | 19.0 | 26.5 | 45.5 | — | — | |
| (001)-AlFFIVE(58.9)/6FDA-DAM | | 979.9 | 1060.4 | 2040.3 | 45.9 | 49.6 | 99.4 | 62.5 | 118 | |
| 6FDA-DAM | 5/5/90 [symbol] | 350.2 | 769.1 | 1119.3 | 14.5 | 31.7 | 46.2 | — | — | |
| (001)-AlFFIVE(58.9)/6FDA-DAM | | 573.0 | 944.9 | 1517.9 | 39.0 | 64.2 | 103.2 | 35.6 | 123 | |
| 6FDA-DAM-DAT | 1/9/90 [symbol] | 82.0 | 202.7 | 284.7 | 18.5 | 45.7 | 64.1 | — | — | |
| (001)-AlFFIVE(59.6)/6FDA-DAM-DAT | | 221.9 | 358.6 | 580.5 | 51.8 | 83.8 | 135.6 | 103.9 | 112 | |
| 6FDA-DAM-DAT | 2/18/80 [symbol] | 82.7 | 210.4 | 293.1 | 18.8 | 47.7 | 66.5 | — | — | |
| (001)-AlFFIVE(59.6)/6FDA-DAM-DAT | | 246.5 | 393.7 | 640.2 | 56.2 | 39.7 | 145.8 | 118.4 | 119 | |
| 6FDA-DAM-DAT | 5/5/90 [symbol] | 64.9 | 196.9 | 261.8 | 16.9 | 51.3 | 68.2 | — | — | |
| (001)-AlFFIVE(59.6)/6FDA-DAM-DAT | | 140.6 | 305.5 | 446.1 | 45.3 | 98.4 | 143.7 | 70.4 | 111 | |
| 6FDA-DAT | 1/9/90 [symbol] | 12.3 | 53.4 | 65.7 | 16.7 | 72.7 | 89.3 | — | — | |
| (001)-AlFFIVE(60.3)/6FDA-DAT | | 39.2 | 118.5 | 157.7 | 45.1 | 136.3 | 181.4 | 140.1 | 103 | |
| 6FDA-DAT | 2/18/80 [symbol] | 12.7 | 56.7 | 69.4 | 17.1 | 76.3 | 93.4 | — | — | |
| (001)-AlFFIVE(60.3)/6FDA-DAT | | 42.1 | 124.2 | 166.3 | 48.9 | 144.3 | 193.2 | 139.5 | 107 | |
| 6FDA-DAT | 5/5/90 [symbol] | 10.6 | 53.1 | 63.7 | 15.2 | 76.4 | 91.6 | — | — | |
| (001)-AlFFIVE(60.3)/6FDA-DAT | | 29.3 | 107.1 | 136.3 | 40.7 | 149.0 | 189.7 | 114.0 | 107 | |
| 6FDA-DAM | 20/20/60 [symbol] | 258.2 | 413.5 | 671.7 | 15.3 | 24.4 | 39.7 | — | — | 11 |
| Y-fum-fcu-MOF(30)/6FDA-DAM | | 469.8 | 587.9 | 1057.7 | 23.4 | 29.3 | 52.7 | 57.5 | 33 | |
| 6FDA-DAM-DABA | | 42.4 | 95.6 | 138.0 | 16.4 | 36.1 | 52.5 | | | |
| Y-fum-fcu-MOF(17.7)/6FDA-DAM-DABA | | 67.3 | 158.6 | 225.9 | 19.7 | 46.4 | 66.1 | 63.7 | 26 | |
| NbOFFIVE-1-Ni(20)/6FDA-DAM | 20/20/60 [symbol] | 401.0 | 547.0 | 945.0 | 20.7 | 28.2 | 48.9 | 41.1 | 23 | 38 |
| 6FDA-DAM | 30/5/65 [symbol] | 167.0 | 137.0 | 304.0 | 7.3 | 9.1 | 16.4 | | | 39 |
| UiO-66-NH-COCH [symbol] (16)/6FDA-DAM | | 193.0 | 172.0 | 365.0 | 16.2 | 18.2 | 34.4 | 20.1 | 109 | |

Feed pressure: [symbol] 10 bar; [symbol] 5 bar; [symbol] 6.9 bar; [symbol] 20 bar. All permeation measured at 35° C. Enh [symbol] enhancement. [symbol]
indicates data missing or illegible when filed

TABLE S17
Lattice parameters of the DFT-optimized and
experimental AlFFIVE-1-Ni bulk structure.

| | Structural model | | | | | | |
|---|---|---|---|---|---|---|---|
| | a [Å] | b [Å] | c [Å] | α [°] | β [°] | γ [°] | Volume [Å³] |
| This work | 9.785 | 9.785 | 15.446 | 90 | 90 | 90 | 1479.06 |
| Exp. (25) | 9.876 | 9.876 | 15.120 | 90 | 90 | 90 | 1474.81 |

TABLE S18
Table S18. 12-6 LJ parameters and DDEC partial charges ascribed
to the atoms of the AlFFIVE-1-Ni (001) surface structure.

| Atom type | ε [symbol] [kcal/mol] | [symbol] [Å] | Qᵢ [e] |
|---|---|---|---|
| Al | 0.505 | 4.008 | +1.661 |
| Ni | 0.015 | 2.525 | +0.735 |
| C | 0.095 | 3.473 | +0.062 |
| H | 0.015 | 2.847 | +0.135 |
| N | 0.077 | 3.262 | −0.236 |
| F1 | 0.050 | 2.997 | −0.604 |
| F2 | 0.050 | 2.997 | −0.623 |
| F3 | 0.050 | 2.997 | −0.561 |

[symbol]

indicates data missing or illegible when filed

TABLE S19
Table S19. Lattice parameters and representative geometric features -
bond distances (L) and valence angles (A) - of the DFT - and
force field NPT MD-generated AlFFIVE-1-Ni surface slab models.

| Lattice | Structure model | | Geometric | Structure model | |
|---|---|---|---|---|---|
| parameters | DFT | NPT MD | features | DFT | NPT MD |
| a [Å] | 9.785 | 9.742 | [symbol] | 2.07 | 2.13 |
| b [Å] | 9.785 | 9.742 | [symbol] | 2.01 | 1.94 |
| z [Å] | 42.57 | 41.41 | [symbol] | 1.85 | 1.81 |
| α [°] | 90 | 90 | [symbol] | 177.5 | 176.3 |
| β [°] | 90 | 90 | [symbol] | 179.0 | 177.6 |
| γ [°] | 90 | 90 | [symbol] | 89.4 | 89.9 |

[symbol]

indicates data missing or illegible when filed

TABLE S20
Table S20. 12-6 LJ parameters and atomic
charges for the 6FDA-DAM model.

| Atom type | Number | [symbol] [kcal/mol] | [symbol] [Å] | Qᵢ [e] |
|---|---|---|---|---|
| CA11 | 1, 11 | 0.0417 | 3.88 | −0.137 |
| CA12 | 6, 12 | | | −0.023 |
| CA21 | 2, 10 | | | +0.082 |
| CA22 | 3, 9 | 0.1003 | 3.695 | −0.049 |
| CA23 | 5, 13 | | | −0.039 |
| CA24 | 28 | | | −0.350 |
| CA3 | 4, 8 | | | +0.305 |
| CA4 | 26, 30 | 0.0417 | 3.88 | −0.425 |
| CA5 | 27, 29, 31 | | | +0.470 |
| CH0 | 7 | 0.0010 | 6.40 | −0.502 |
| CF3 | 14, 15 | 0.0417 | 4.73 | +0.053 |
| CH3 | 32, 33, 34 | 0.1947 | 3.75 | −0.080 |
| COO | 16, 18, 21, 23 | 0.1689 | 3.72 | +0.369 |
| OCO | 19, 20, 24, 25 | 0.3924 | 3.05 | −0.383 |
| NN1 | 17, 22 | 0.0238 | 3.78 | +0.107 |
| OES | Termination | 0.1093 | 2.80 | −0.102 |
| NA1 | Termination | 0.2206 | 3.34 | −0.660 |
| HA1 | Termination | 0.0000 | 0.00 | +0.330 |

[symbol]

indicates data missing or illegible when filed

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A metal organic framework (MOF) nanosheet having the formula MₐM_{b}F₅ (O/H₂O)(pyrazine)₂·x(solv), wherein Mₐ is Ni²⁺, Mb is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH, wherein the nanosheet comprises one dimension (1D) channels extending vertically through the nanosheet and the nanosheet has an aspect ratio of at least 20, the aspect ratio being defined as the ratio of a lateral dimension of the nanosheet to a thickness of the nanosheet.

2. The MOF nanosheet of claim 1, wherein the thickness of the nanosheet is between about 20 and about 50 nm.

3. The MOF nanosheet of claim 1, wherein the lateral dimension of the nanosheet is between about 0.5 and about 4 μm.

4. The MOF nanosheet of claim 1, wherein the formula is AIFFIVE-1-Ni.

5. The MOF nanosheet of claim 1, wherein the formula is NbOFFIVE-1-Ni.

6. The MOF nanosheet of claim 1, wherein the formula is FeFFIVE-1-Ni.

7. The MOF nanosheet of claim 1, wherein the aspect ratio is between about 20 and about 80.

8. The MOF nanosheet of claim 1, wherein the aspect ratio is between about 25 and about 50.

9. The MOF nanosheet of claim 1, wherein a ratio of pyrazine to a pillar component is between about 10 and about 60.

10. The MOF nanosheet of claim 1, wherein a ratio of nickel to a pillar component is between about 5 and about 20.

11. The MOF nanosheet of claim 1, wherein the ratio of nickel to the pillar component is between about 5 and about 10.

12. A mixed-matrix membrane for molecular separation, the membrane comprising:
a plurality of metal organic framework (MOF) nanosheets, the MOF comprising a square grid pillared by an inorganic building block, the square grid being Ni(pyrazine)₂ and the inorganic building block selected from [NbOF₅]²⁻, [AlF₅(H₂O)]²⁻, [FeF₅(H₂O)]²⁻ and [GaF₅(H₂O]²⁻; and
a polymer matrix,
wherein the plurality of MOF nanosheets are incorporated into the polymer matrix and the incorporated nanosheets are in-plane aligned with one another such that 1D channels of the nanosheets are parallel with one another.

13. The membrane of claim 12, wherein the polymer matrix is formed of at least one of 6FDA-based polyimides and 6FDA-based co-polyimides polymers.

14. The membrane of claim 12, wherein the polymer matrix includes one or more polymers that are chemically stable under exposure to acid gases.

15. The membrane of claim 12, wherein the polymer matrix includes one or more polymers that are thermally stable at temperatures up to about 200-300 degrees Celsius.

16. The membrane of claim 12, wherein the polymer matrix includes one or more polymers that are resistant to solvents.

17. The membrane of claim 16, wherein the solvent is polar.

18. The membrane of claim 16, wherein the solvent is non-polar.

19. The membrane of claim 12, wherein the 1D channels are parallel to a gas diffusion direction through the membrane.

20-31. (canceled)

32. A method of making a mixed-matrix membrane for molecular separation, the method comprising:
contacting a ligand and a pillar component at a ligand to pillar ratio between about 10 and about 120 to form a plurality of MOF nanosheets, and the MOF has the formula MₐM_{b}F₅ (O/H₂O)(pyrazine)₂·x(solv), wherein Mₐ is Ni²⁺, Mb is Nb⁵⁺, Al³⁺, Fe³⁺, Fe⁵⁺ or Ga³⁺; x is from 0 to 10 and solv is one or more of H₂O, CO₂, DMF, EtOH, NMP, and MeOH;
contacting the plurality of MOF nanosheets with a polymer matrix in a dispersion of solvent to form a solution in which the plurality of MOF nanosheets incorporate into the polymer matrix to form a mixed-matrix membrane; and
evaporating the solvent at a rate sufficient to induce in-plane alignment of the incorporated nanosheets with one another in the mixed-matrix membrane such that 1D channels of the nanosheets are parallel with one another.

33-66. (canceled)
